(19) United States
(12) Patent Application Publication
(10) Pub. No.: US 2005/0055286 A1
(43) Pub. Date: Mar. 10, 2005

(54) System and method for tracking disposition of items

(76) Inventor: David A. Zimet, Hightstown, NJ (US)

Correspondence Address: REED SMITH LLP;2500 One Liberty Place, 1650 Market Street, Philadelphia, PA, 19103-7301, US

(21) Appl. No.: 10/893,580

(22) Filed: Jul. 16, 2004

Related U.S. Application Data
(60) Provisional application No. 60/487,656, filed on Jul. 16, 2003.

(51) Int. Cl. G06F 17/60

(52) U.S. Cl. 705/28; 705/37

(57) ABSTRACT

A method and system of tracking and the disposition of inventoried items is disclosed. The method and system include assigning an audit code to an incoming inventoried item, wherein the audit code comprises a manual audit code and an automated audit code; auditing the incoming inventoried item to assess the incoming inventory item as suitable for one or more selected from the group consisting of destruction, demanufacturing, resale, recondition, storage, and redeployment; sending the incoming inventoried item to one of a redeployment, a demanufacturing, a reconditioning, a resale, a storage, and a destruction in accordance with the auditing; manually updating the manual audit code in accordance with the auditing and the sending; providing, after the sending and the manually updating, redeployment or resale of at least a portion of the incoming inventoried item audited as suitable for at least one of demanufacturing, resale, recondition, and redeployment; and, finally updating the manual audit code based upon the providing.

### CROSS REFERENCE TO RELATED APPLICATIONS

This application claims priority to provisional application Ser. No. 60/487,656, filed Jul. 16, 2003.

### BACKGROUND OF THE INVENTION

1. Field of the Invention

The present invention is directed generally to a method and apparatus for tracking the lifecycle of items and, more particularly, to a inventory tracking system and method.

2. Description of the Background

Inventory tracking necessary in order to assess the location of items and goods that may be reused, purchased, sold, disposed of, or otherwise transferred. Inventory tracking is particularly necessary if the goods or items be tracked may be subject to certain laws or other regulations, such as environmental and/or hazardous waste regulations. Thus, for example, hazardous and/or non-biodegradable materials may be assessed with a particular need for inventory tracking.

Items having a particular need for tracking may provide other requirements not applicable in certain inventory tracking situations. For example, in the tracking of non-biodegradable materials, certain portions of a device may be biodegradat4e, or may be reclaimable, and it may be useful to note those portions of a given material as such. Further, certain types of inventory that are assessed with a particular need for inventory tracking may be reconditionable, and/or redeployable. It may thus also be useful to track the ability to recondition, and/or the ability to redeploy, certain inventory items or components.

Inventory tracking systems available at the present do not provide for the strict tracking and auditing functionality, necessary for items having a particular need to be tracked and inventoried. Inability to reliably retrieve such information may lead to legal exposure for generators or disposing parties. Further, present inventory tracking systems do not allow for differentiation between certain items, or between certain parts of certain items, which may be resellable, reconditionable, or redeployable. Thus, present inventory systems do not provide an adequate audit trail to prevent legal exposure resulting from failure to track the disposal, reconditioning or redevelopment of certain items which are subject to legal regulations. Further, present inventory systems do not tack the original owner and document the transfer of ownership.

For example, the disposition of hazardous waste materials is subject to very strict laws. Often those disposing of such hazardous materials hire disposal companies to handle the disposal and hence are not privy to the final location or final disposition of the hazardous materials. Thus, an inventory tracking system which allows for specific tracking of a disposition (including, but not limited to, whether those goods have been stored, resold, demanufactured redeployed, or reconditioned) of all items entered into the system, is necessary but not available in the present art.

Present inventory and tracking systems generally have a lack of tracking and reporting for data, software, and/or hardware eradication in one program. Further, there is generally a lack of registry information recovery when dealing with software applications, particularly for computers that have experienced a disk and format command.

Further, for items designated as being suitable for being resold, redeployed, or reconditioned, a mechanism may be needed wherein such items may be resold, reconditioned, or redeployed. Such a mechanism might include auctions, wherein bids are submitted for an available item, and the highest bidder wins the opportunity to purchase the item for the bid amount. An inventory tracking system that tracks the status of all items within the inventory tracking system, and tracks separately, but in communication with, the inventory tracking system auction items, items for sale, items destroyed, and/or reconditioned items would provide a unique and efficient mechanism of tracking goods making goods available for sale, and disposing of goods, in a single system.

Thus, the need exists for an inventory tracking system that tracks and audits the status of all items within the inventory tracking system, including disposed items, and that lacks separately, but in communication with the inventory tracking system, auction items, items for sale, items destroyed and/or reconditioned items.

### BRIEF SUMMARY OF THE INVENTION

A system and method of tracking and reselling inventoried items is disclosed. This method includes assigning an audit code to an incoming inventoried item, wherein the audit code comprises a manual audit code and an automated audit code; auditing the incoming inventoried item to assess the incoming inventory item as such for one or more of, for example, the destruction, demanufacture, resale, recondition, storage, and redeployment; sending the incoming inventoried item to one of a redeployment, a demanufacture, a recondition, a resale, a storage, and a destruction in accordance with the auditing; manually updating the manual audit code in accordance with the auditing and the sending; providing, after the sending and the manually updating, redeployment or resale of at least a portion of the incoming inventoried item audited as suitable for at least one of demanufacture, resale, recondition, and redeployment; and, finally updating the manual audit code based upon the information provided to the system.

Further, a system and method of reselling inventoried items is disclosed. This method includes auditing the incoming inventoried item to assess the incoming inventory item as suitable for resale; making the incoming inventoried item available for auction in accordance with the auditing; auctioning the incoming inventoried item by at least one of a line item auction and a lot auction; disposing of the incoming inventoried item, upon completion of the auctioning, in accordance with an outcome of the auctioning; and, tracking the disposing, wherein the tracking updates a code associated with the auditing.

A system for tracking and disposition of inventoried items is additionally included in the present invention. The system includes an audit code assigner that assigns a manual audit code and an automated audit code to the inventoried item, an auditor that audits the incoming inventoried item to assess the incoming inventory item as suitable for one or more of destruction, demanufacturing, resale, reconditioning, storage, and redeployment, at least one of a redeployer, a demanufacturor, a reconditioner, a reseller, a storer, and a destructor associated with the auditor, and at least one updator that manually updates the manual audit code at each of the audit code assignor, the auditor, and the at least one redeployer, demanufacturor, reconditioner, reseller, storer, and destructor.

Thus, the present invention provides an inventory tracking system and method that tracks and audits the status of all items within the inventory tracking system, including disposed items, and that tracks separately, but in communication with the inventory tracking system, auction items, items redeployed, reconditioned or for sale, or items destroyed.

### BRIEF DESCRIPTION OF SEVERAL VIEWS OF THE DRAWINGS

Understanding of the present invention will be facilitated by consideration of the following detailed description of the embodiments of the present invention taken in conjunction with the accompanying drawings, in which like numerals refer to like parts, and wherein:

FIG. 1 is a flow diagram illustrating the organization of an inventory tracking system of the present invention;

FIG. 2 is a flow diagram illustrating materials entering the inventory hub of FIG. 1;

FIG. 3 is a flow diagram illustrating, an embodiment of an inventory receipt and tracking system of FIG. 2 of the present invention;

FIG. 4 (which figure comprises 4A and 413) is a flow diagram illustrating an embodiment of the present invention of the inventory management system of the present invention wherein items may be sold, inventoried, contained, shipped or to-be shipped;

FIG. 5 is a flow diagram illustrating an embodiment of the interaction of a remote user with the inventory tracking system of the present invention;

FIG. 6 is a flow diagram illustrating the implementation of an auction module of FIG. 1 of the present invention;

FIG. 7 is a flow diagram of an embodiment of the present invention providing for multiple line item or lot auctions running concurrently;

FIG. 8 is a flow diagram of an embodiment of the present invention illustrating a bid status form;

FIG. 9 is a flow diagram of an embodiment of the present invention illustrating client profile options implementing the hub and spoke system of FIG. 1;

FIG. 10 is a flow diagram of an embodiment of the present invention illustrating the IT/electronic processing of FIG. 9;

FIG. 11 is a flow diagram of an embodiment of the present invention illustrating Lab Equipment processing module of FIG. 9;

FIG. 12 is a flow diagram of an embodiment of the present invention illustrating of the Logistics module of FIG. 9;

FIG. 13 is a flow diagram of an embodiment of the present invention illustrating the storage and warehousing module of FIG. 9;

FIG. 14 is a flow diagram of an embodiment of the present invention 15 illustrating the report/certificate options module of FIG. 9;

FIG. 15 is a flow diagram of an embodiment of the present invention illustrating the electronics redeployment module of FIG. 9;

FIG. 16 is a flow diagram of an embodiment of the present invention illustrating an exemplary lab equipment redeployment module of FIG. 9;

FIG. 17 is a flow diagram of an embodiment of the present invention illustrating the overall grouping module for client reporting of FIG. 9;

FIG. 18 illustrates a list of potential job summary reports which may be generated by the present invention;

FIG. 19 is a screen representation of an aspect of the present invention;

FIG. 20 is a screen representation of the an aspect of the present invention;

FIG. 21 is a screen representation of the an aspect of the present invention;

FIG. 22 is a screen representation of the an aspect of the present 10 invention;

FIG. 23 is a screen representation of the an aspect of the present invention;

FIG. 24 is a screen representation of the an aspect of the present invention;

FIG. 25 is a screen representation of the an aspect of the present invention;

FIGS. 26-54 are screen shots illustrative of aspects of the present invention;

FIGS. 55 and 56 are hierarchical diagrams illustrative of the organizational hierarchy used in an exemplary embodiment of the present invention;

FIGS. 57-62 illustrate the processing of items using item related information in the present invention;

FIG. 63 illustrates a logisitics and warehouse hierarchy for use in the present invention;

FIGS. 64-86 are screen shots illustrative of the tracking of inventory and jobs, including searching, discrete inventory items, containers, and buyers and sellers of items in inventory; and

FIGS. 87-90 illustrate an exemplary auction interface for use in the present invention.

### DETAILED DESCRIPTION OF THE INVENTION

It is to be understood that the figures and descriptions of the present invention have been simplified to illustrate elements that are relevant for a clear understanding of the present invention, while eliminating, for the purposes of clarity, many other elements found in a typical inventory tracking system. Those of ordinary skill in the pertinent art will recognize that other elements are desirable and/or required in order to implement the present invention.

However because such elements are well known in the art, and because they do not facilitate a better understanding of the present invention, a discussion of such elements is not provided herein.

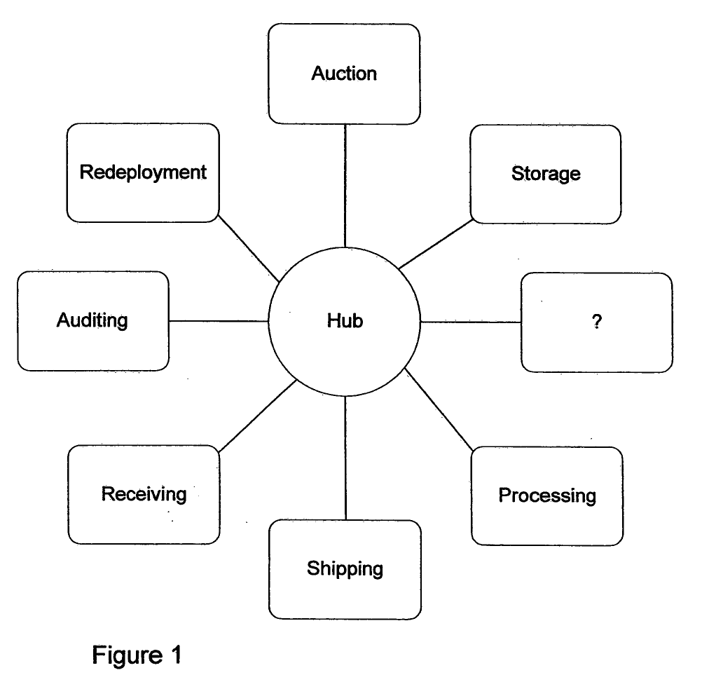

FIG. 1 is a flow diagram illustrating the organization of an inventory tracking system. The organization may include, for example, a hub mechanism, wherein the hub mechanism tracks substantially all inventory present in the system, and a series of spoke mechanisms or modules, wherein each of the spoke mechanisms may operate to dispose of inventory items in the hub in a specific manner.

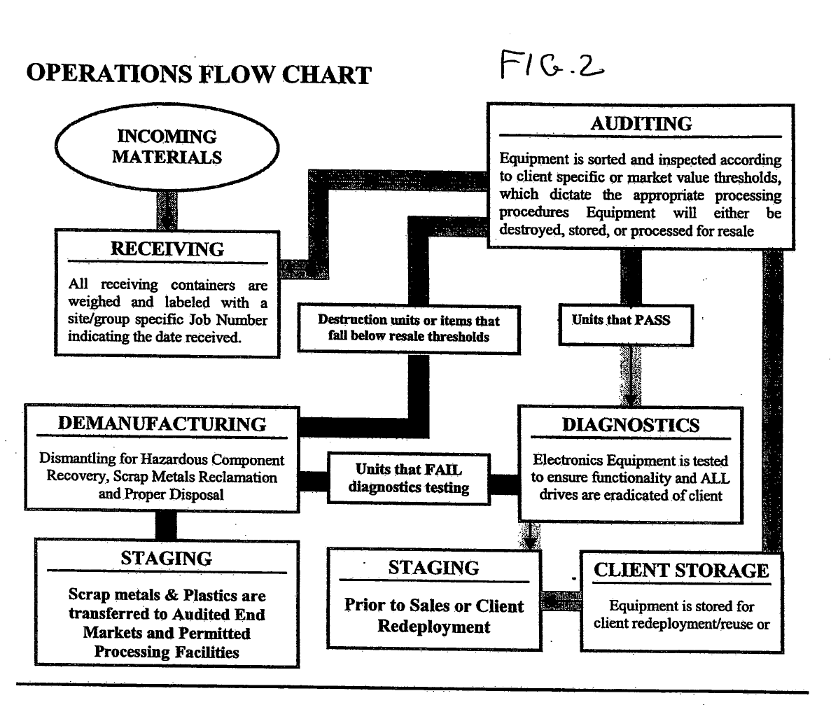

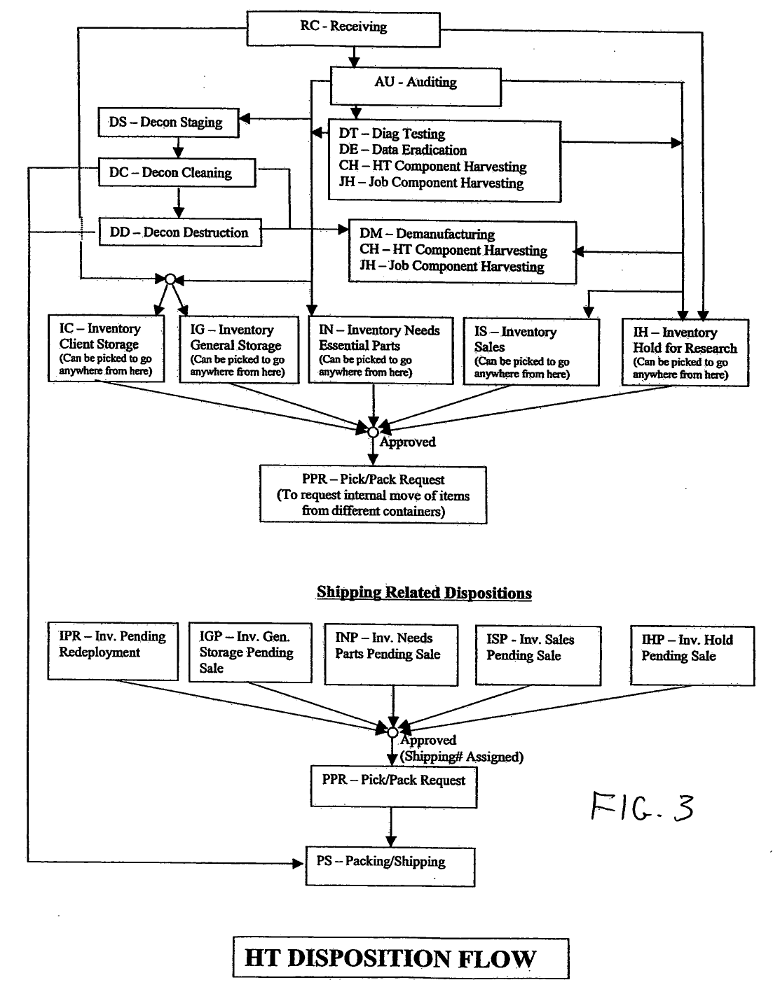

FIG. 2 is a flow diagram illustrating the flow of materials or items entering the inventory hub of FIG. 1, and operations performed upon those materials. Incoming materials, which may be, for example, materials that may be physically inventoried, may exist on, in computers, or that may be maintained in another location, such as at a client location, and tracked by computer, enter a receiving system in the hub of FIG. 1. Information may be received via computer for remotely inventoried items, or may include receiving containers, or like-physical equipment, which may be physically mapped upon receipt. For example, received containers may be weighted and labeled with the site number, a group number and a job number, by way of non-limiting example only, and further the date received may be indicated. Likewise, for non-physical inventory, the hub system may include the actual physical location, or computing location, of the inventory to be tracked, and/or a tracking number and a date received, by way of non-limiting example only.

Once received, inventory may be audited, for example. Auditing may include sorting and/or inspecting received physical inventory, such as equipment. Auditing may assess the received inventory using client specific, or market value thresholds, for example, with the appropriate processing procedures determined based on the received inventory. Received inventory may be, for example, destroyed, stored, demanufactured, or processed for resale, by way of non-limiting example only.

Once inventory is audited, inventory that falls below resale thresholds, storage thresholds, or items specifically designated for destruction, may proceed to demanufacturing. Demanufacturing may include, for example, the dismantling of hazardous components, such as for recovery, reclamation, and/or proper disposal. Further, following demanufacturing, recoverable or reclaimable materials, such as scrap metals and plastics, may be transferred to an audited end-market, and permitted to be processed within end market facilities tracked by the auditing. Units that pass, and are to be made available for storage or processed for resale, may proceed either to diagnostics, or to storage. Diagnostics may include testing to insure proper functionality of a device, and or to ensure proper security, such as the removal of all identifying information from a computer hard drive. Items that fail the diagnostic stage may proceed to demanufacturing or disposal. Items that pass the diagnostic stage may proceed to staging, where the diagnosed items may be cleared for sale or redeployment. Alternatively, units that pass may proceed to client storage, where equipment or inventory is prepared for storage, and/or stored for reuse, redeployment, or resale.

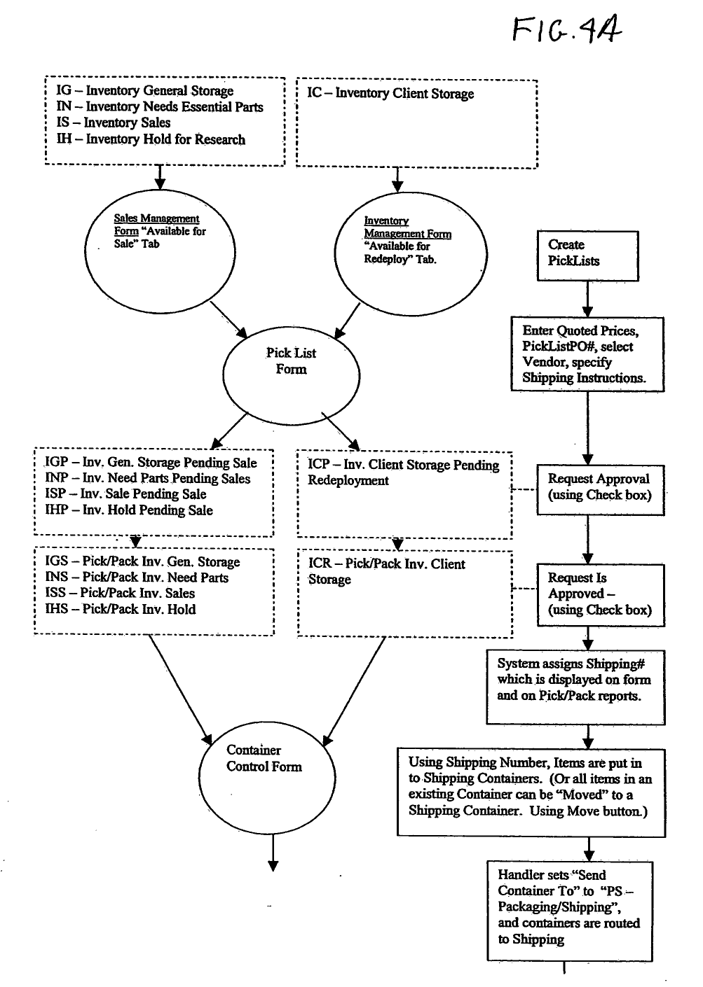

FIG. 3 is a flow diagram illustrating, with more specificity, an inventory receipt and tracking system as illustrated in FIG. 2. FIG. 3 additionally illustrates a series of two-to-three letter codes that, at each stage of the flow process, track the status of the inventory goods. In an embodiment of the present invention, the two-to-three letter codes may be assigned manually, and may thereby be changed in accordance with a change in inventory status. Further, each of the manually input codes may be appended with a computer generated code, wherein the computer generated code uniquely tracks each item within the inventory. Of note, it will be apparent to those skilled in the art that each of the computer generated, and manually generated, codes may be a series of either letters, numbers or other symbols. In accordance with this tracking system, both off-site and on-site inventory may be disposed of in accordance with instructions determined by a user or controller of the inventory. For example, off-site inventory may be tracked by the present invention, and a controller of the off-site inventory may elect to auction-off certain of the items in the inventory. At that time, the controller of the off-site inventory may change the inventory code manually from one of stored goods to one of goods eligible for auction. The system of the present invention, in accordance with the change in the code by the controller of the off-site inventory, may manual change a manual code associating the randomly generated computer code from one for stored goods to one for auctioned goods, and may, in accordance with this change, post the (desired inventory for auction to the auction spoke of the central hub in FIG. 1.

FIG. 3 illustrates a receiving step and an auditing step, in accordance with FIG. 2. FIG. 3 additionally illustrates that the receiving step may or may not flow to the auditing step. Consequently, in certain circumstances, the auditing step may be shipped in accordance with the present invention, such as instances wherein a previously acceptable certification has been obtained prior to placement of goods into the inventory system of the present invention. The auditing step, when performed, may include, for example, diagnostic testing, data clearing/irritation, such as for security purposes, and component or job component harvesting. Dependant upon the outcome of the auditing, inventory may be destroyed, stored, demanufactured into parts, or processed for resale. If material is designated to be destroyed, it may proceed through a variety of stages, such as Raging, cleaning and/or destruction. Cleaning and destruction may include, for example, demanufacturing, such as breaking a device into components, which components may be reused, stored, or destroyed individually, rather than as part of a whole. If goods are designated as approved in auditing, or parts of a particular inventoried good are approved following demanufacturing of an inventoried item, items may be inventoried in accordance with a series of codes. These codes may include, for example, storage at a client facility, storage at an on-site facility, general storage, storage for a specific purpose, storage for essential parts and purposes, and or storage for research, for example. Further, items approved for sale or resale, either as parts of an initial whole or the whole itself, may pass to inventory sales, which may include, for example, direct sales and/or auction sales.

Goods may flow from inventory, directly from receiving, or from destroyed item demanufacturing, to packing and shipping of those goods for transport outside. In accordance with a pick item, pack item, or ship item request, audit information is inserted to the audit trail of the inventory goods, in accordance with the unique manual and computer generated tracking code generated hereinabove, to allow an auditor to assess precisely where, when, and to whom goods were delivered, packed and/or shipped. Thus, the present invention may allow, in accordance with the unique tracking code, a complete audit trail from the moment goods enter the inventory tracking to the moment goods exit the inventory tracking, whether those goods are on-site or off-site. This audit trail further may include the party from whom each manual instruction was received to engage in the unique activities throughout the tracking process, i.e. those events tracked by the manually input audit code discussed hereinabove.

As illustrated in FIG. 3, inventory pending sale may be tracked by a variety of manual input codes, including whether the inventory is for sale pending redeployment, whether the inventory is in the general inventory merely pending sale or resale, sales received and pending approval, or sellable goods on hold. Items that are sold may additionally receive specific audit codes, such as corresponding to the method of shipping, such as shipped pending payment, shipped C.O.D., shipped FedEx, shipped U.S. mail, or shipped via freight, for example. Further, codes may be included to identify the packing personnel, or the packing methodology, such as wherein goods must be packed, and or shipped, in multiple boxes, on multiple palates, or the like. Further, the audit trail of the present invention allows for tracking of specific circumstances, such as wherein client goods remain stored, but are pending resale or redeployment, such as wherein goods are up for auction, or wherein goods are subject to contract negotiations. To the extent inventoried goods are available on-site, those goods may, for example, be physically marked or tagged with information correspondent to hallmarks of the audit trail, such as by placement of stickers having information thereon, or other trackable, identifiable, readable, scannable, or like-the identifying technologies having information correspondent thereto, as will be apparent to those skilled in the art in light of the disclosure herein, or the scanning of all or parts of the goods themselves, such as of information resident thereon. Such tracking, identifying, reading, scanning, or the like may then have associated therewith a listing in a computer of the hallmarks of the audit trial in accordance with each tracking, identification, scanning, reading, or the like of the particular item.

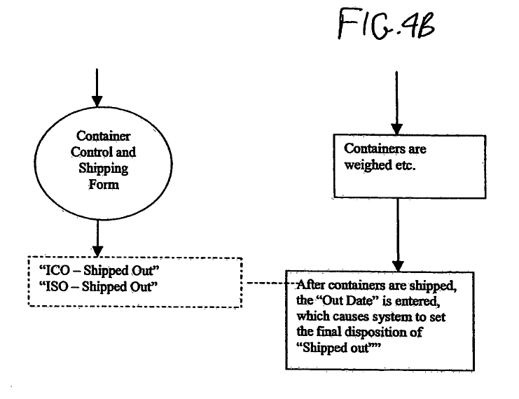

FIG. 4 is a block diagram illustrating inventory management of sold, inventoried, contained, shipped and/or to be shipped goods. Each item, as illustrated, may be tracked by a tab, wherein the tab may be a physical element placed upon the item, or wherein the tab may be correspondent to a tab within the user interface of the inventory tracking system. For example, as illustrated, certain types of goods may be made available for sale, or may be made available for sale under particular circumstances, such as when a necessary essential part is obtained. Other inventoried items may be made available for redeployment, such as for return to a client.

For example, as illustrated in FIG. 4, a pick list of available inventory may be created. Certain of the inventoried items on the pick list may have entered therefore quoted prices, purchase order numbers, vendors, and/or shipping instructions, or a flag as items picked from the pick list. Other options may be made available for items on the pick list corresponding to sale, redeploying, or storing, as will be apparent to those skilled in the art. Approval may be requested, such as from administrators or third parties, for goods made available for sale, redeployment, or storage, and, upon receipt of the requested approval, the making of the request and receipt of the approval may be entered into the audit trial of the inventoried item. The system may assign, for example, a shipping number, which may be displayed on the item, on forms relating to the item, and/or on packing reports, for example. Dependant upon the issuance and identity of the shipping number, items may be put into shipping containers, where necessary. For example, certain computer assigned shipping numbers, or manually entered shipping codes, may require particular shipping criteria, such as insertion into a box, a drum, a safety wrap, or onto palates, by way of non-limiting example only. The inventory tracking system of the present invention may automatically identify the packing steps, required or desired, for shipping in accordance with the manually entered or computer generated audit code, for example. The handler, or packer, of the goods to be shipped may send the container to shipping, and may enter the action as such into the inventory system. Before shipping the goods out, the goods may be inspected, or may be weighed, such as to assess proper postage, or to assess best shipping methods, prior to shipping. The goods may then be shipped, and entered as such into the audit trail of the inventory tracking system.

Thus, the present invention may provide a computerized interface solution suitable for viewing, and operations upon, inventory, and the destruction, deployment, redeployment, and/or sales of inventory. This inventory interface may be localized, or may be available over a network, such as the internet, an intranet or an extranet, for example. This remote interface may allow for operations on remotely stored inventory, which remotely stored inventory may nonetheless be tracked at the local site through the use of the inventory system of the present invention. Further, for example, the availability of the inventory interface over a remote connection, such as network interface, may allow for interaction by third parties, such as those desiring to contract for the purchase of, or enter into an auction for, inventoried goods.

In an embodiment wherein remote sales, and/or auctions are available, a third party accessing the inventory system of the present invention may have available only certain aspects of the inventory tracking system, such as the criteria of goods desired for purchase.

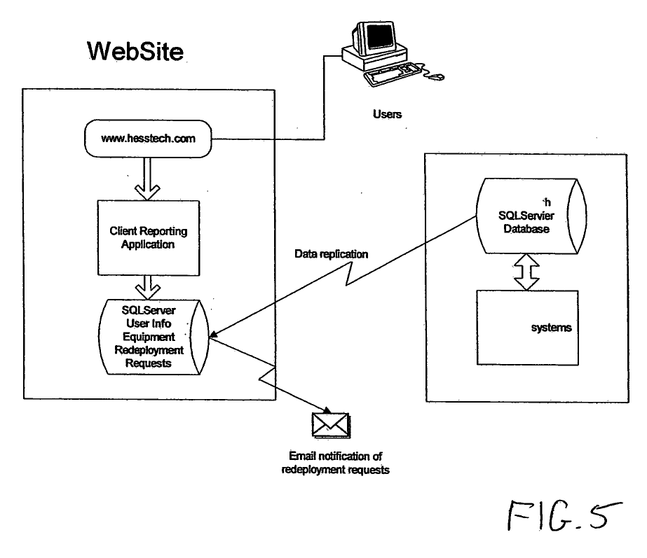

FIG. 5 is a flow diagram illustrating the interaction of a remote user with the inventory tracking system of the present invention. The remote nature of the inventory tracking server/data base from the SQL server allows the user to request information, sale, and/or redeployment, and may provide security. This security may preclude the remote user from accessing more information than is desired or necessary from the inventory tracking site. For example, a predefined filter component may apply filters relevant to a client and/or a user privilege, as well as to the desired action and/or the desired view of the user.

More specifically, the SQL server which may be used as a database may be any SQL server known to those skilled in the art, such as, but not limited to, an SQL 2000 server. The data base may be populated, and accessible to outside users, via a one way SQL server replication from the internal inventory tracking data base. Replication to the user-accessible server may occur automatically, such as periodically, or, for example, may occur transactionally. Transactional replication may occur upon request for information, and may provide increased security over automated periodic replication. Requested information, such as redeployment requests, may be maintained in a data base and/or table at the user accessible server, and may be replicated back to the internal inventory tracking data base, on an agreed upon schedule, or per transaction.

Security may be provided within the user interface, such as by a client login screen. Such a client login screen may require entry of user name and password for example. After the identifying information is input to the system, the system may assess, or identify, the user.y directly or indirectly identifying the user, a determination may be made as to whether the remote user is a client, such as one that has inventory present, or is a regular user, such as one that may only purchase or bid on auctions. User names and passwords may be set up by the internal data base server, and may be replicated to the remotely accessible data base as part of the replication scheme discussed hereinabove. Access to application information and/or data may be controlled by the client's level of access, as stored in the client login table. Access may be, for example, at a client level, a site level, a group level, or a user level, such as by determination through a security mask placed, upon each individual request, upon the correspondent requesting entry in the client login table. Of note, encrypted login, such as SSL, may be used in order to increase client security.

Multiple views may be provided in the present invention, and the information displayed in each view may be consistent with the requesting user's access level. For example, certain users may be eligible to view all equipment that is available for sale and/or auction. Certain users may be able to view equipment which is available for redeployment. Other users, such as those who have made a purchase, may be able to view equipment which is pending shipment. Still other users, such as those who have made a purchase and viewed a pending shipment, may additionally be able to view shipped items. A job summary may be provided to users having a login. The job summary may provide all information relevant to that user which that user is eligible to see. Further, particular elements within the audit trail may be available to certain users, dependant upon those users' security clearance.

For example, redeployment requests may be made with the present invention. Users may enter a category, an item type, a manufacturer, make, model, and/or a quantity requested. Filtering, or other search mechanisms known to those skilled in the art, may query and check quantity for the availability of the hems requested for redeployment. The recipient of the redeployment may, for example, be selected from a drop down list of known recipients, or a new recipient may be entered by completing a recipient information form. The redeployment request may be submitted, such as by clicking a submit button, which may cause the sending of an email to the internal inventory tracking data base. Such an email may detail that forms have been filled out and a redeployment request has been remotely generated.

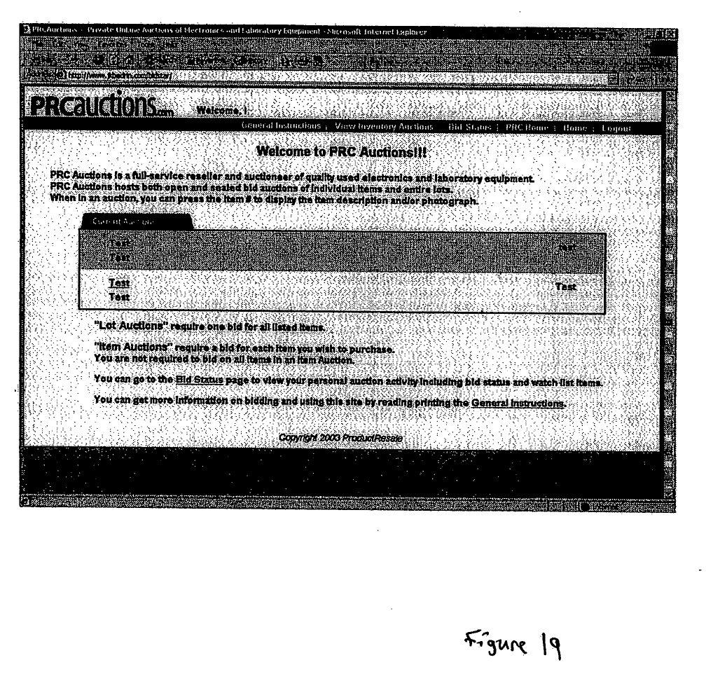

Referring now to FIGS. 19-24, there are shown embodiments of screen representations according to an aspect of the present invention. In FIG. 19, for example, there is shown an entry page to an auction site identifying the user and the types of auctions that the user has access to.

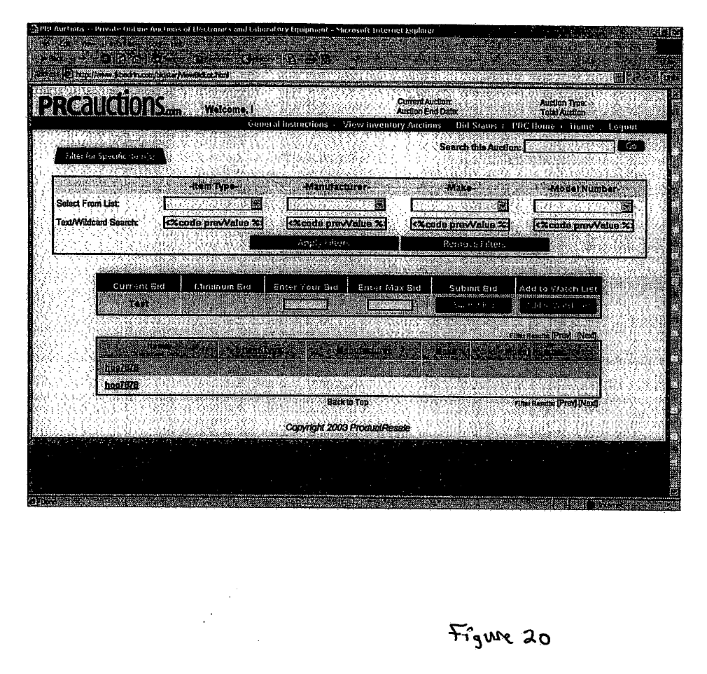

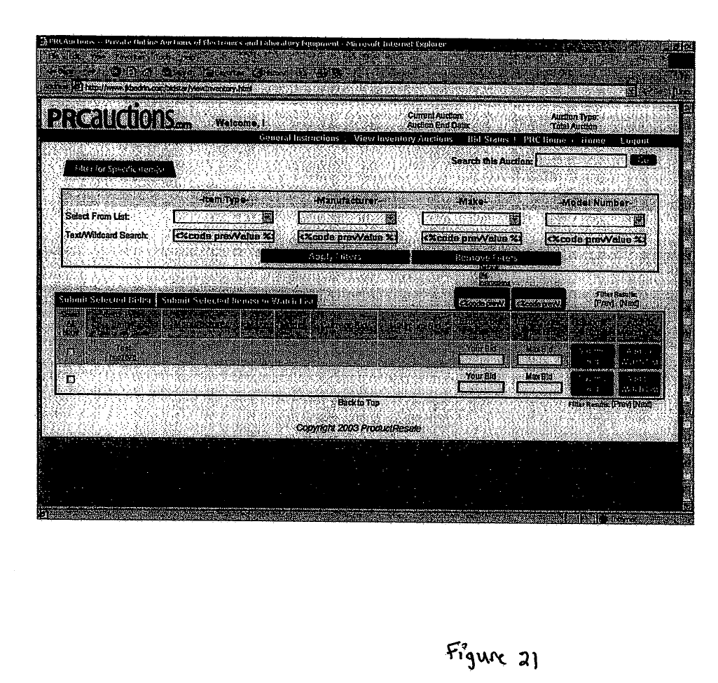

Different types of auctions and access may be shown in FIGS. 20 and 21. In FIG. 21 there is shown a screen available to a user with required access to bid on items identified by lots. As may be seen in FIG. 20 various information on the lot is provided to the user, as discussed hereinabove. In FIG. 21, there is shown a screen available to a user with required access to bid on individual items, such as line item auctions, for example. As may be seen in FIG. 21, individual items and the items pertinent information may be identified as a line item on the screen.

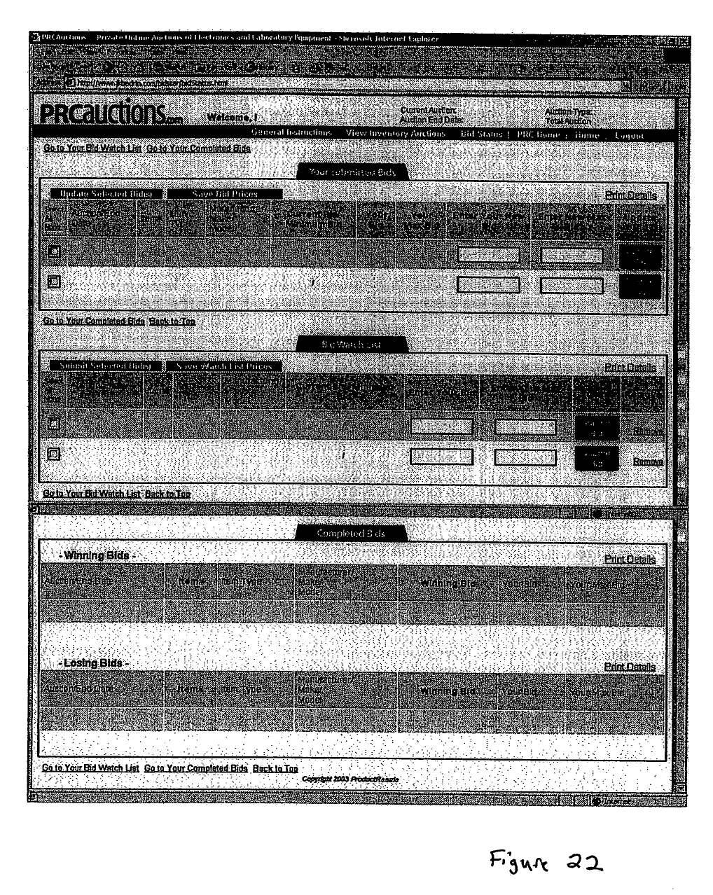

FIG. 22 illustrates a screen shot according to an aspect of the present invention. In FIG. 22, there is shown a bid status page configured to allow the user to view various bids, such as on-going and completed bids, and further identify each bid as currently the highest or not, as discussed hereinabove.

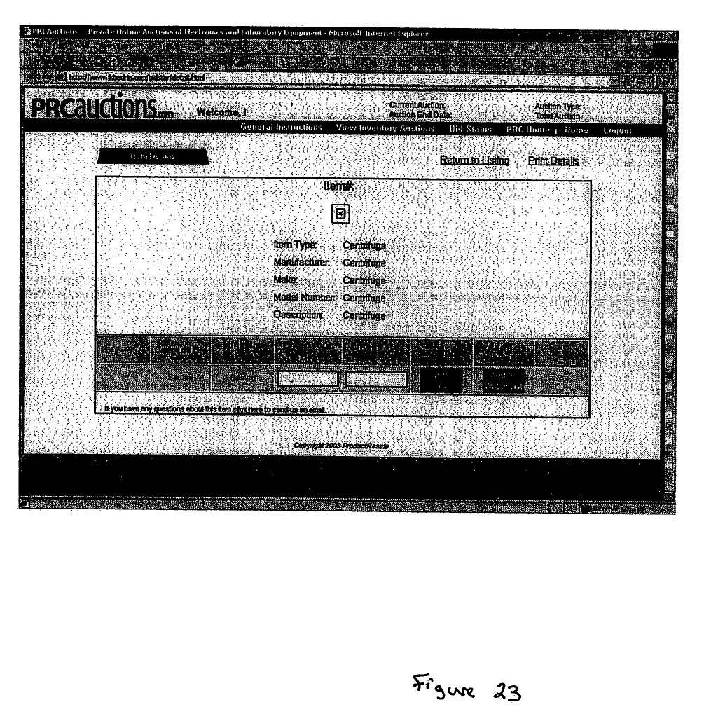

FIG. 23 illustrates a screen shot demonstrating the types of information available within the inventory system of the present invention. As is shown in FIG. 23, line items may be identified and further information may be determined corresponding to the particular identified line item.

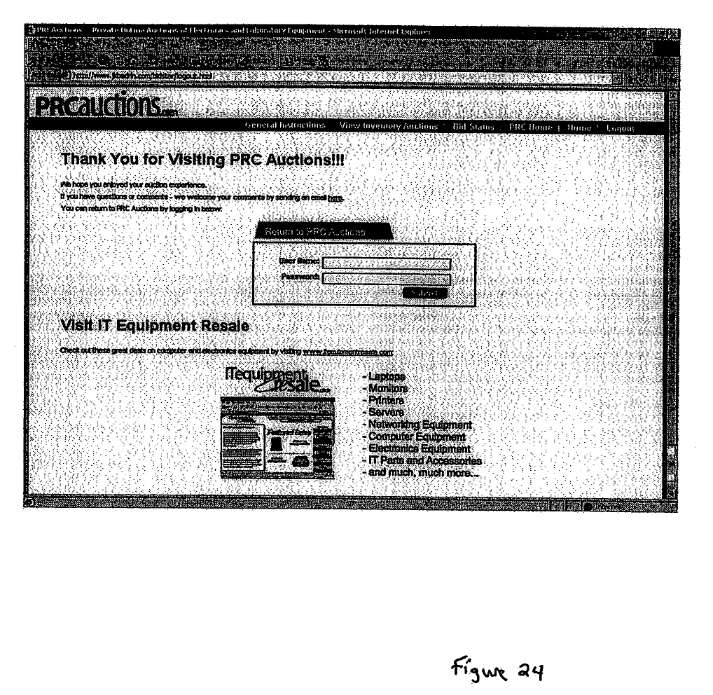

In FIG. 24, there is shown a logout screen according to an aspect of the present invention. This login screen denotes the required information to access certain levels of the inventory system disclosed herein.

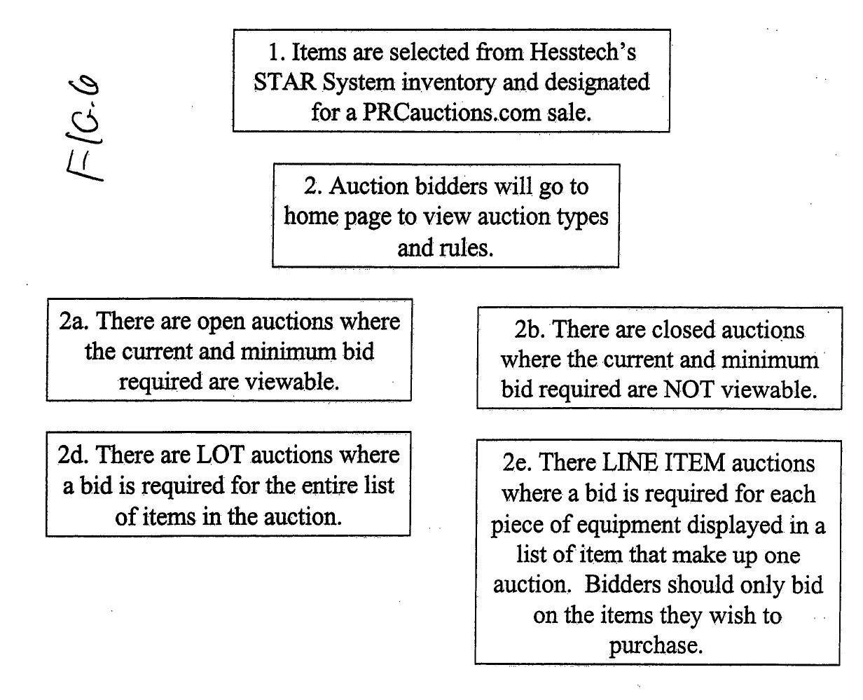

FIG. 6 is a flow diagram illustrating the implementation of an auction module from the inventory hub of FIG. 1. Items may be selected from the system inventory and designated for auction sale. Auction bidders may enter user information to acquire a list of items available for auction, or may be required to enter user information only upon entry of an auction bid. Further, the home page may be accessible to external users and may provide, for example, auction types and/or rules. Upon gaining access to the auction page, open auctions and closed auctions for requested items may be presented. Further, the requested items may be requested utilizing any search engine, as will be apparent to those skilled in the art. Open auctions are those wherein the current and minimum bid required are viewable to the user having that user's security level. Closed auctions are those wherein a current and minimum bid are not viewable to that particular user.

Lot auctions may be available, wherein a bid is required for the entire list of items in a given auction, and wherein one or more of the items are responsive to the users searched for item. Alternatively, line item auctions may be available, wherein a bid is required for each equipment item, or part of a piece of equipment, displayed in a list of equipment items, but wherein the sum of the lists, and/or the sum of the items, and/or the sum of the bids, may make a single auction. Alternatively, in a line item auction, bidders may bid only on the items they wish to purchase.

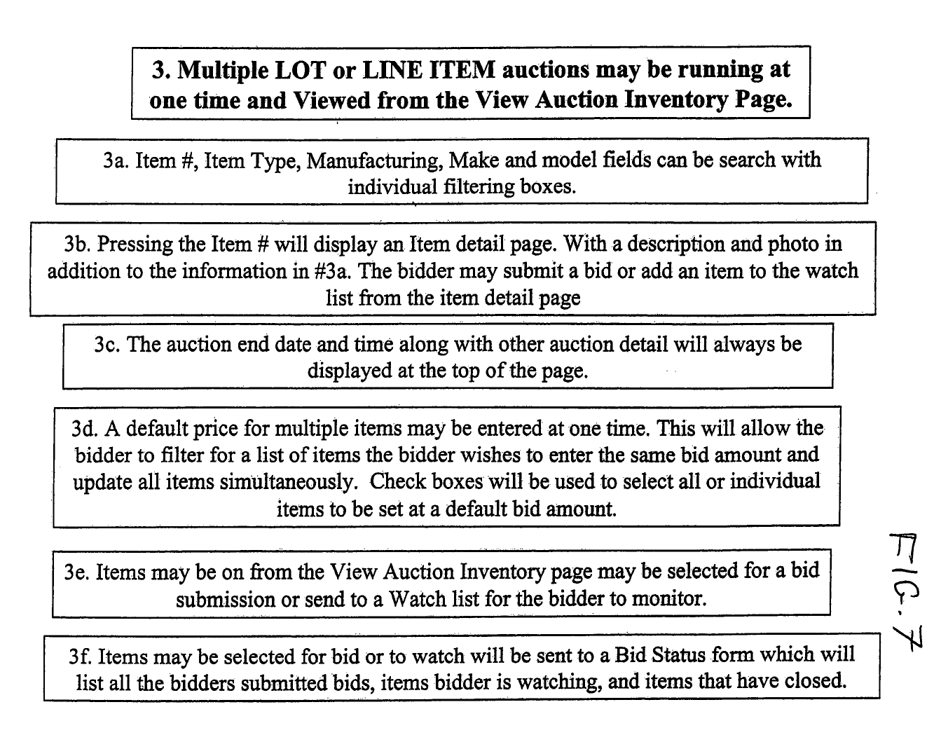

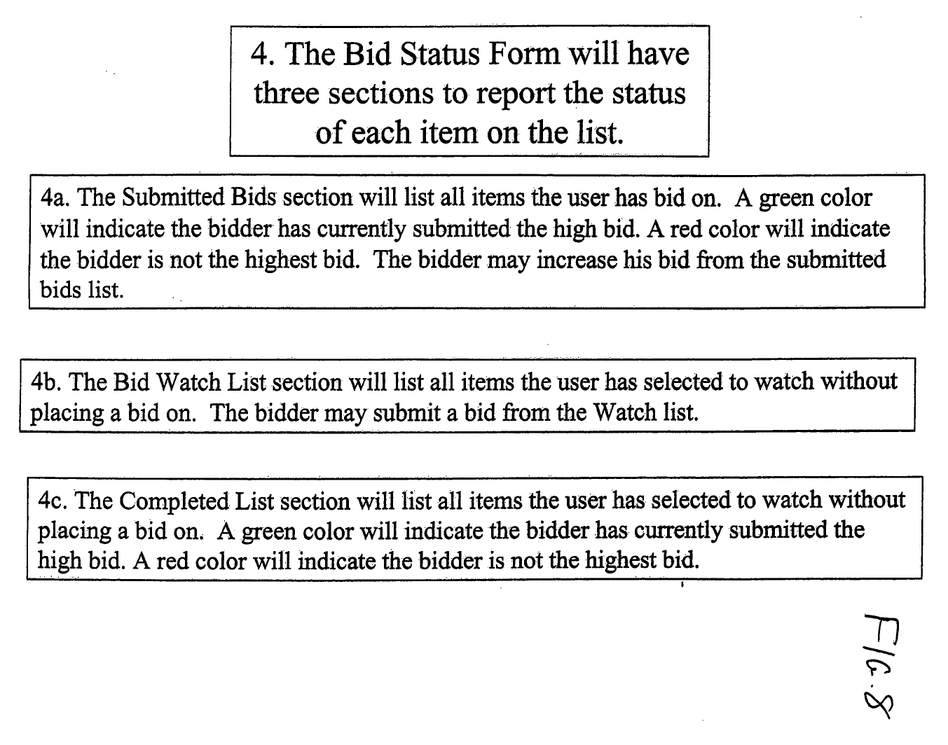

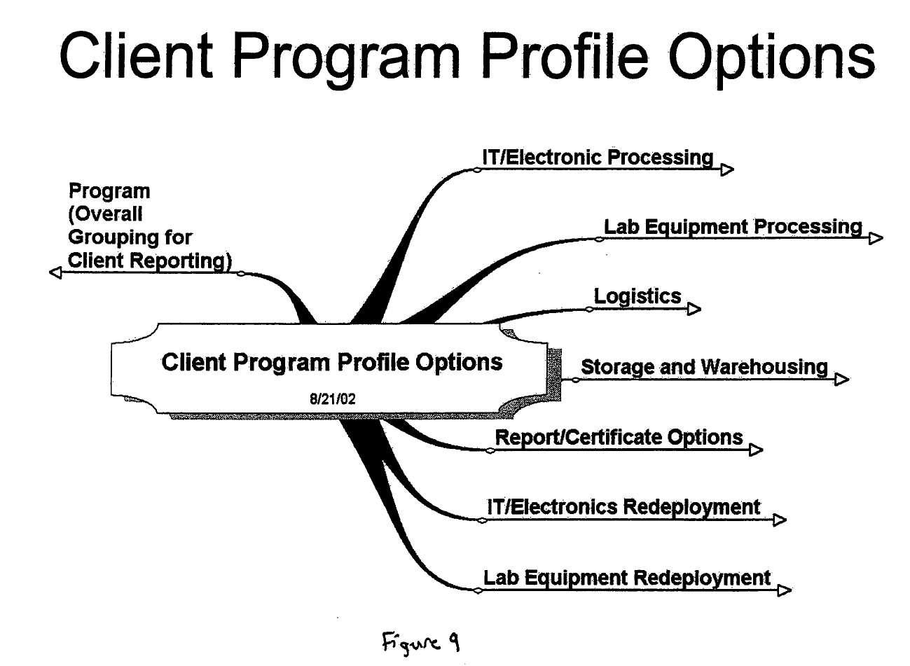

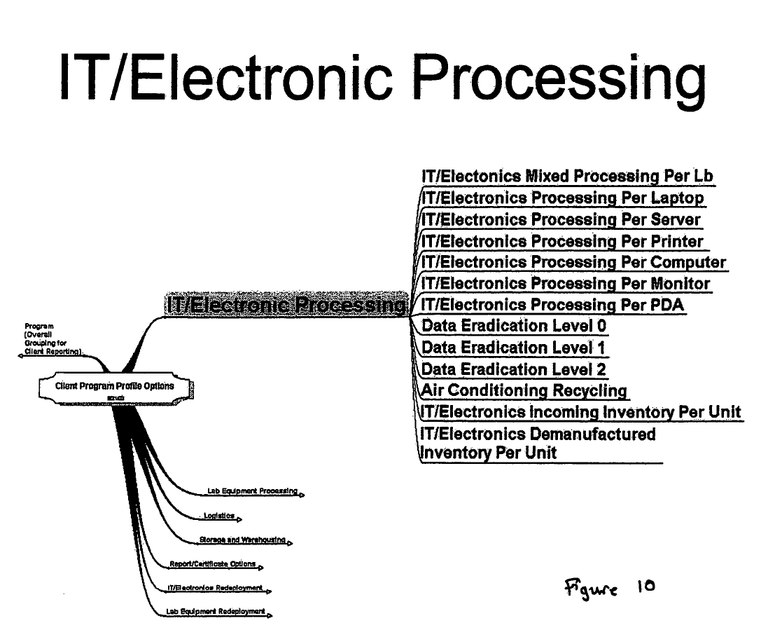

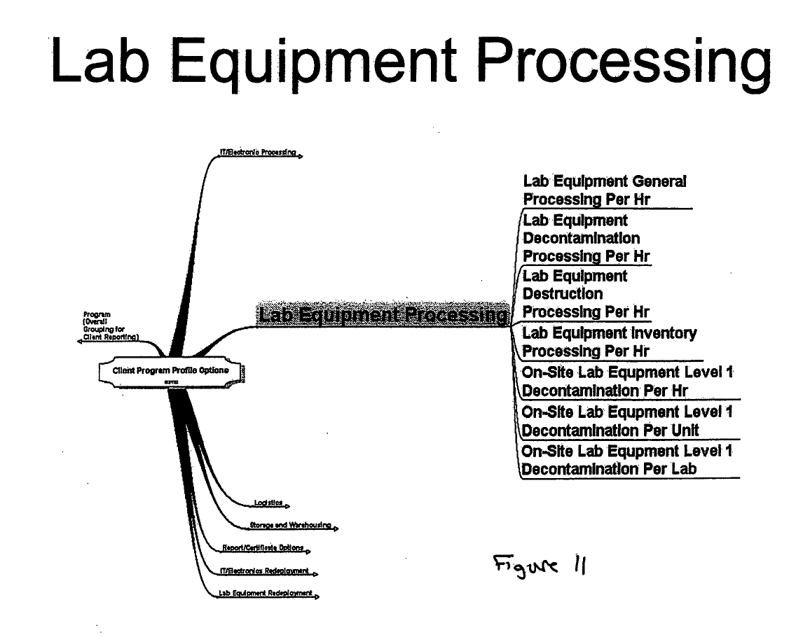

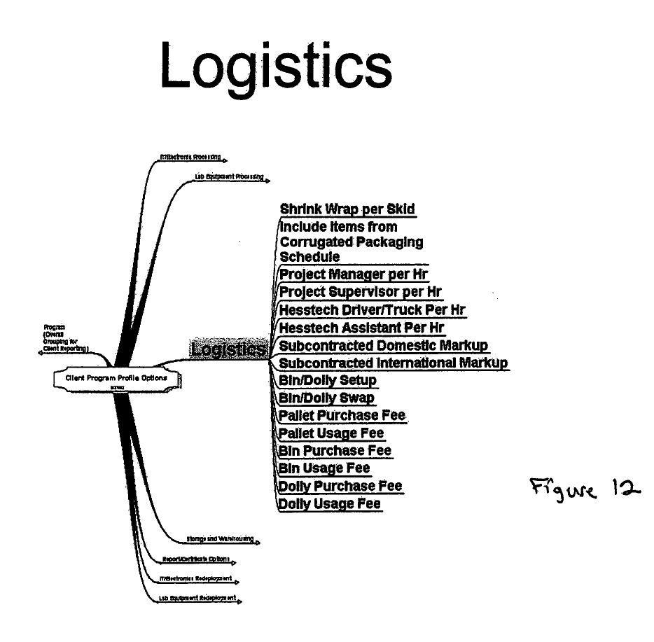

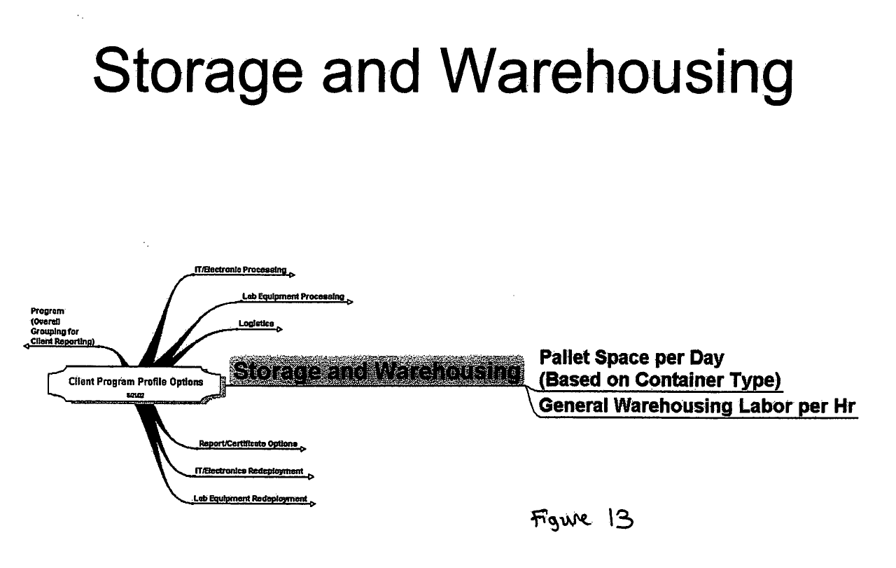

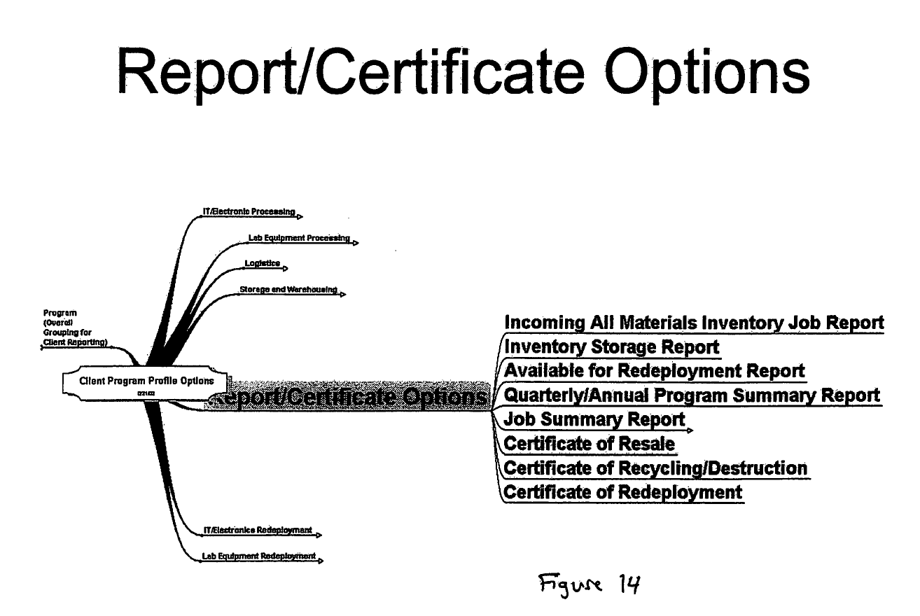

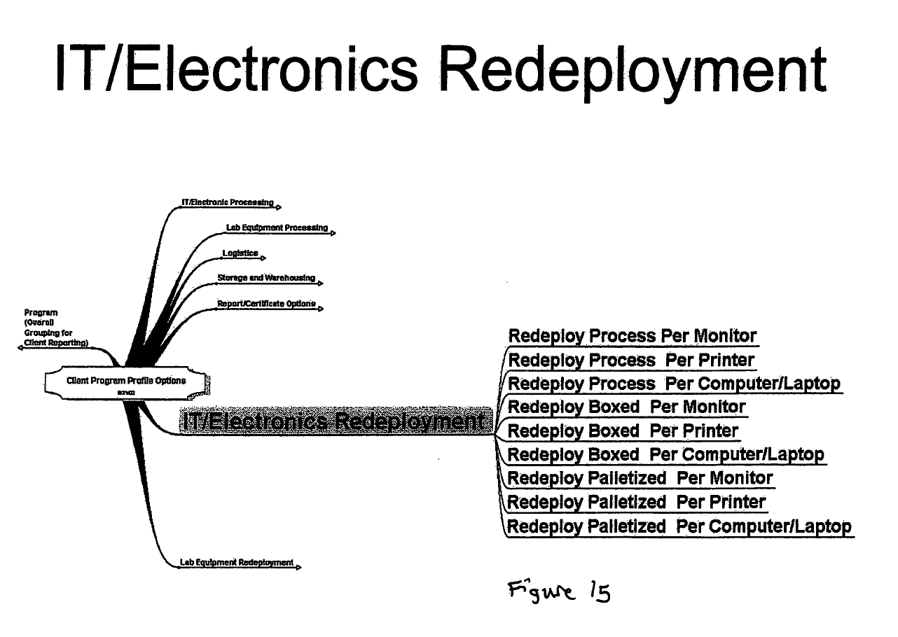

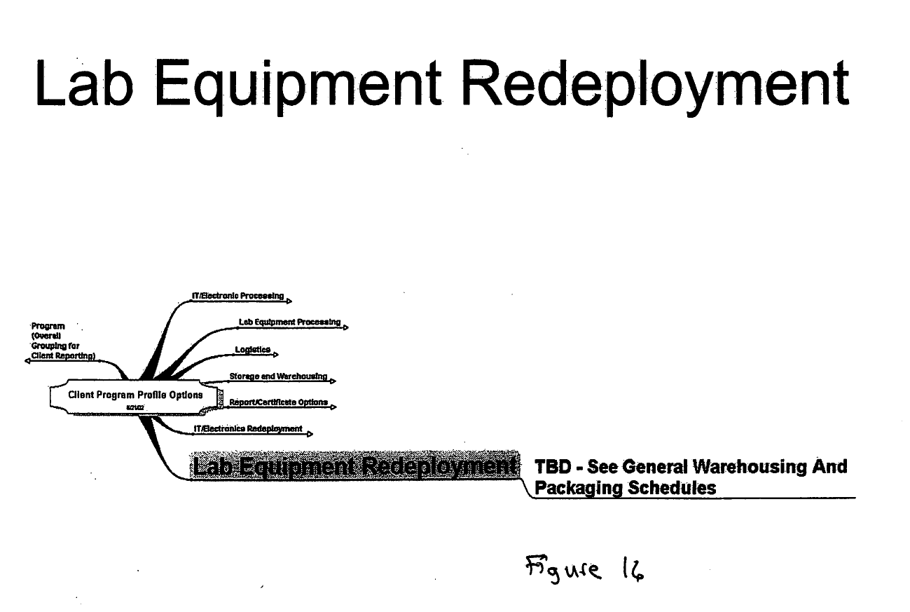

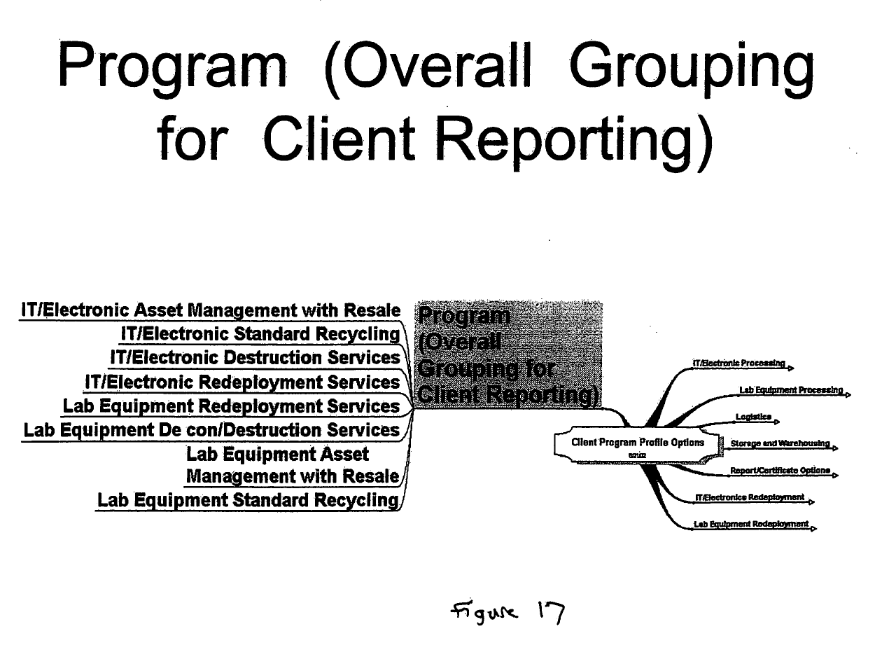

Referring now to FIG. 7, there is shown a flow diagram illustrating multiple line item or lot auctions, running concurrently. Numerous lot or line item auctions may be available at any given time, and for any given item, and may be viewed by the user from an auction inventory page, for example. Further, items may be searchable not only by item type, but by lot or line item type, for example. In an embodiment, an item number, an item type, manufacturer, a make, and/or a model may serve as the search term, and may be individually filtered, such as for security reasons. Clicking on an item number, which may be, for example, a hyperlink, may cause the display of an item detail page. The item detail page may include, for example, the audit trial of the selected item, or selected portions thereof. A description and/or photograph of the item may be provided to the prospective bidder. The prospective bidder may then submit a bid, or add the item to, for example, a watch list, from the item detail page. The auction start date, end date and end time, along with other auction detail, may be persistently provided, such as at the top of each page of a selected auction or item. A default, or a reserve, price for single or multiple items may be entered at one time. This may allow the bidder to filter for a list of items on which the bidder wishes to bid the same amount, and to have all items updated simultaneously. Check boxes may be used to select all, or individual items, to be set at the default bid amount.

Items may be selected for bid, or bid watch, and a bid status form, unique to each user, may be sent. The bid status form may list all items on which the bidder has submitted bids, the items the bidder is watching, current bid status, and items that have been won, lost, or closed in the course of bid.

FIG. 8 illustrates a flow diagram of a bid status form. The bid status form may have, in an exemplary embodiment, three sections that report on the status of each item on a bid list. For example, the submitted bid section may list all items on which the user has bid. A particular color or signifier, such as a green color, may indicate that the bidder had currently submitted the high bid. A different color or signifier, such as a red color, may indicate that the bidder does not currently have the highest bid in that particular auction. The bidder may then increase the current bid from the submitted bids list, and have that bid update entered into the auction system. The bid watch list section may list all items that the user has selected to watch without actually bidding. The current bid price may be available from the bid watch list section. Further, the bidder may enter a bid from the watch list section. The completed list section may list all items the user has selected to watch without actually bidding. Further, this section may list all completed auctions, including those on which the bidder has bid, and the status of each. A green color, or other color, or other differentiating factor, may signify that the bidder has won that auction. A different color, or a different differentiation, may signify that the bidder has lost that auction.

Referring now to FIG. 9, there is shown a flow diagram of an exemplary client profile options implementing the hub and spoke system of FIG. 1, such as in the auction system of FIGS. 5 through 8. As may be seen in FIG. 9, the client program profile options link various aspects, such as the spokes of FIG. 1, for example, with the client reporting function. As shown in FIG. 9, the program or overall grouping for client reporting may be linked to the client program profile options. Also linked to the client program profile options are the various spokes which may be utilized, such as the IT/Electronic Processing, Lab Equipment Processing, Logistics, storage and warehousing, report/certificate options, IT/electronics redeployment and lab equipment redeployment.

Referring now to FIG. 10, there is shown a flow diagram of the IT/electronic processing module of FIG. 9. As may be seen in FIG. 10, the IT/Electronic Processing may include, by way of non-limiting example only, electronics mixed processing per pound, processing per laptop, per server, per printer, per computer, per monitor, and per PDA. Further, the electronic processing may include accounting for data eradication levels indicative of the processing, such as level 1, 2, or 3. Further, the processing may include accounting for each incoming inventory unit.

Referring now to FIG. 11, there is shown a flow diagram of the Lab Equipment processing module of FIG. 9. As may be seen in FIG. 11, the lab equipment processing may include general processing per hour, decontamination processing per hour, destruction per hour and inventory processing per hour.

Referring now to FIG. 12, there is shown a flow diagram of the Logistics module of FIG. 9. As may be seen in FIG. 12, the logistics module may include shrink wrap per skid, accounting for personnel such as a manager, supervisor or other required personnel. Other setup fees and cost may be itemized such as bin or dolly setup fees, pallet fees, and other necessary charges.

Referring now to FIG. 13, there is shown a flow diagram of the storage and warehousing module of FIG. 9. Such storage and warehousing may include itemization of pallet space per day identified for selected container types and additional general warehousing costs per hour such a labor.

Referring now to FIG. 14, there is shown a flow diagram of the report/certificate options module of FIG. 9. The report certification options may include itemization of all materials inventoried for a job, a storage report, identification of materials or parts identified for redeployment, job summaries, and various certificates.

Referring now to FIG. 15, there is shown a flow diagram of the electronics redeployment module of FIG. 9. As may be seen in FIG. 15, electronics redeployment may be itemized by monitor, printer and computer/laptop in such increments as process, box and pallets.

Referring now to FIG. 16, there is shown a flow diagram of an exemplary lab equipment redeployment module of FIG. 9.

Referring now to FIG. 17, there is shown a flow diagram of the overall grouping for the client reporting of FIG. 9. As may be seen in FIG. 17, the client reporting may include groups such as asset management with resale, standard recycling, destruction services, redeployment services for electronics and/or lab equipment.

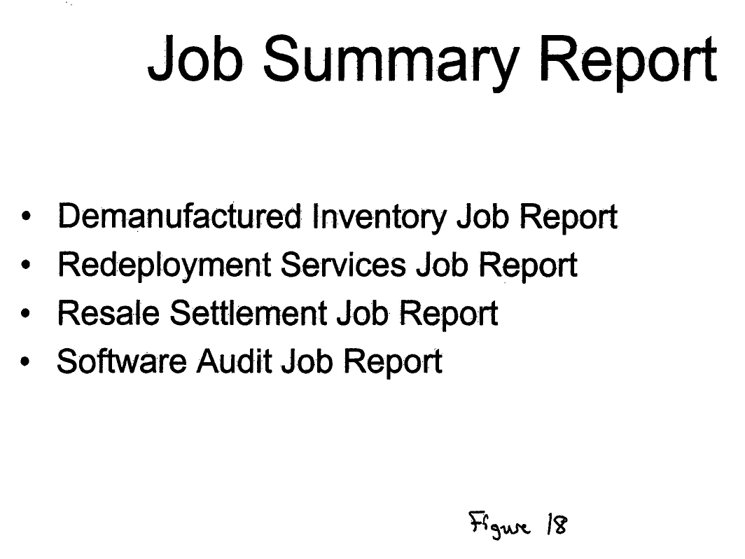

Referring now to FIG. 18, there shown a list of potential job summary reports which may be generated by the present invention including demanufactured inventory, redeployment, resale settlement and software audit reports.

In addition, there may be a need or requirement to track and report information regarding data, software, and/or hardware eradication in one program. The present invention may incorporate each of these elements. For example, as discussed above, individual hardware items may be tracked and inventoried. Additionally, software may be identified on a computer system and tracked similarly to the component level tracking of hardware. Further, data components may be tracked.

For example, the registry information on a computer may be tracked. This provides assurances to those involved, such as the original owner of the computer, that data and software are being eradicated such as by disk or disk formatting before sending the computer to the inventory system. The present invention is capable of interrogating the computer system to determine which software applications were sly resident on the machine even after such a disk format. This may provide ownership and separates licenses, such as software licenses, from the hardware in which they reside. This may allow for example, a computer owner to discard a computer system while accounting for the software licenses, thereby permitting the licensed software to be added to another machine without purchasing a new software license.

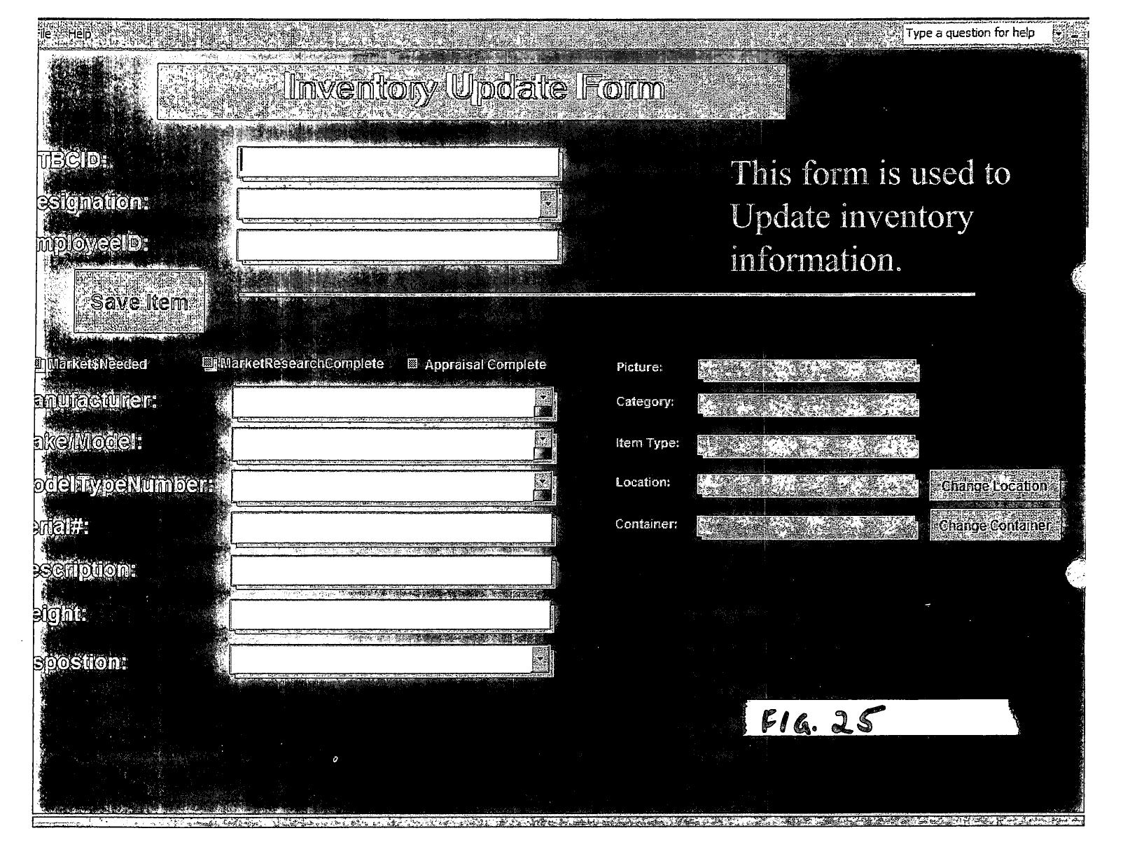

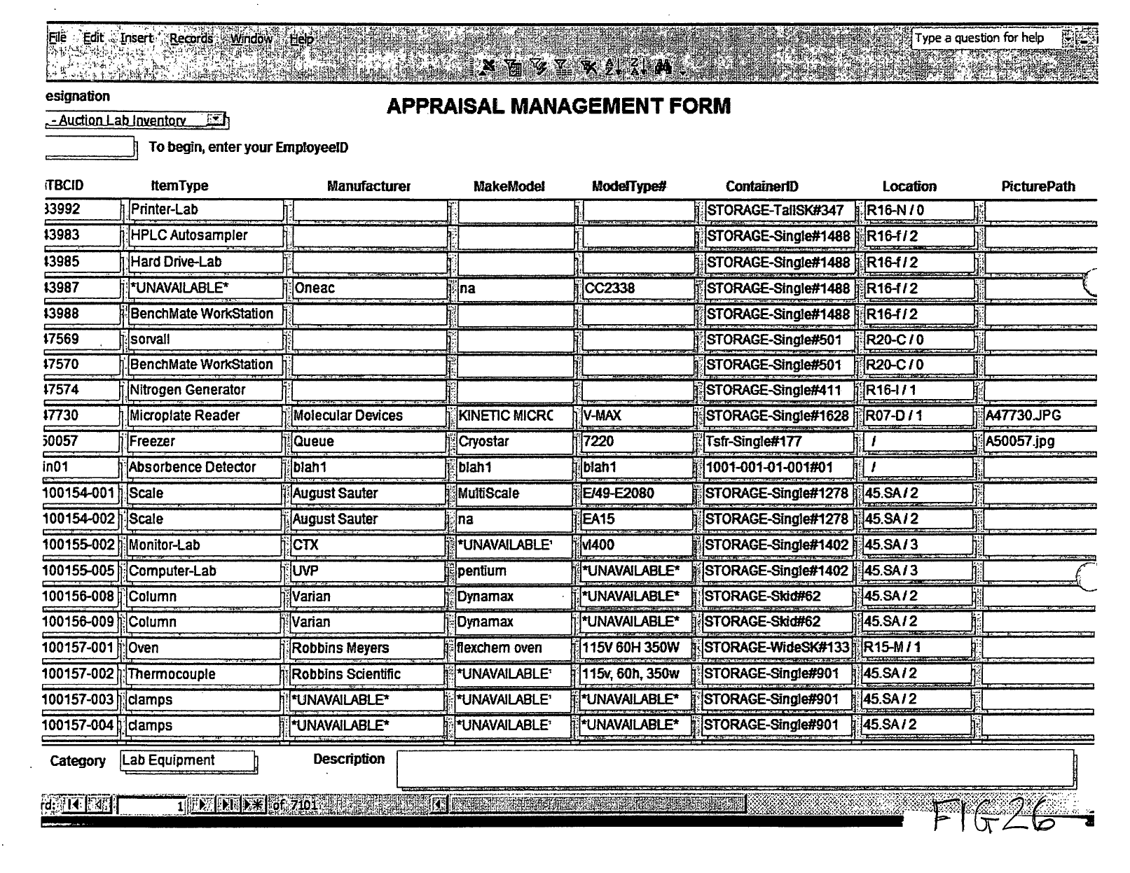

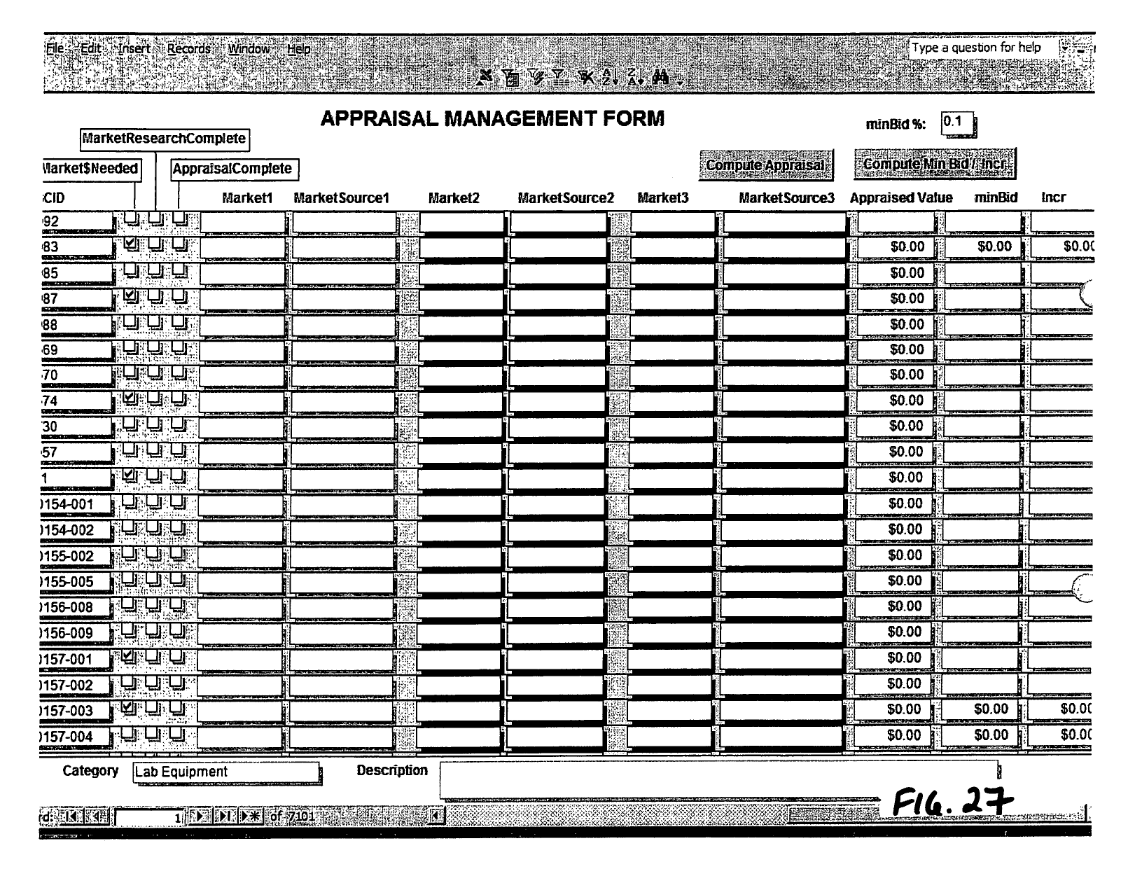

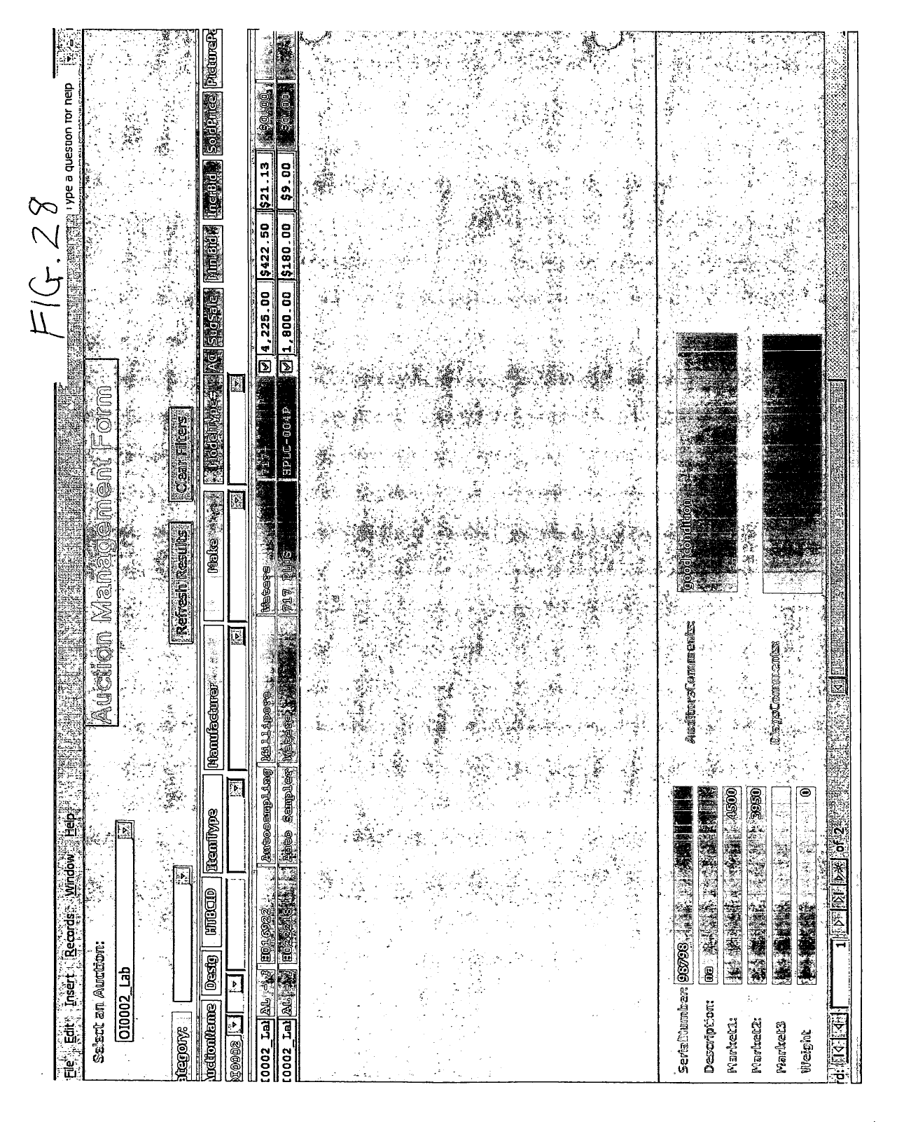

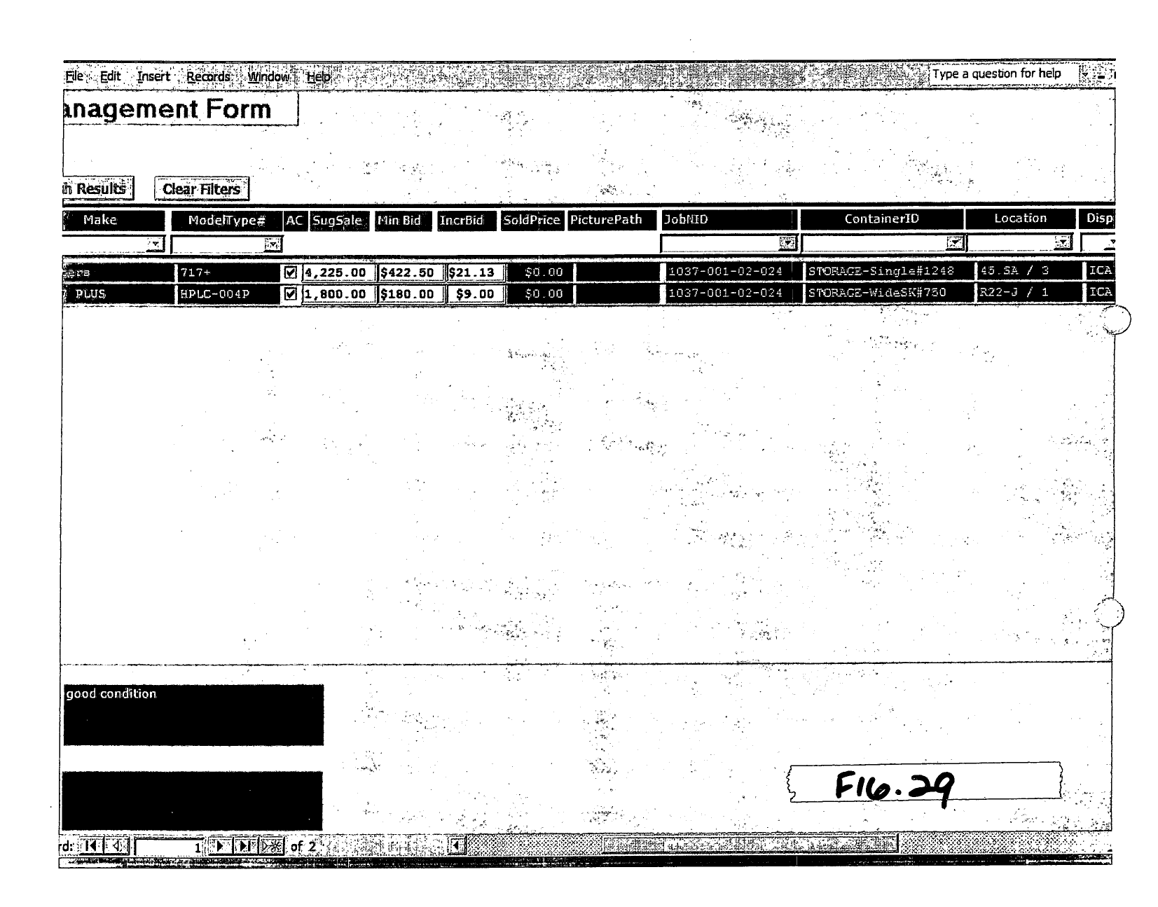

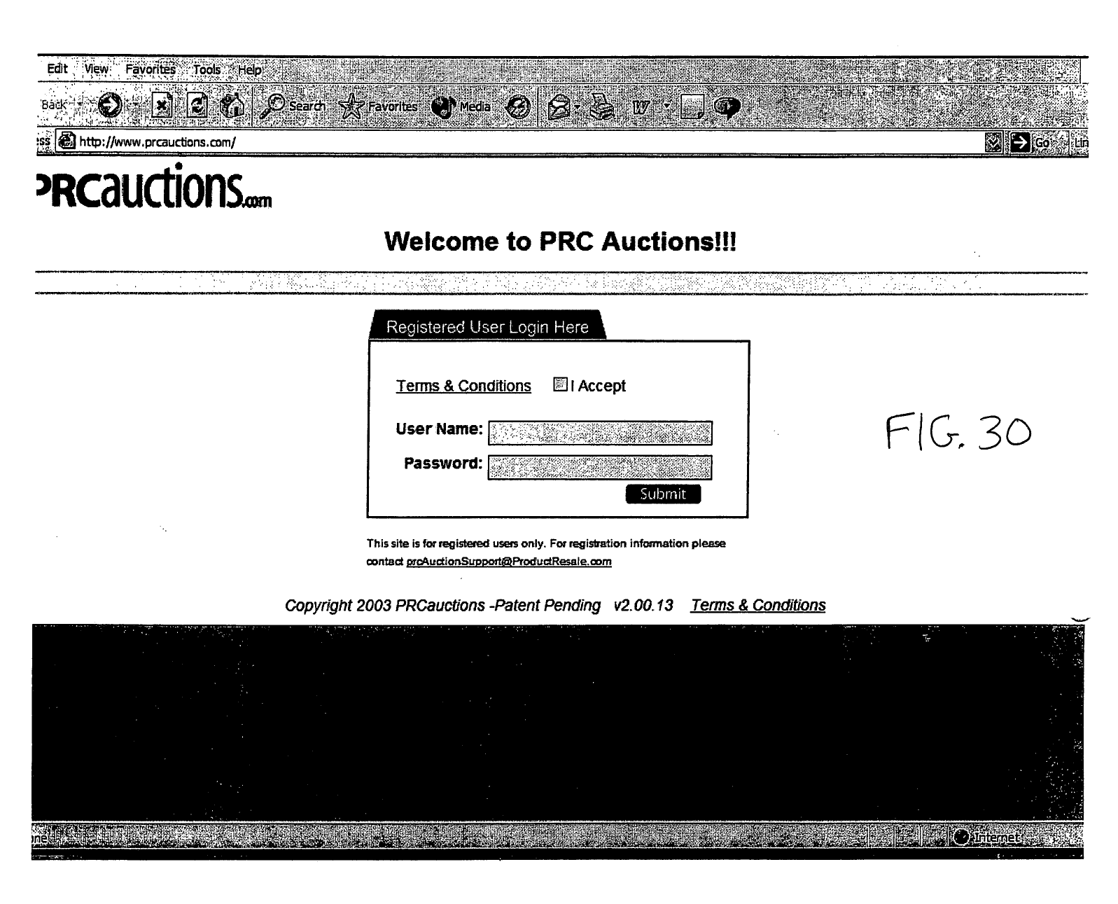

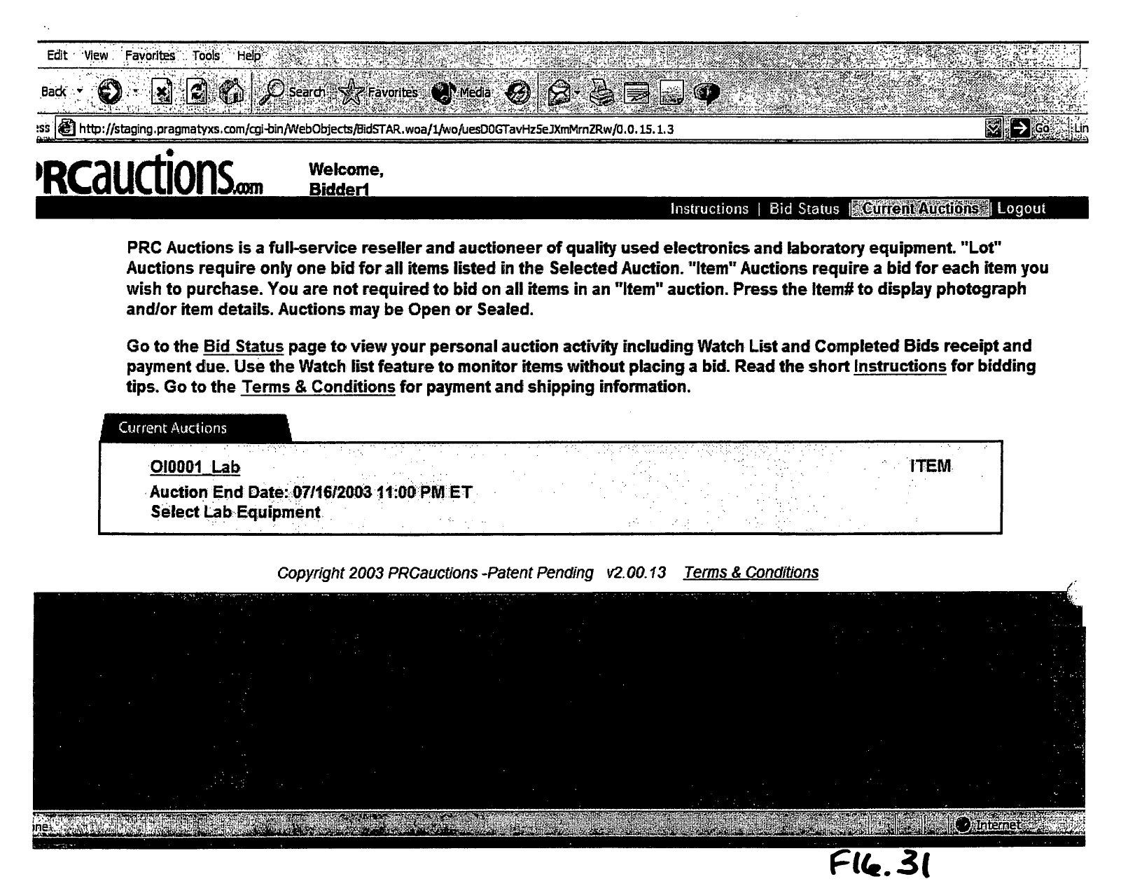

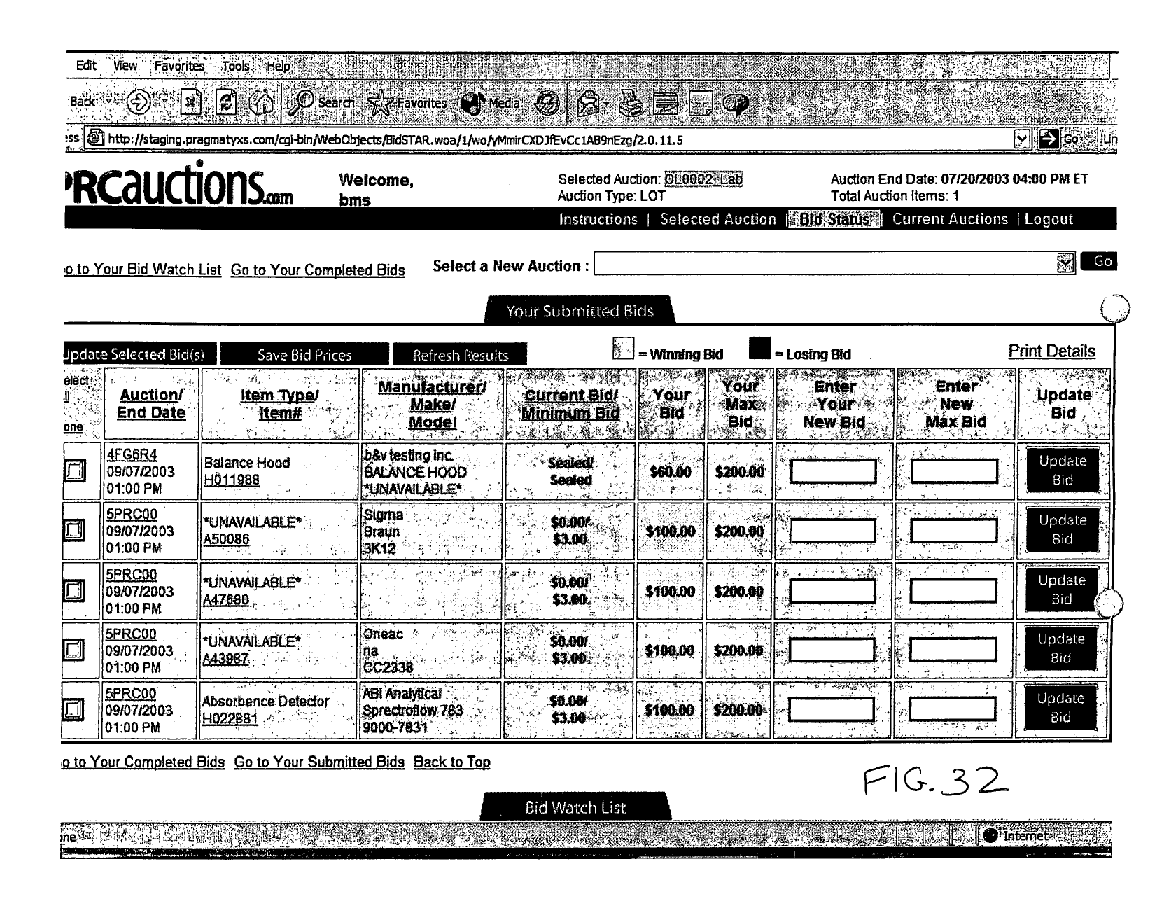

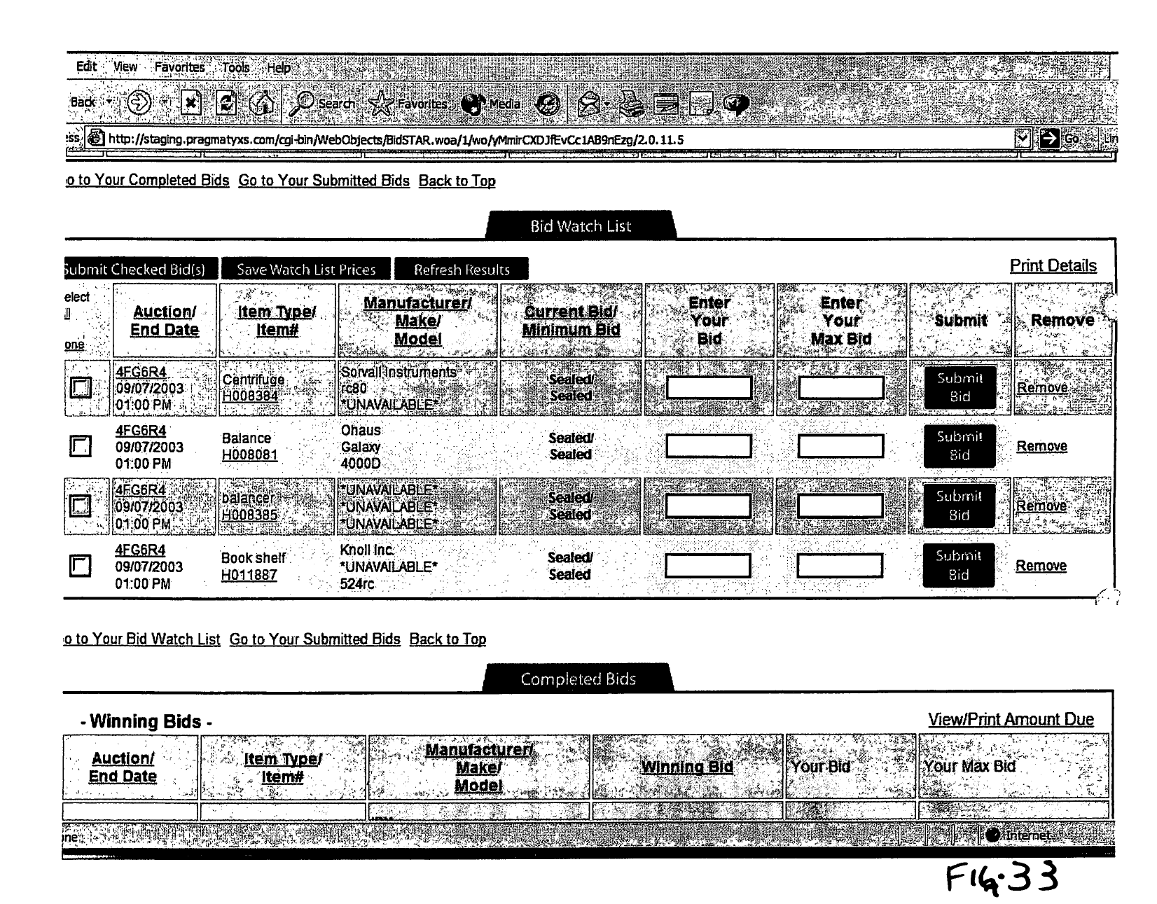

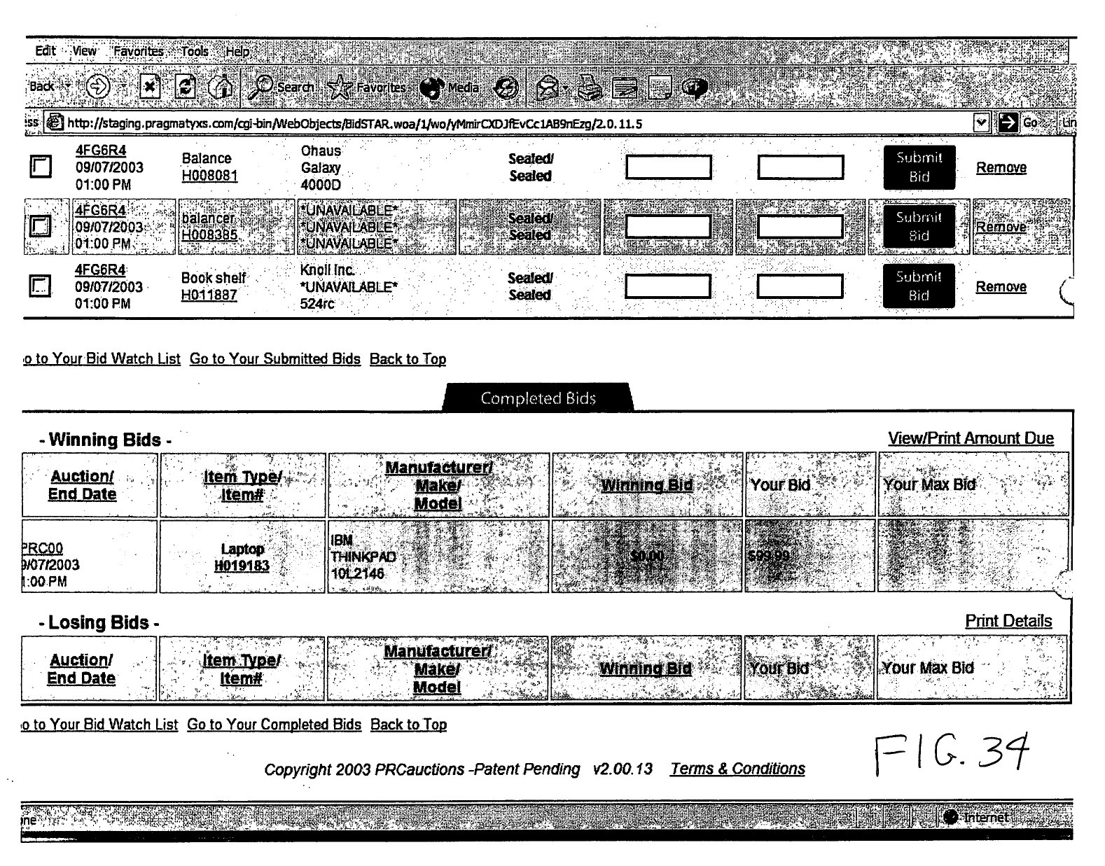

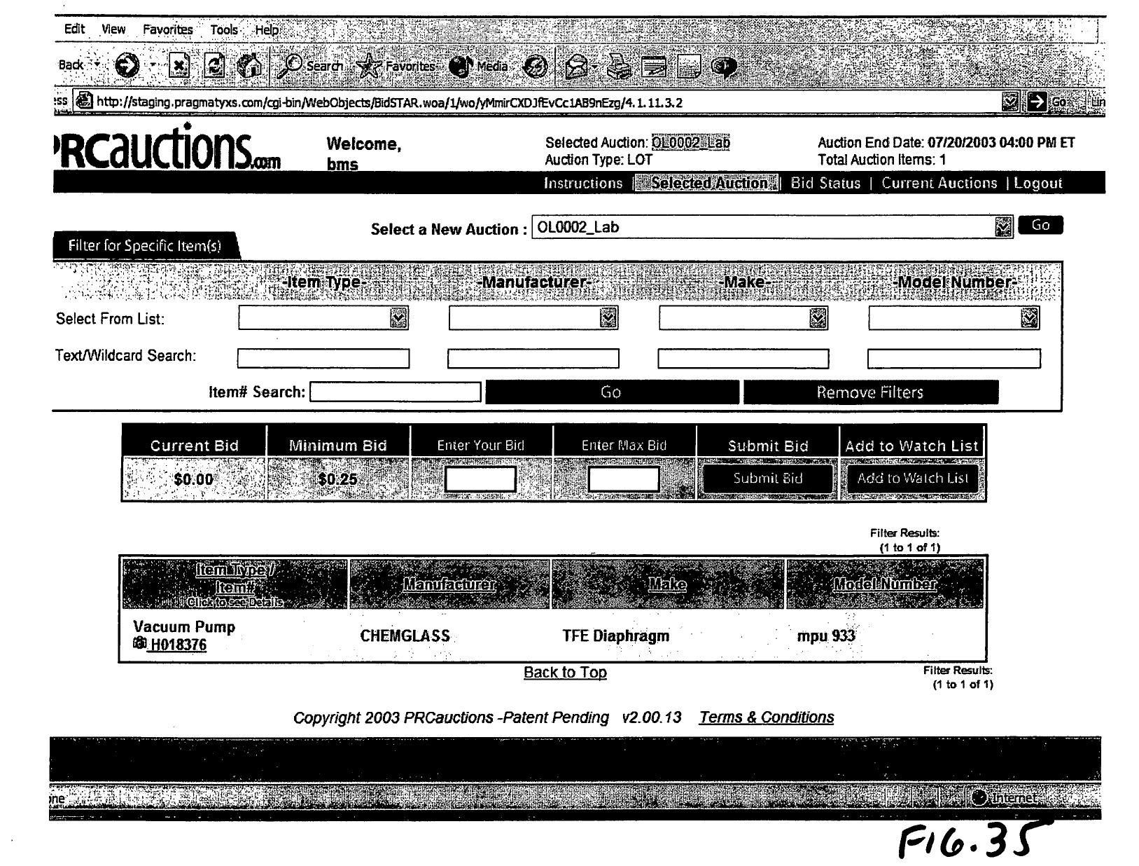

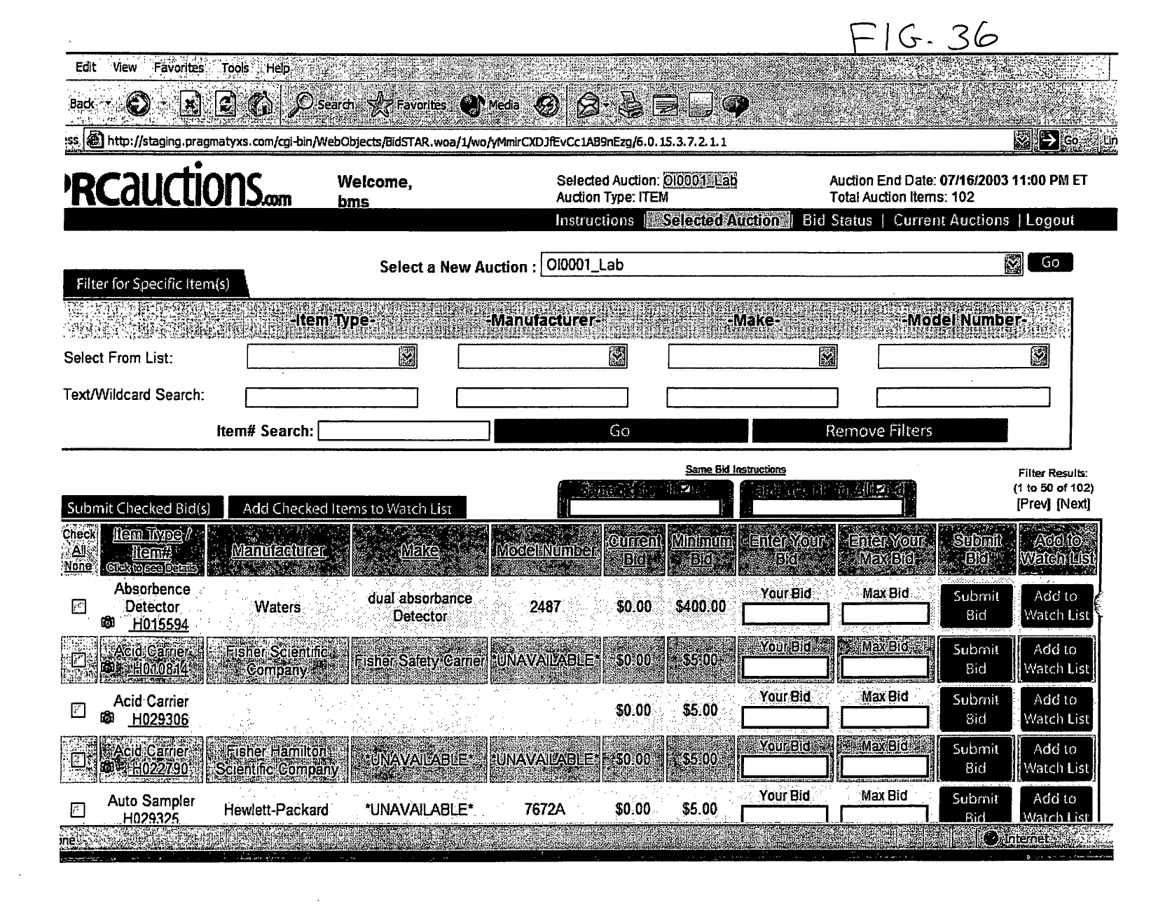

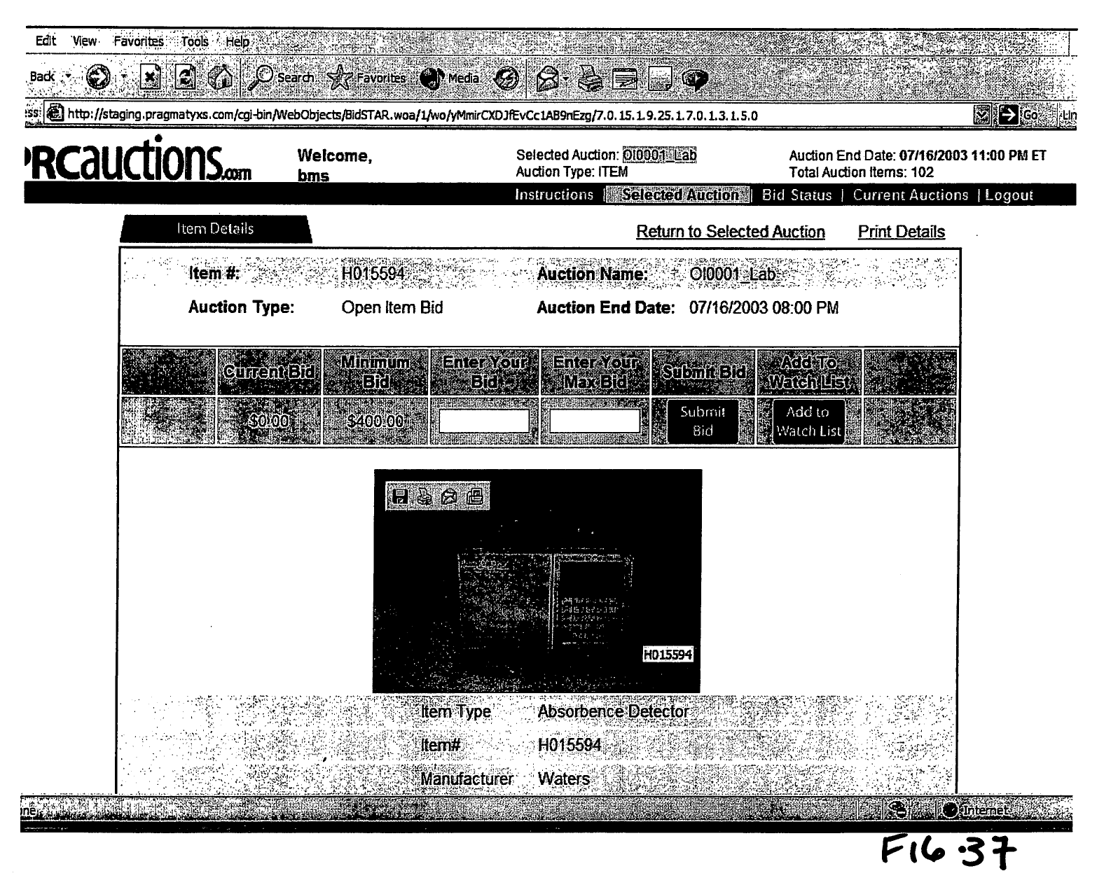

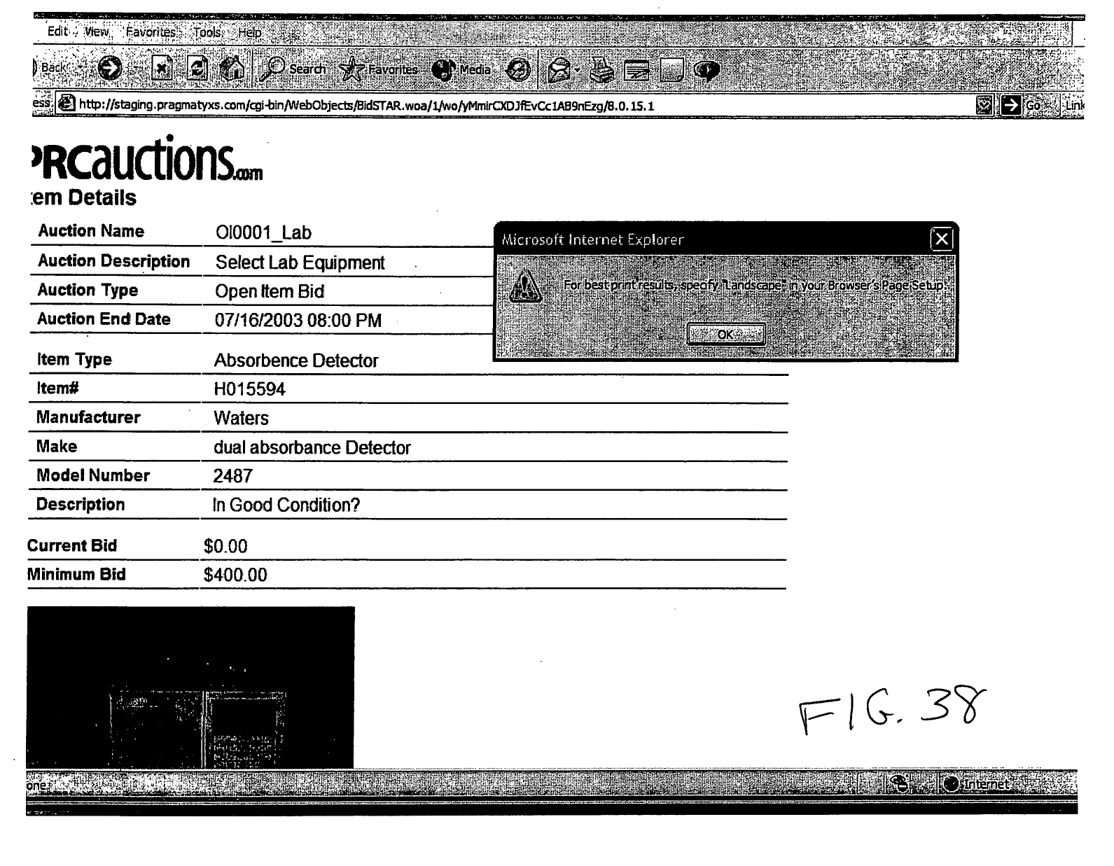

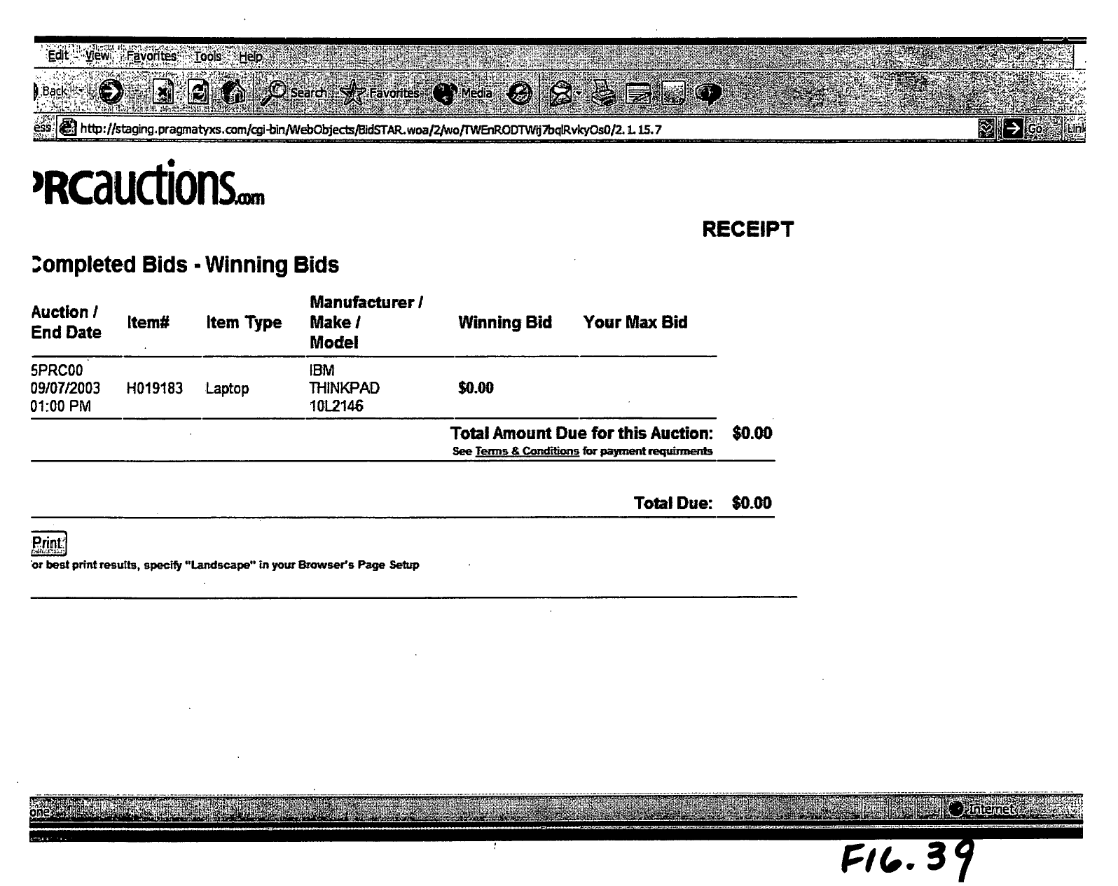

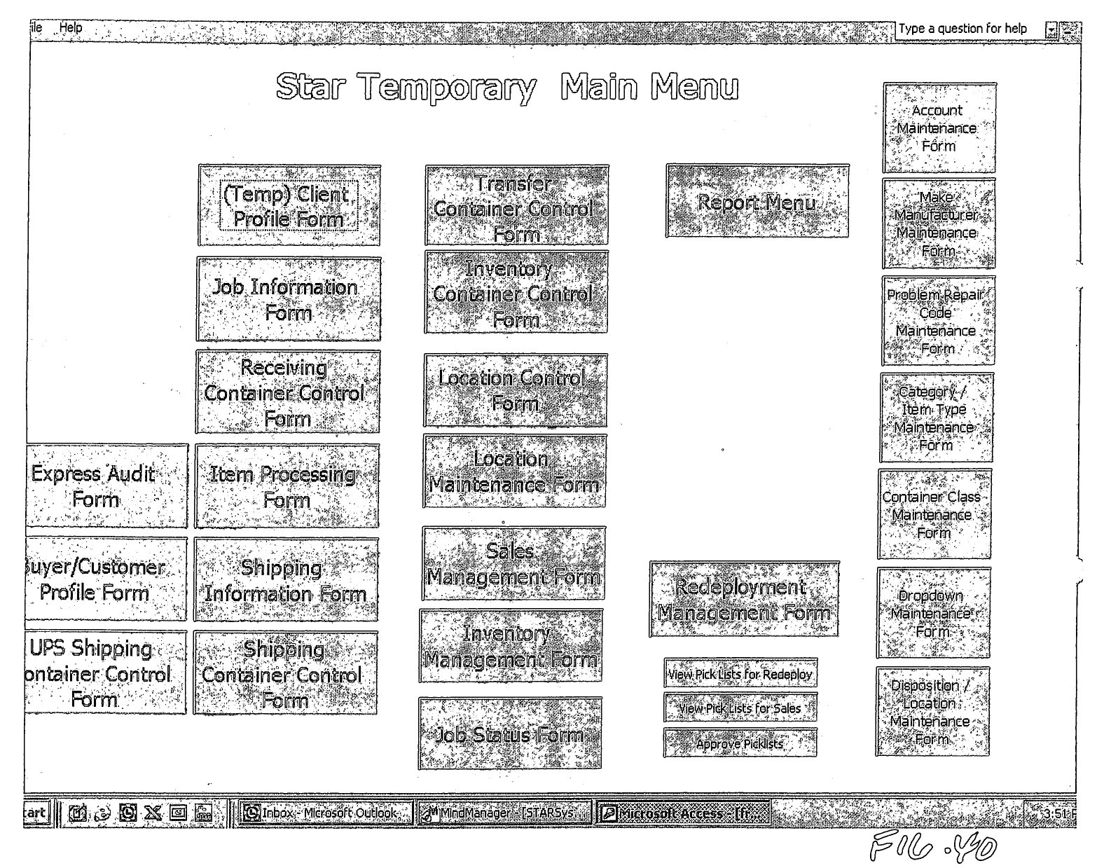

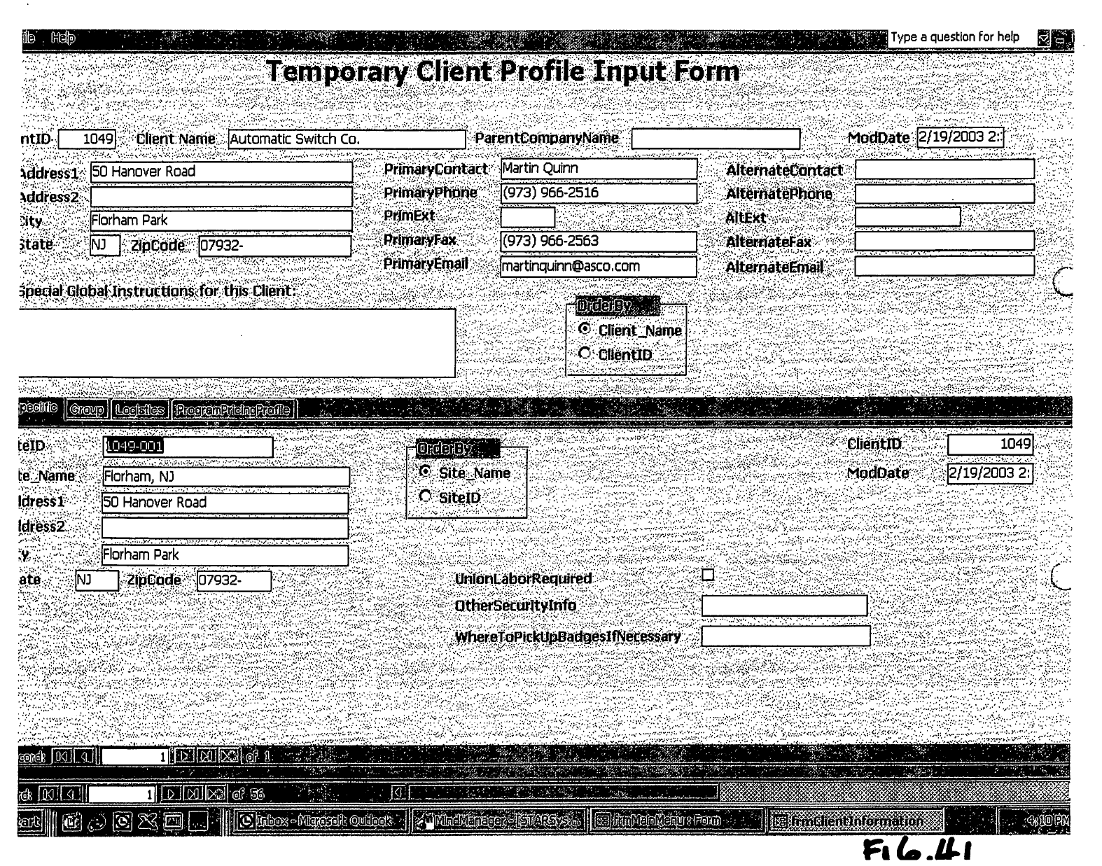

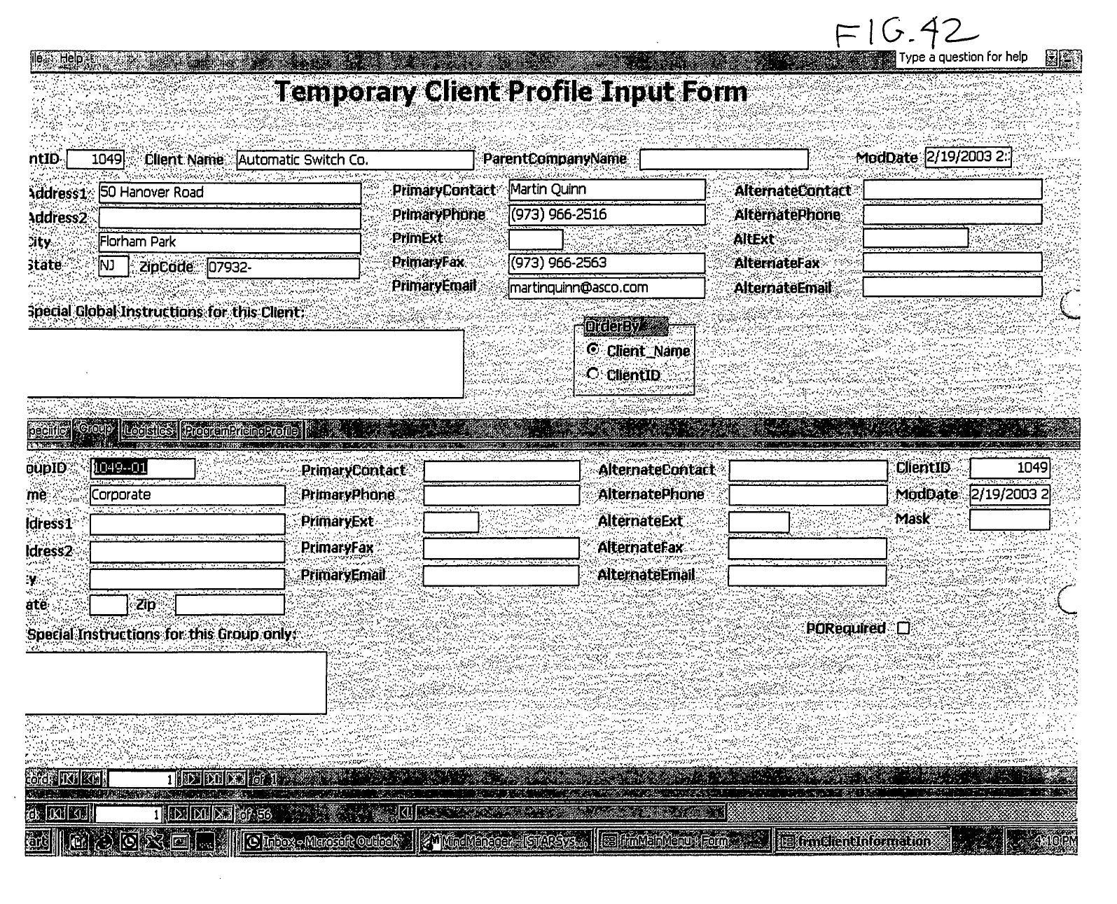

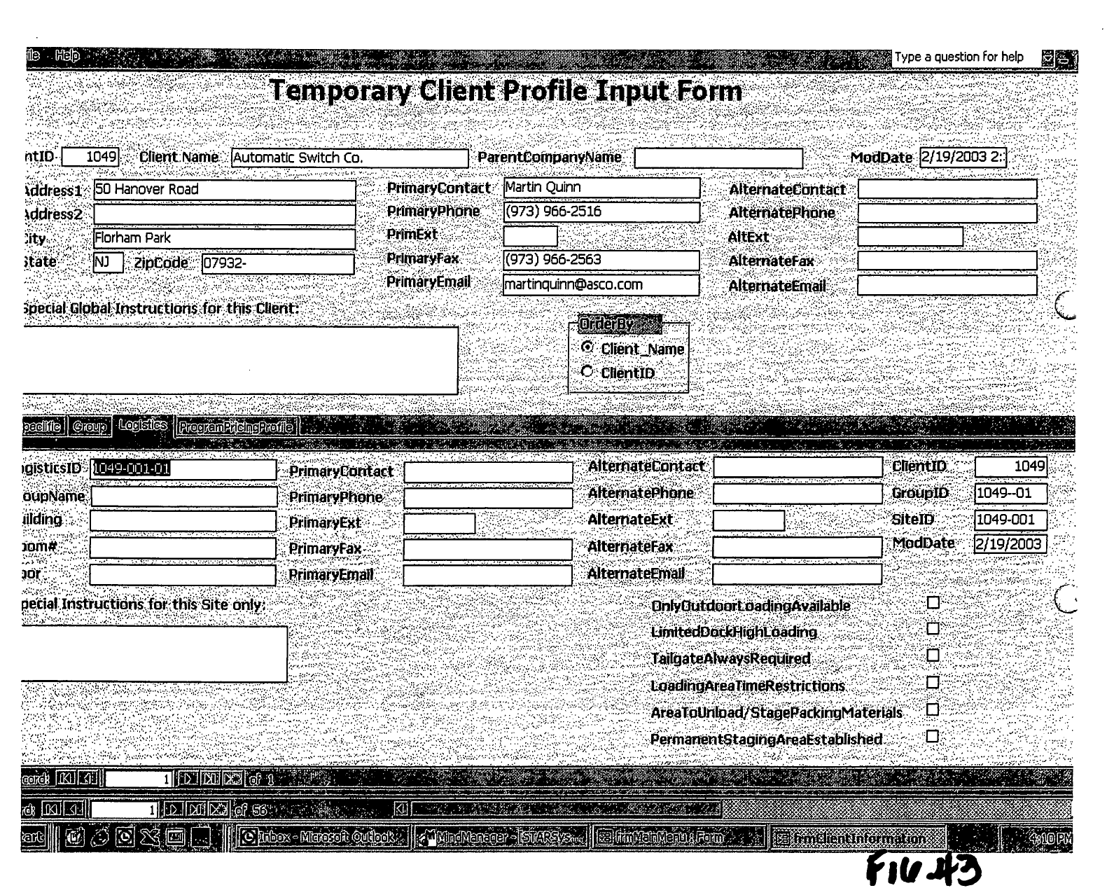

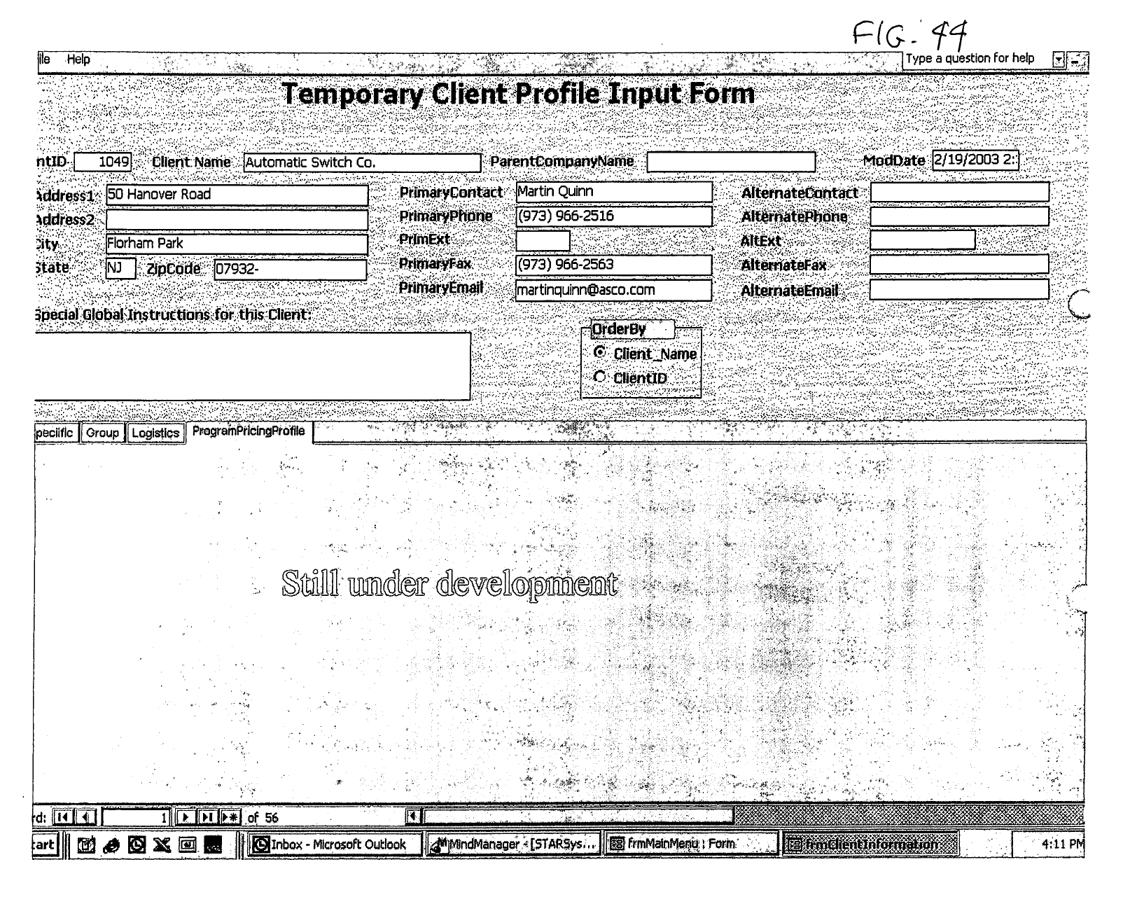

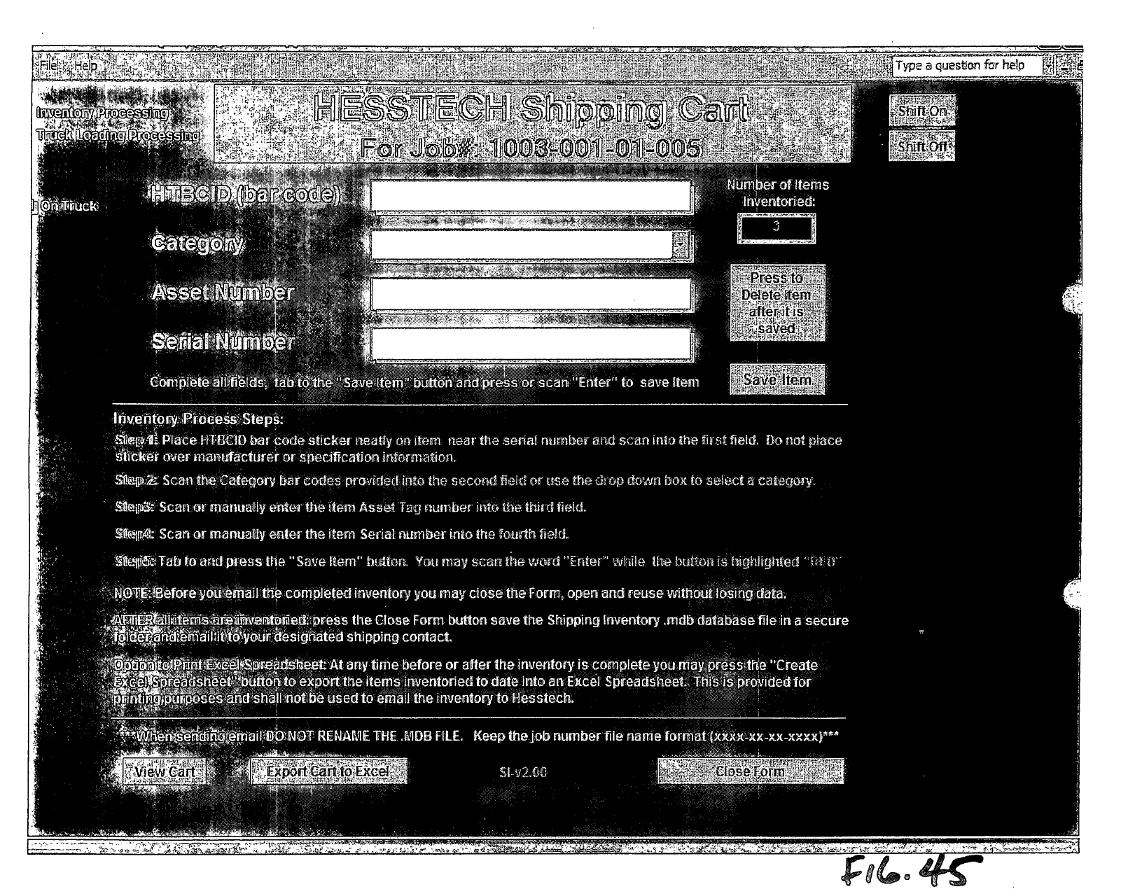

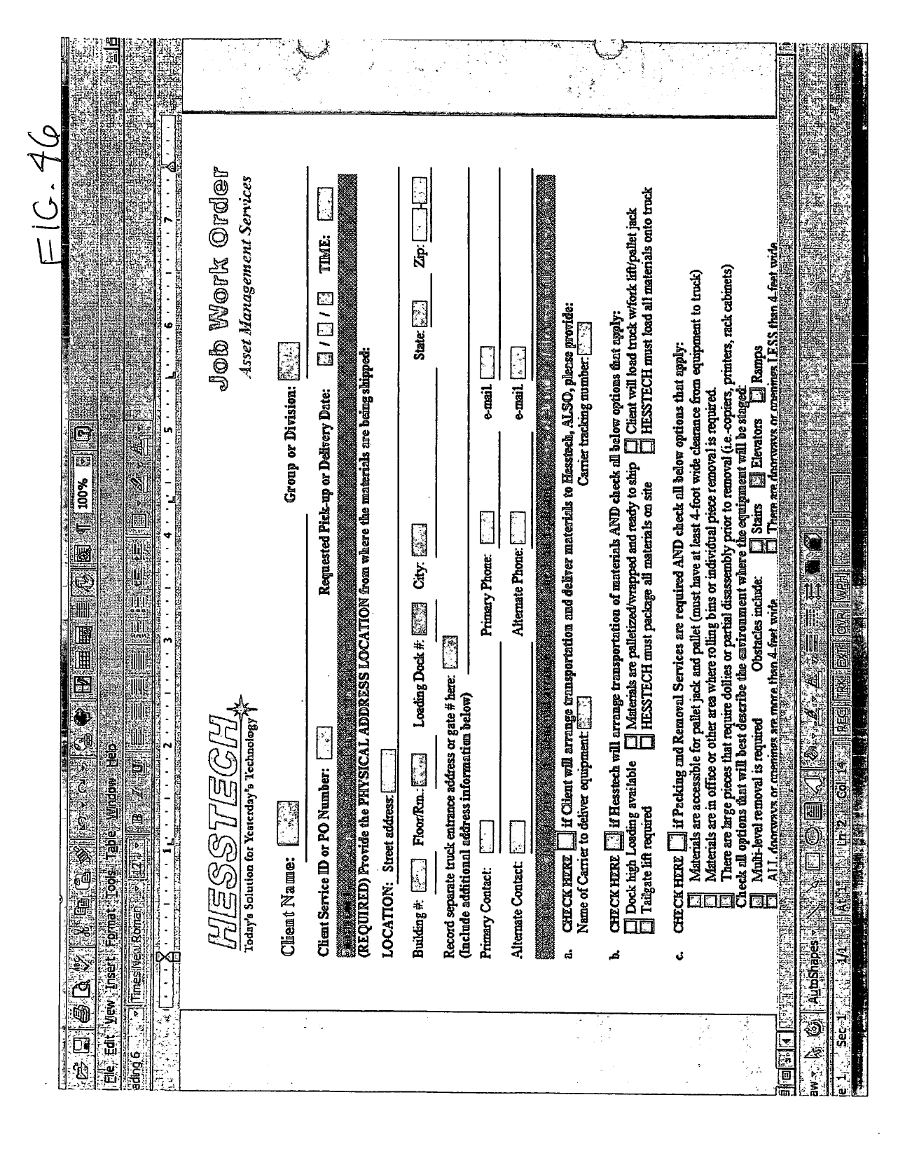

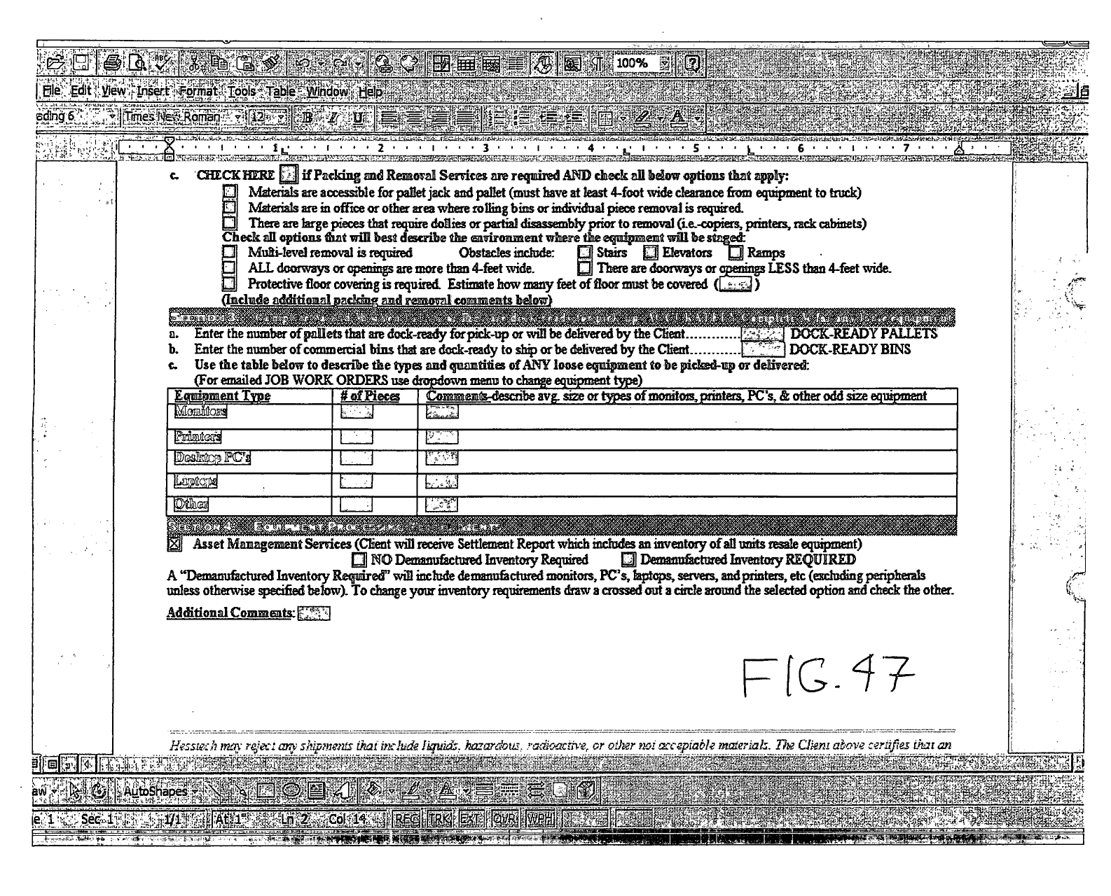

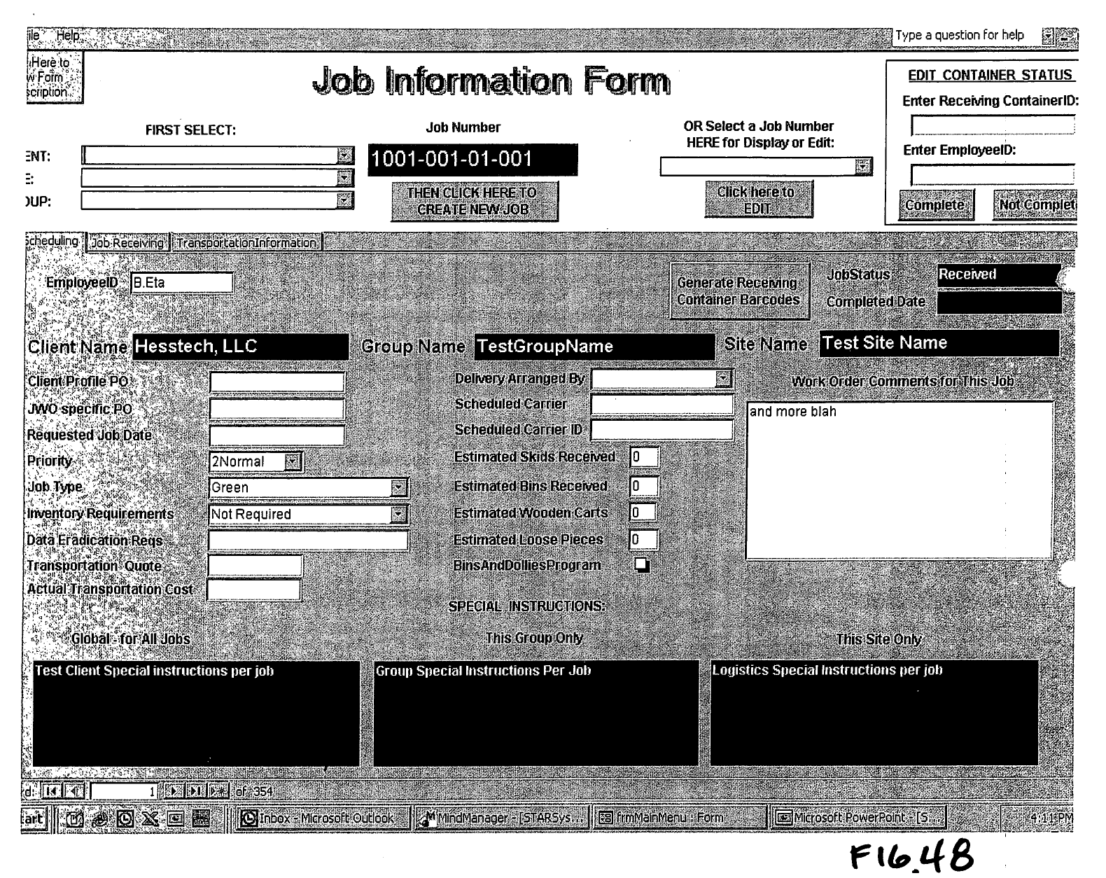

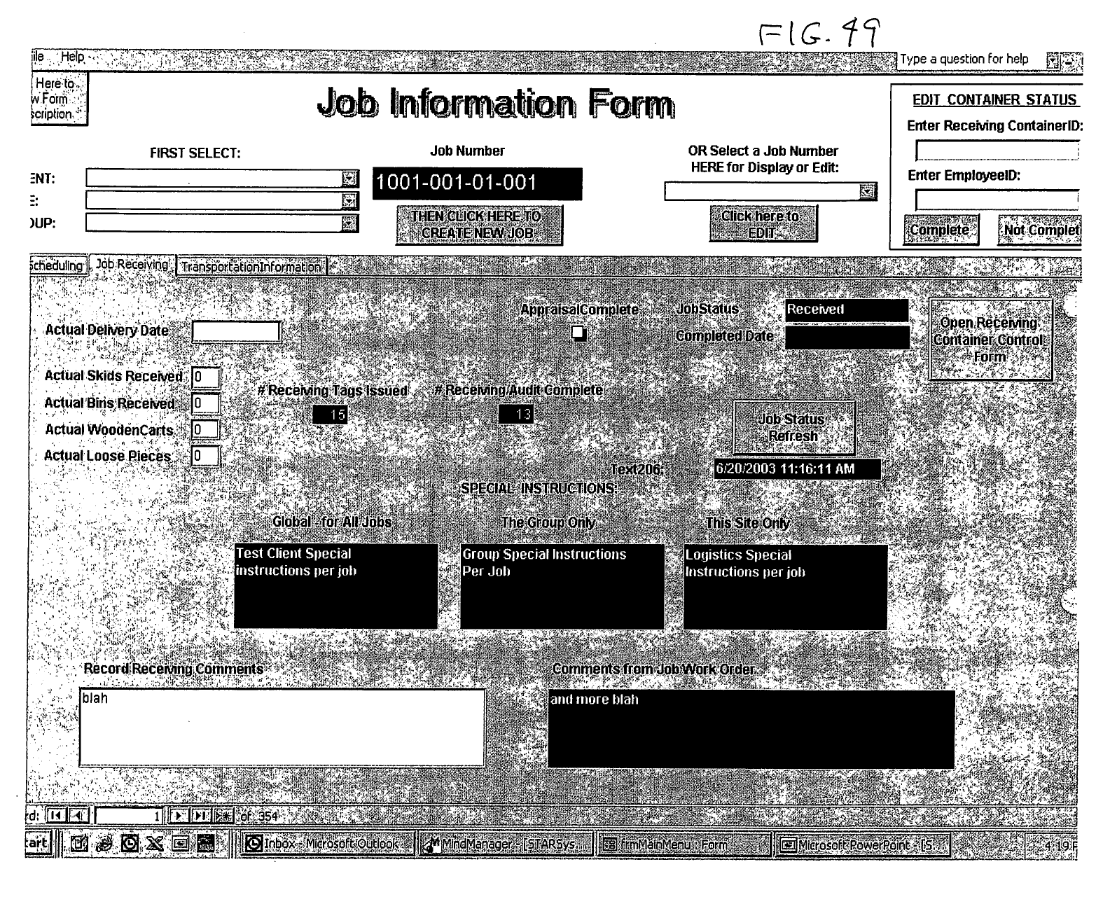

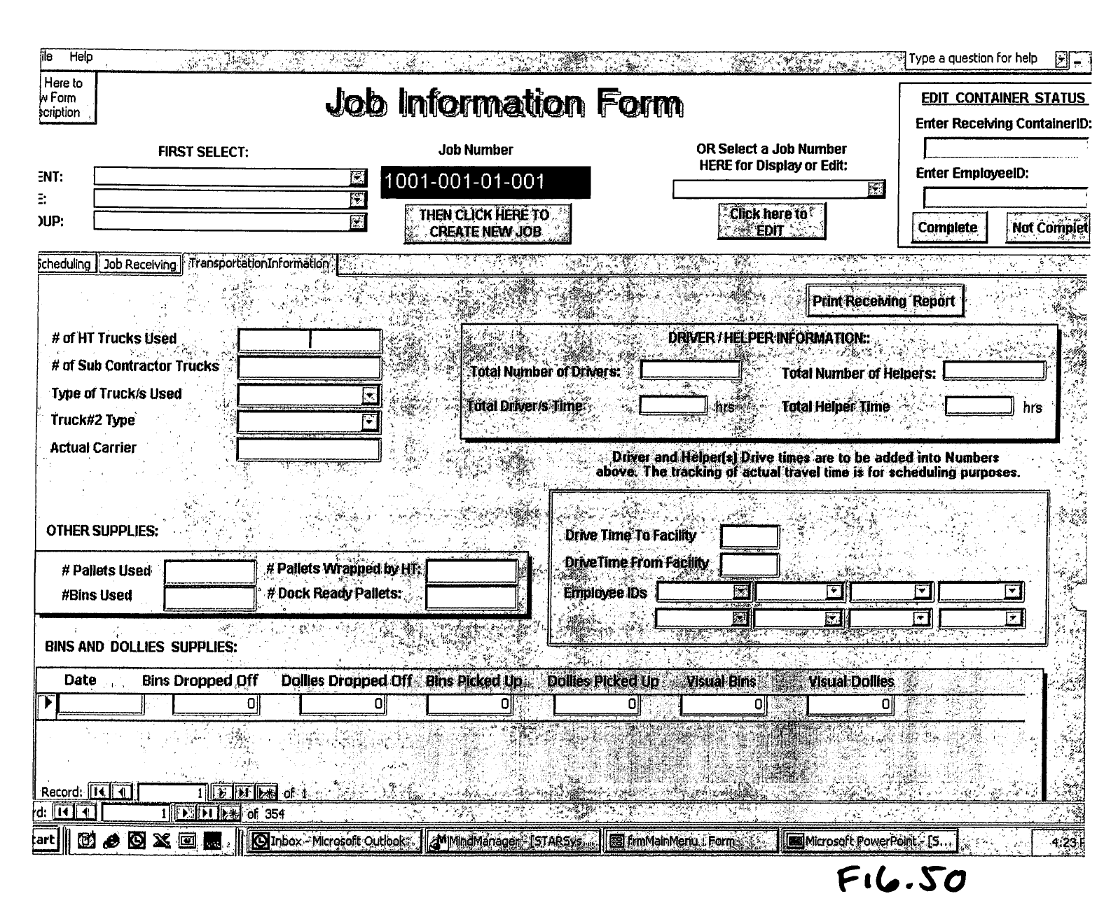

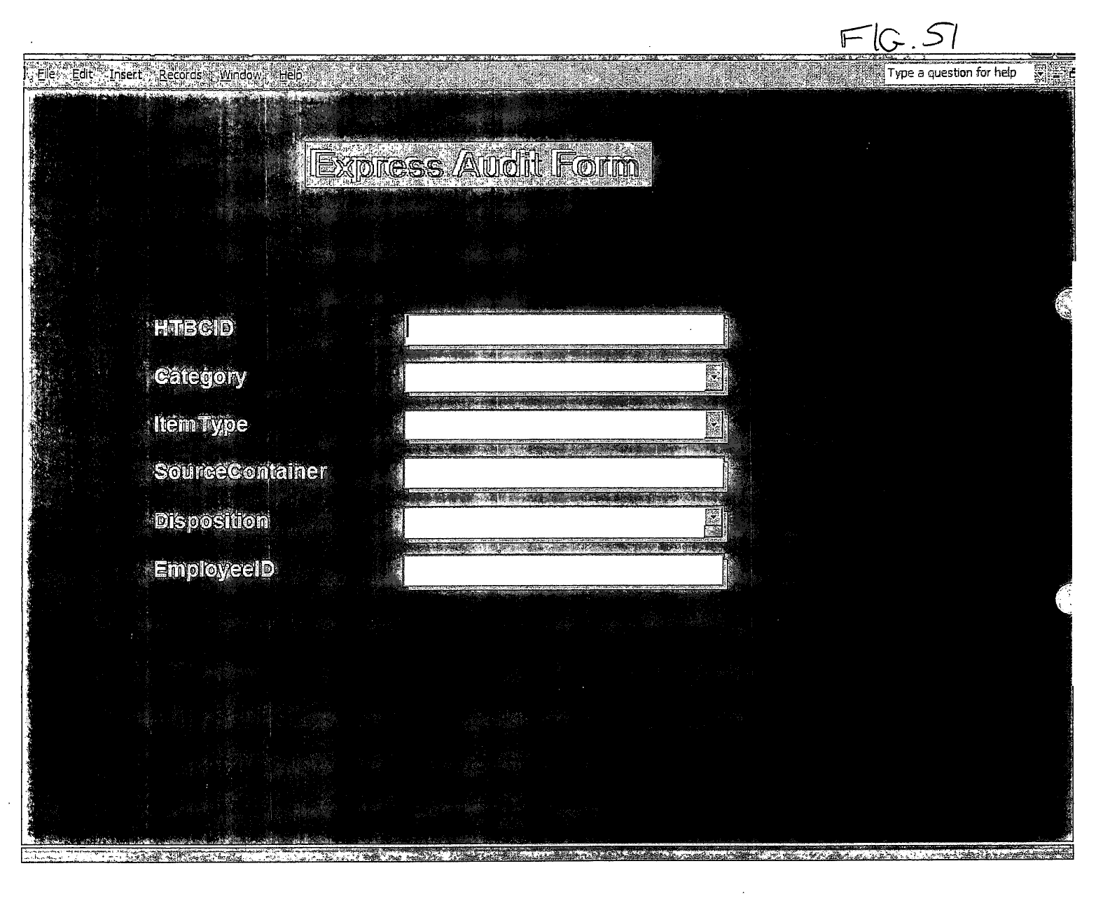

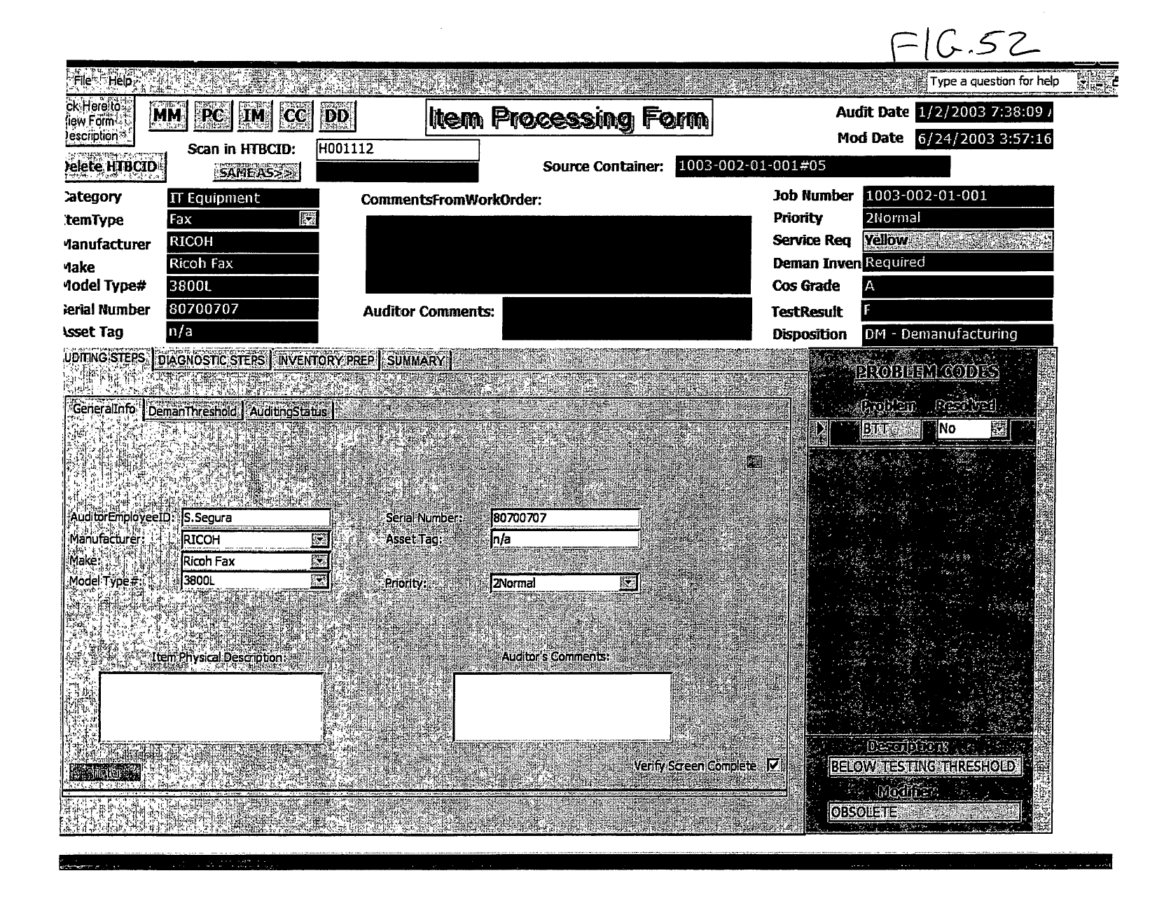

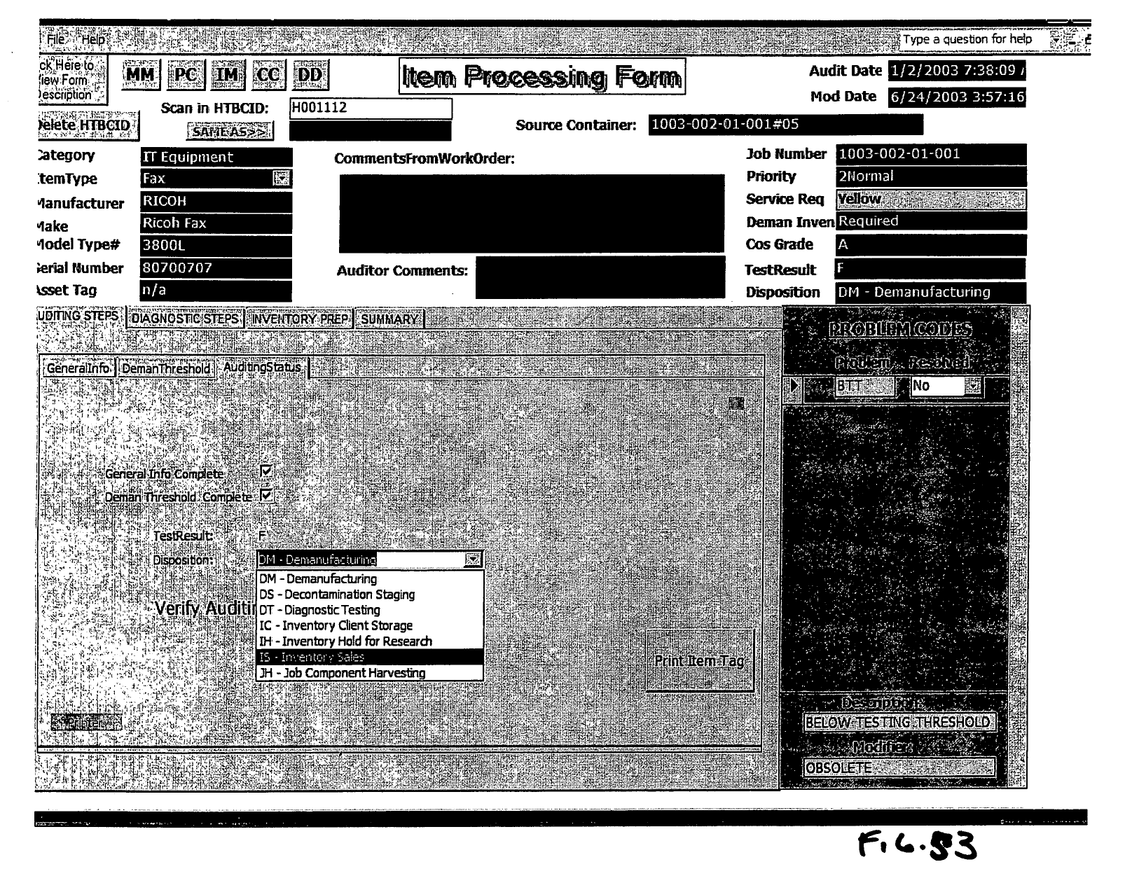

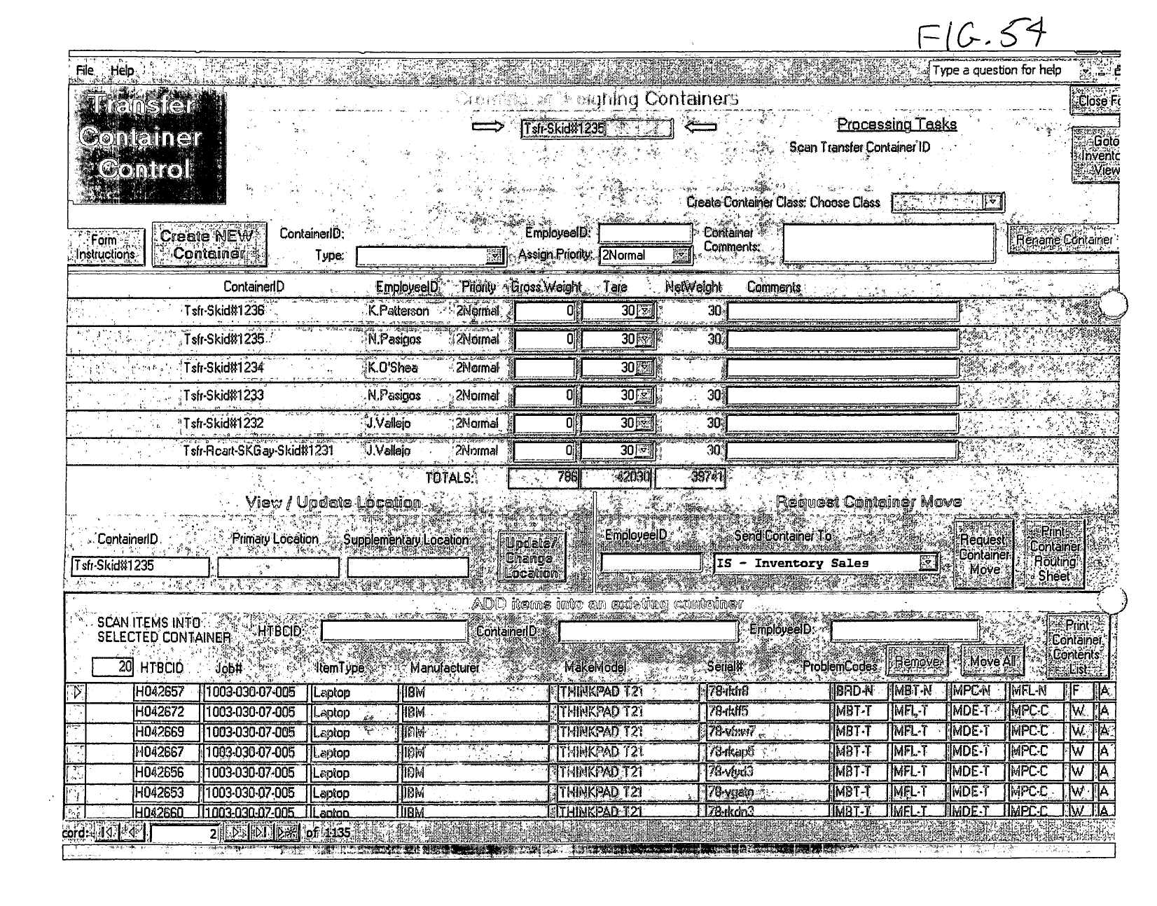

FIGS. 19-54 are screen shots illustrative of aspects of the present invention. These screen shots illustrate, for example, in FIGS. 19-24, the auction of inventory items, including used inventory items. In FIGS. 25-27, the screen shots illustrate inventory updating, searching , managing and/or appraising. Screen shots of FIGS. 28-39, illustrate, for example, the management of an auction, including the entry and searching of item information, logging in to an auction, searching auction items and bidding, including bid breakdowns and watch items. Screen Shot of FIG. 40 illustrates an exemplary main menu entry screen for entry to the network of the present invention. FIGS. 41-45 illustrate the input of various information items regarding client profiles. FIGS. 46-54 illustrate the entry of various inventory related information, including item and job information and processing.

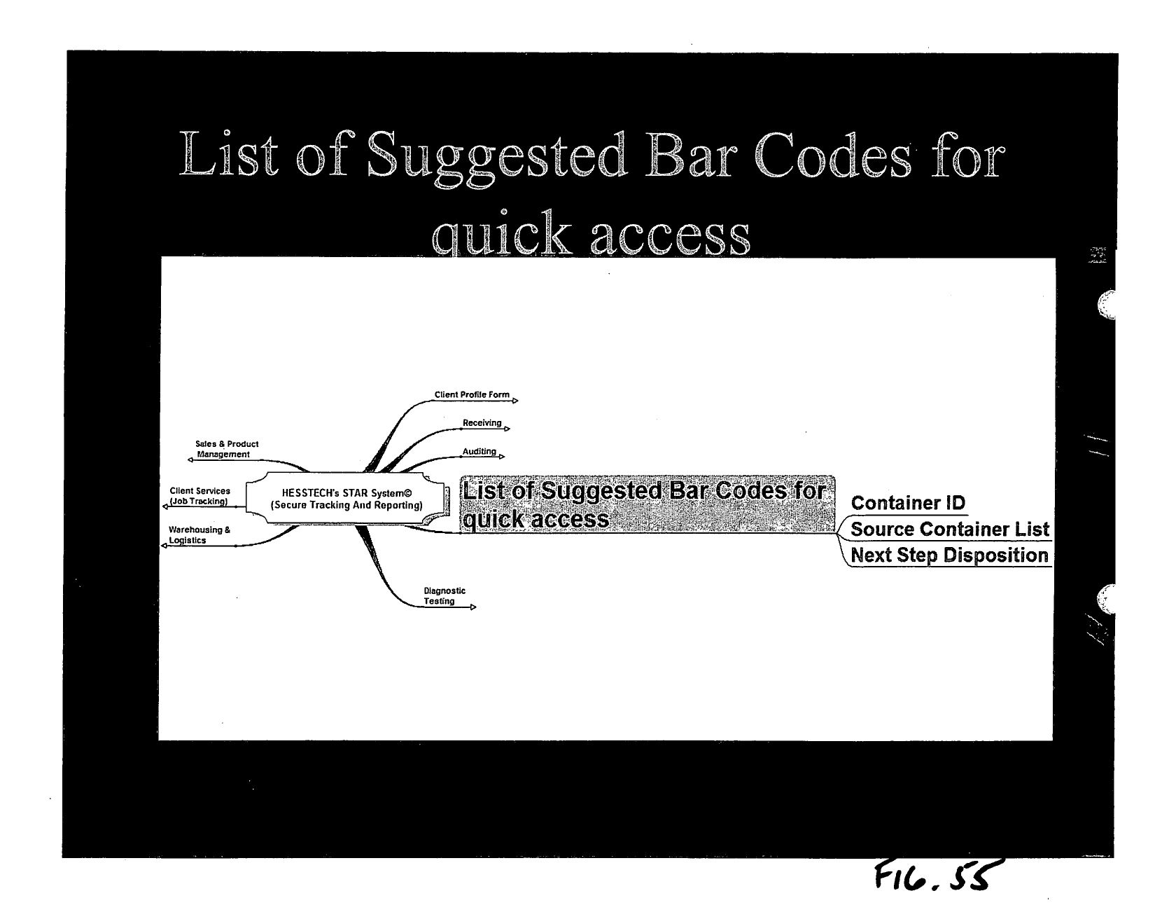

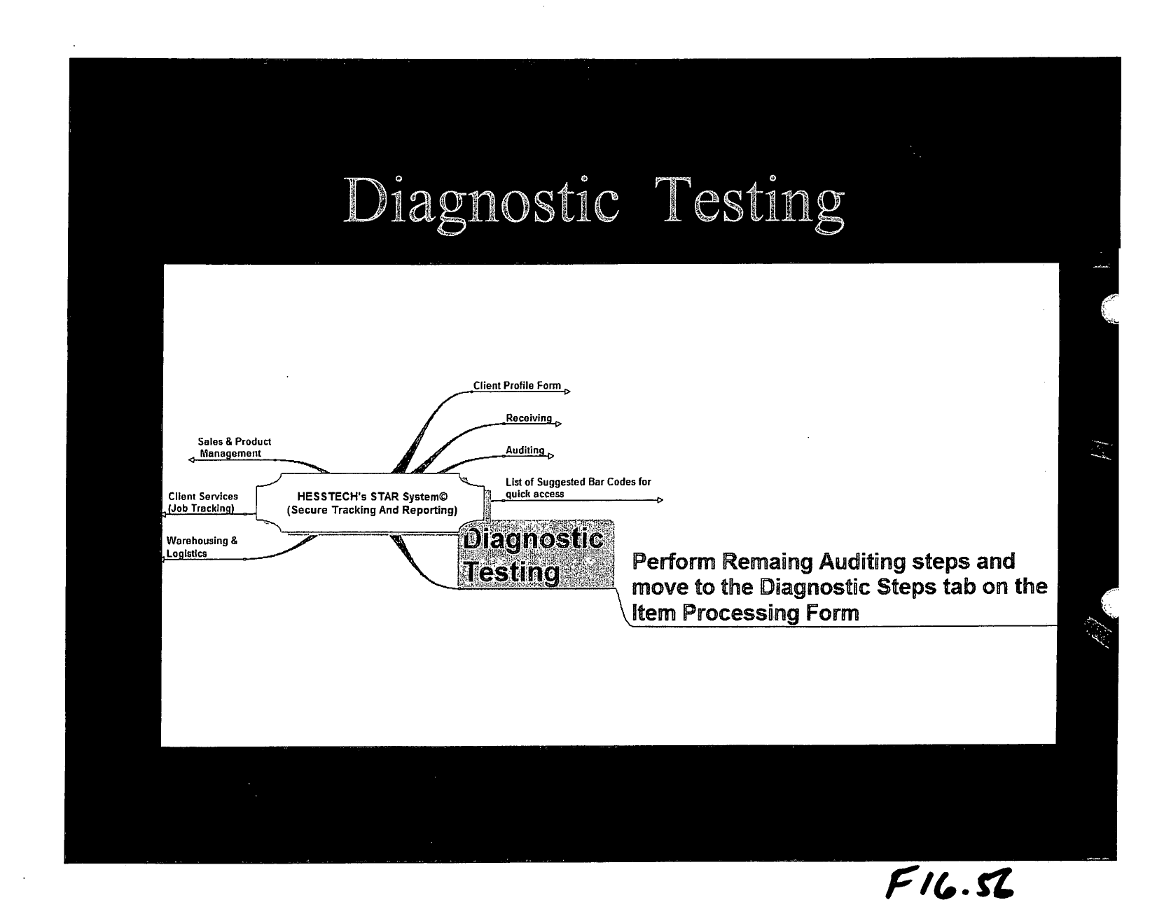

FIGS. 55 and 56 illustrate the organizational hierarchy used in an exemplary embodiment of the present invention. The figures illustrate the use of suggested bar codes for quick inventory access, and the use of diagnostic testing.

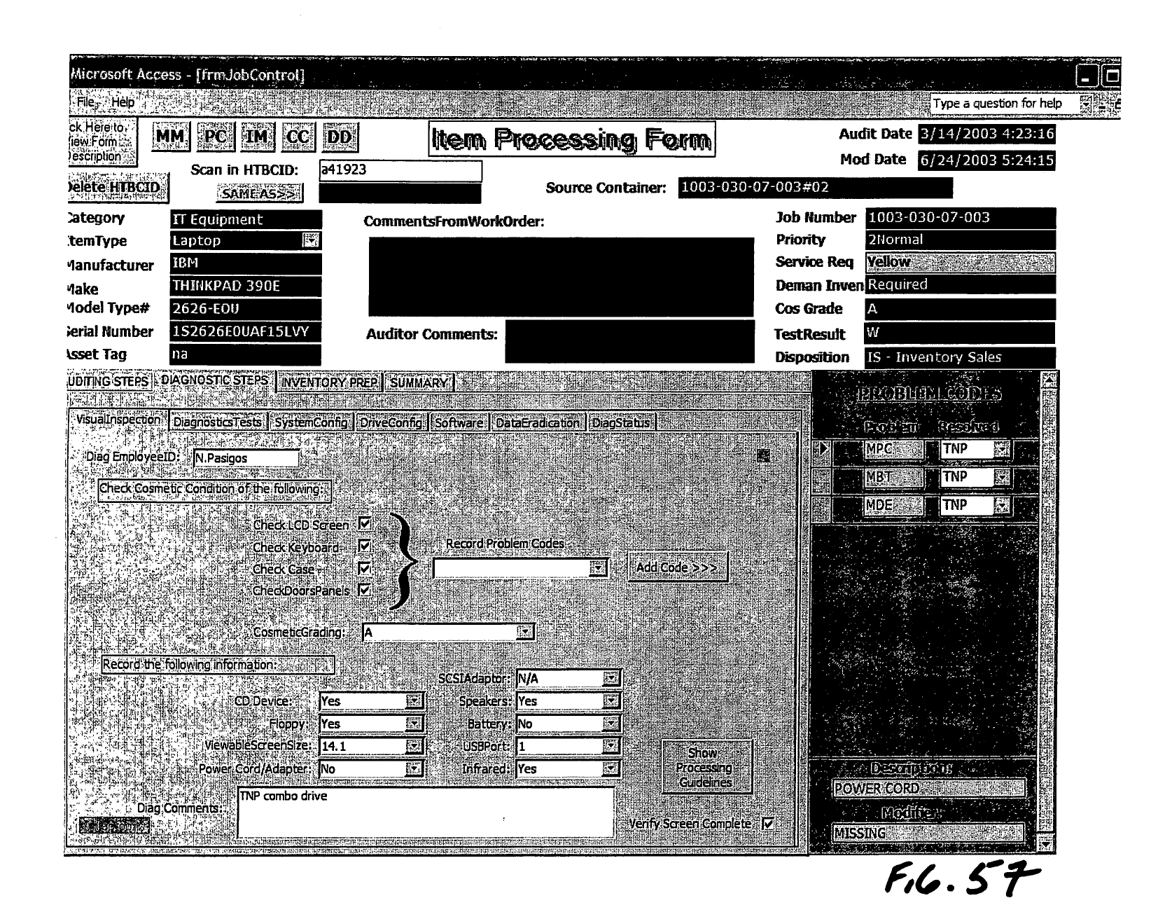

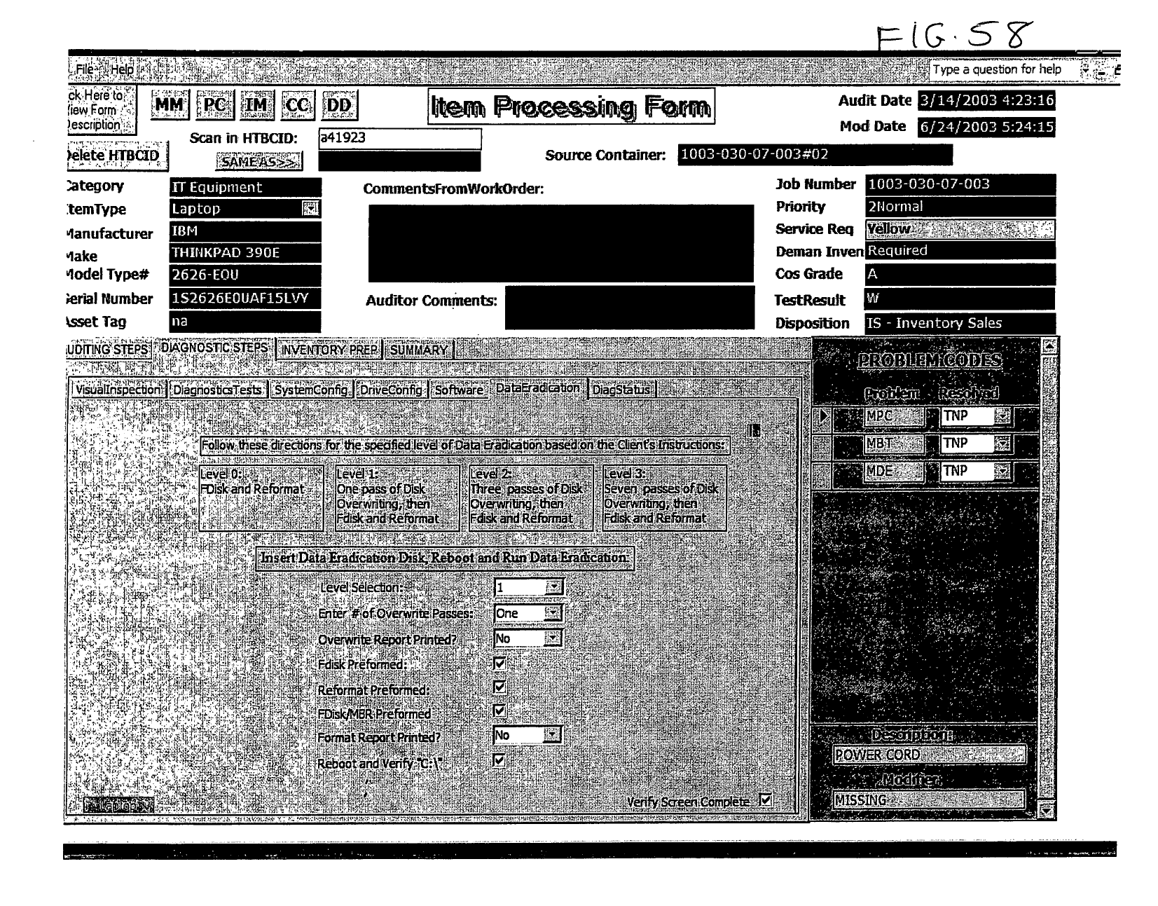

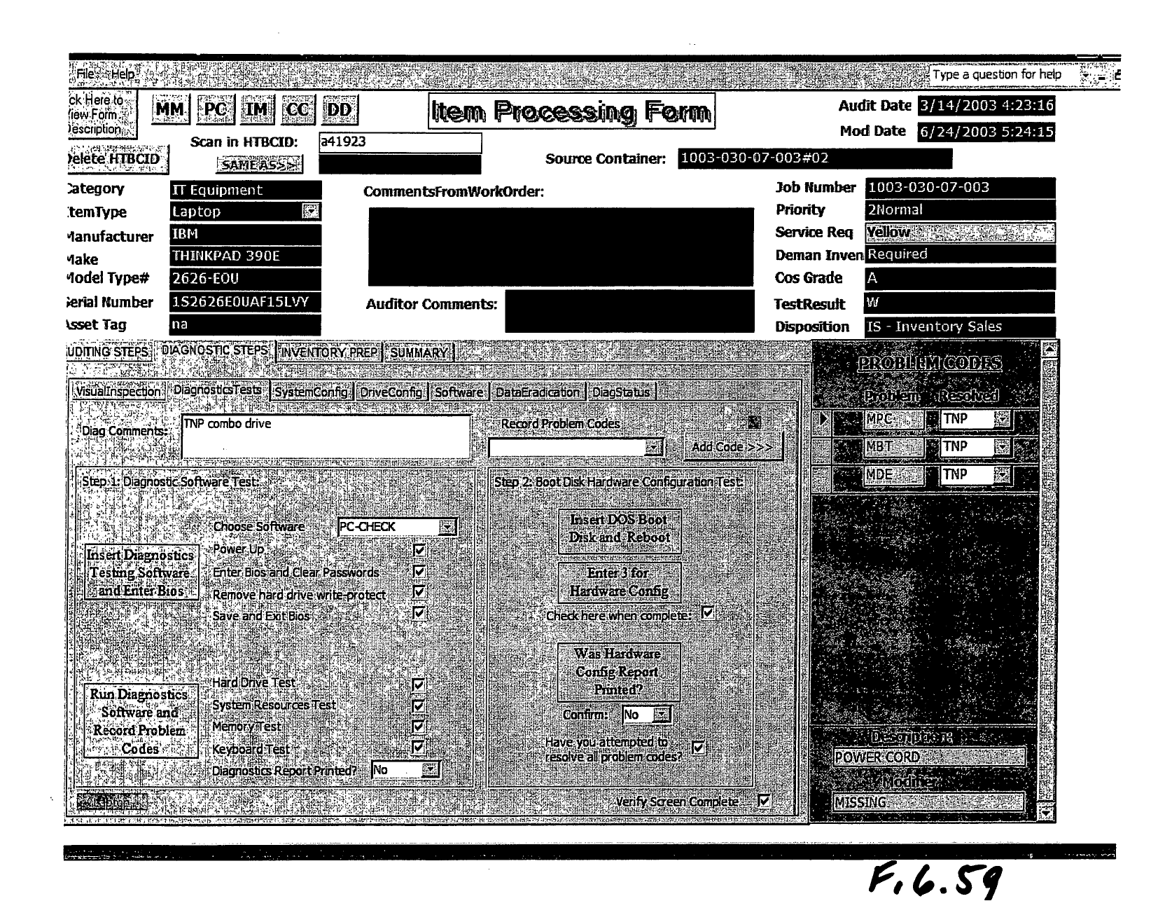

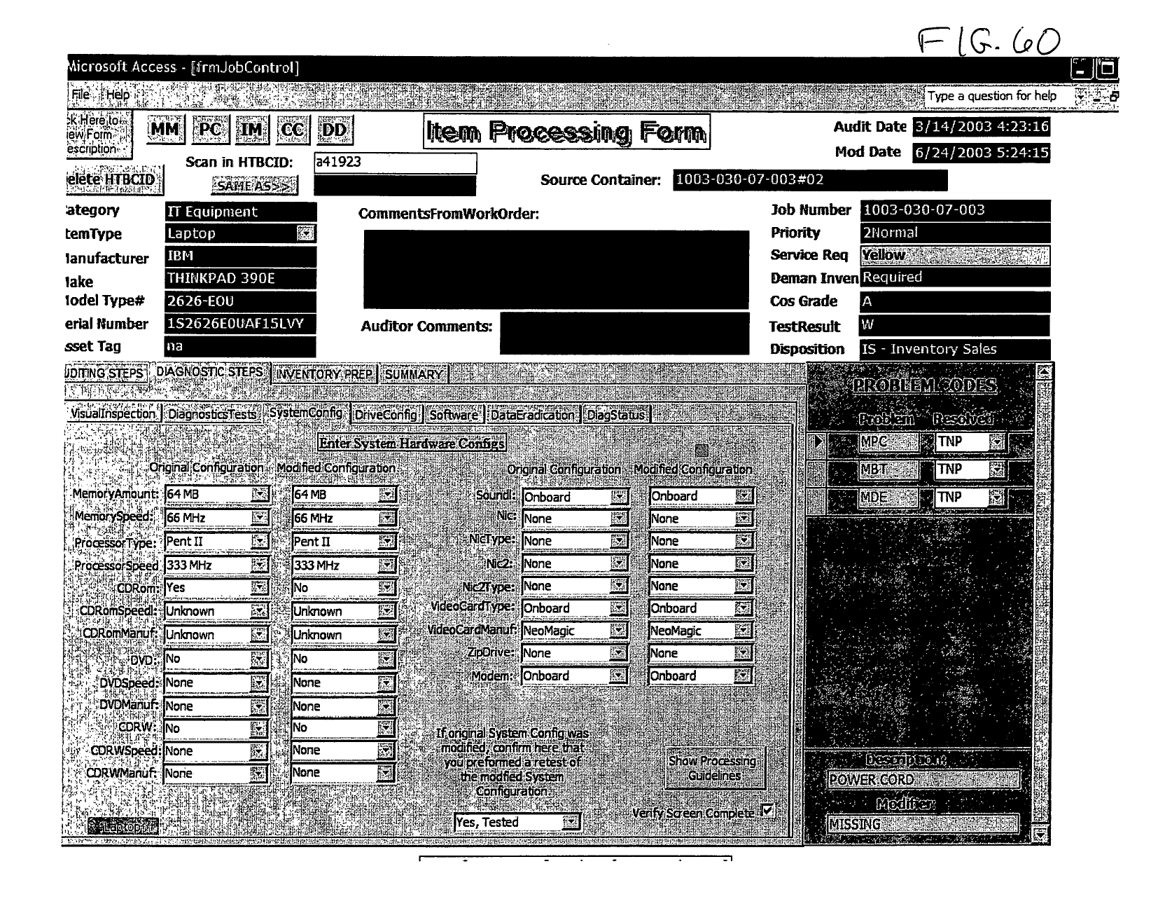

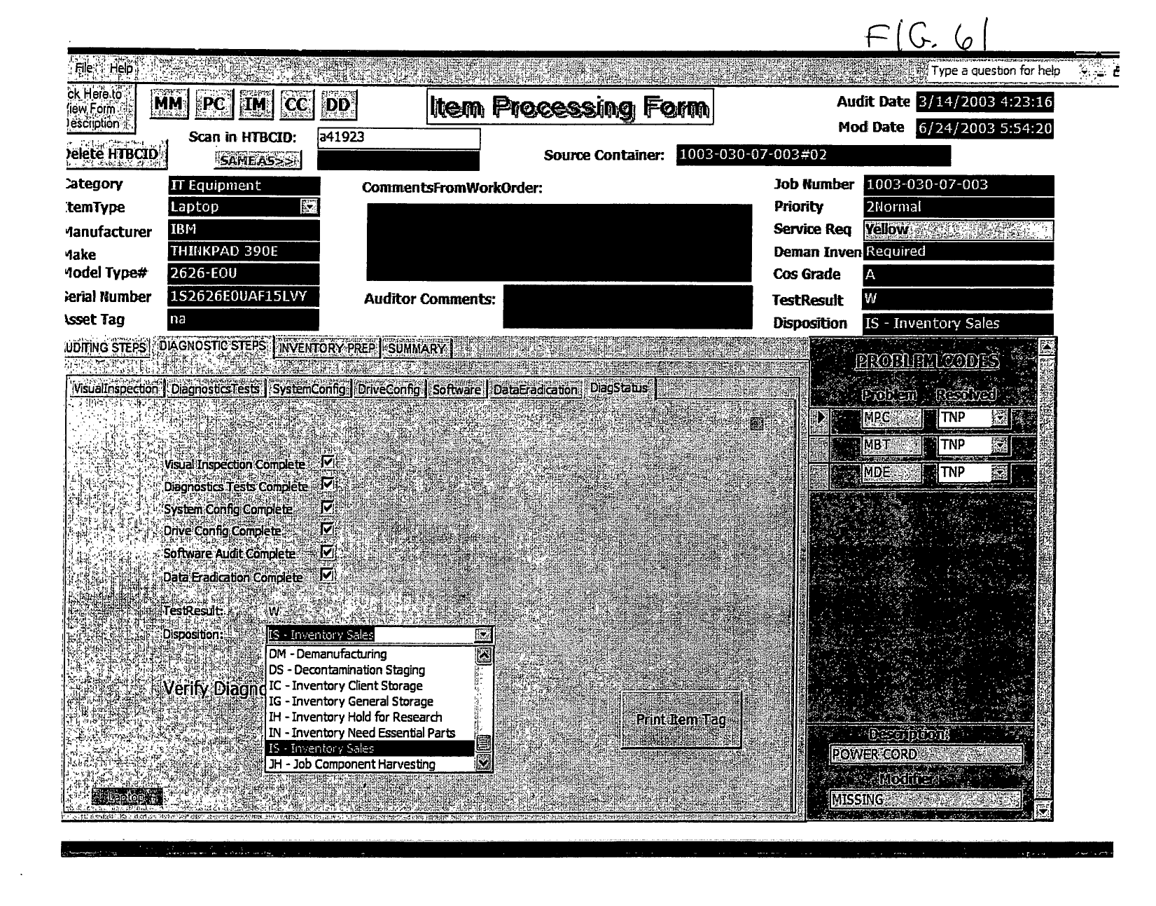

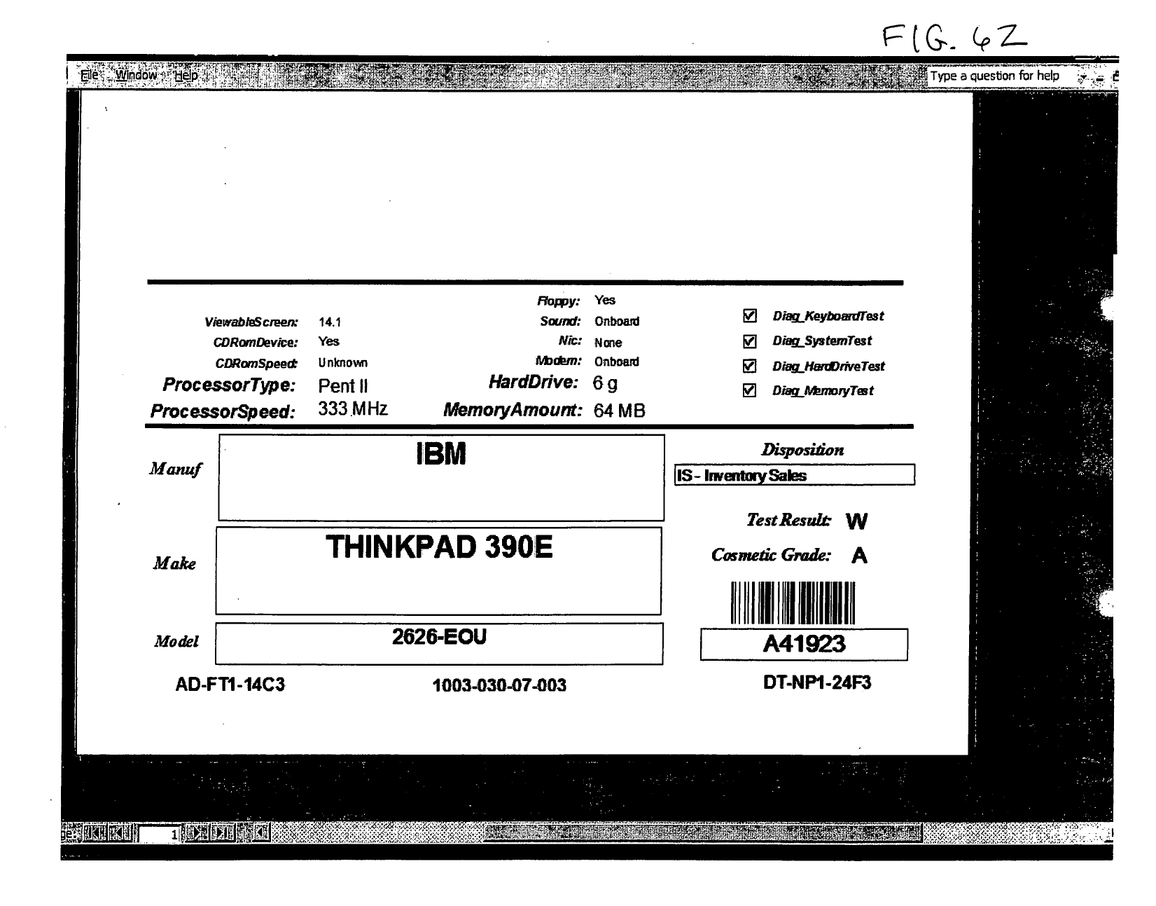

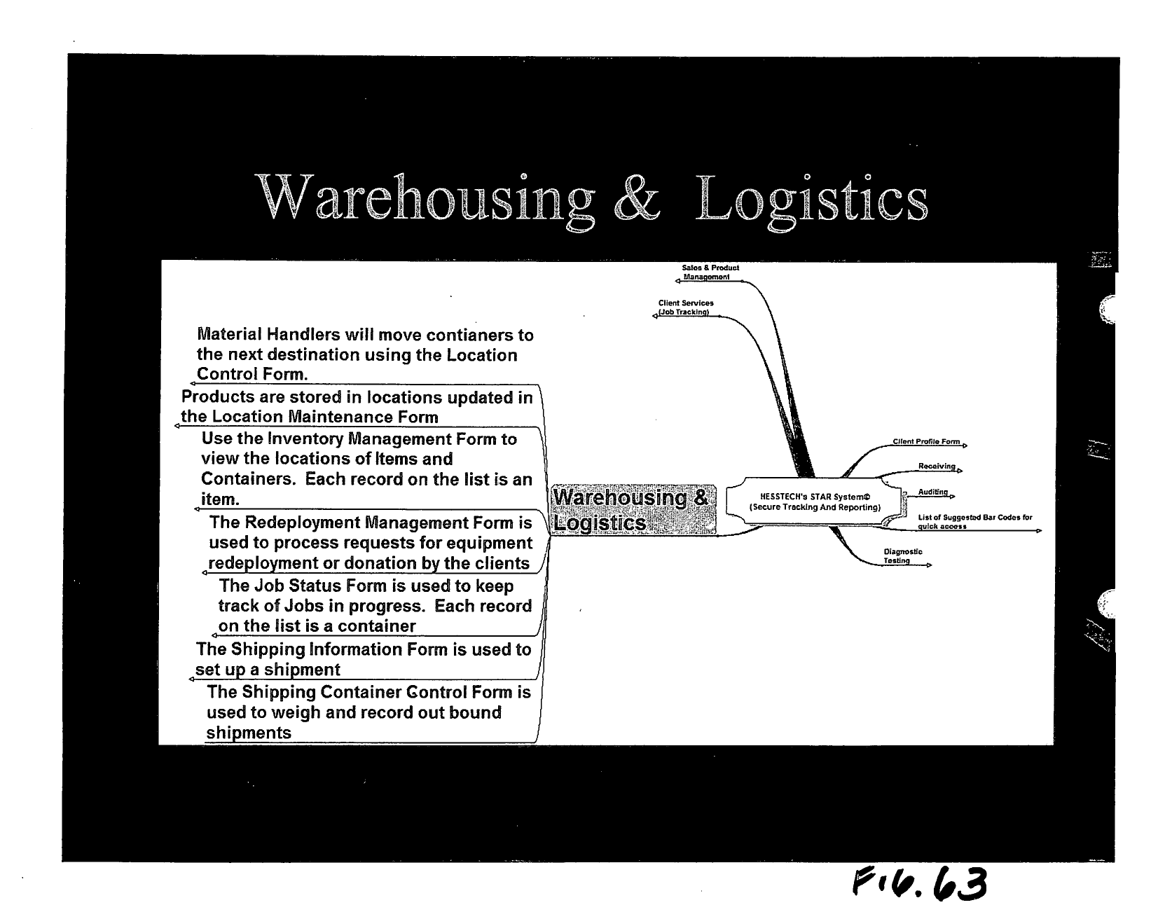

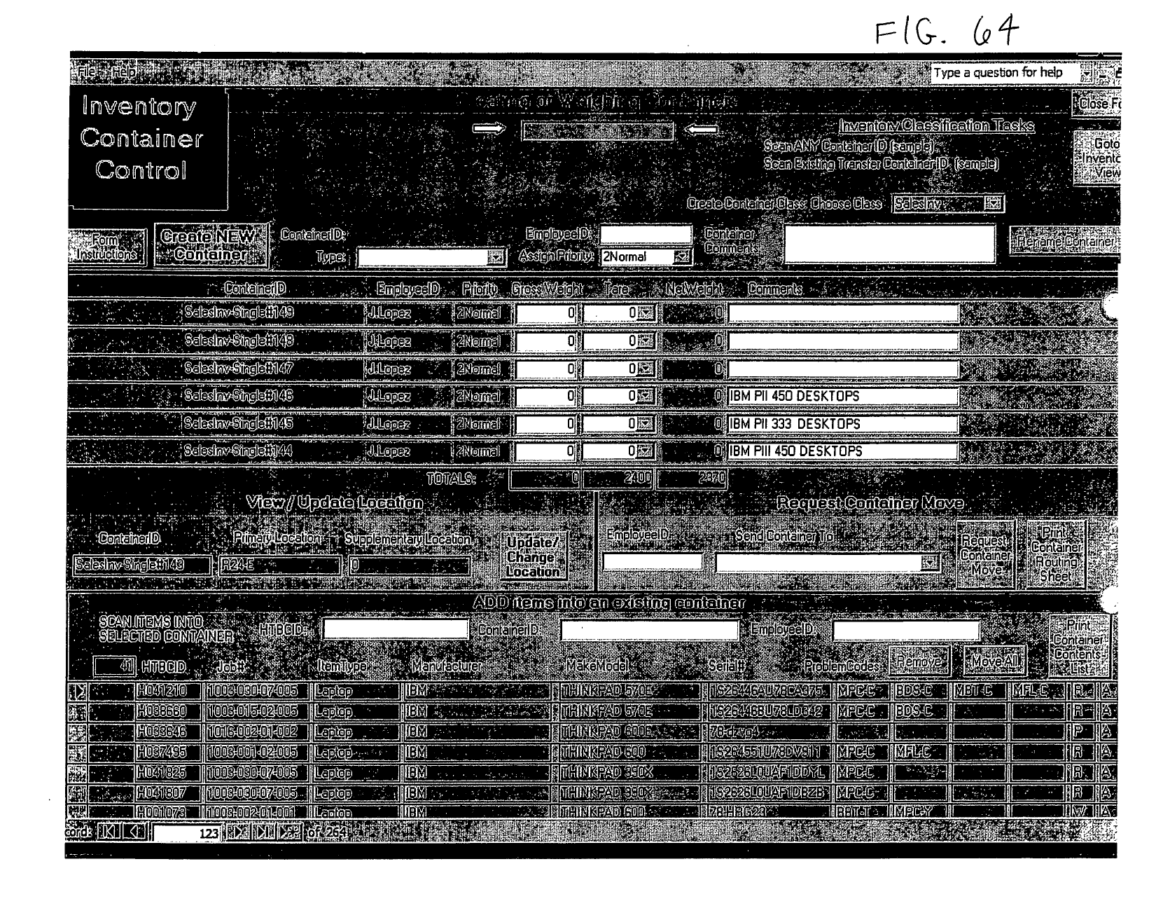

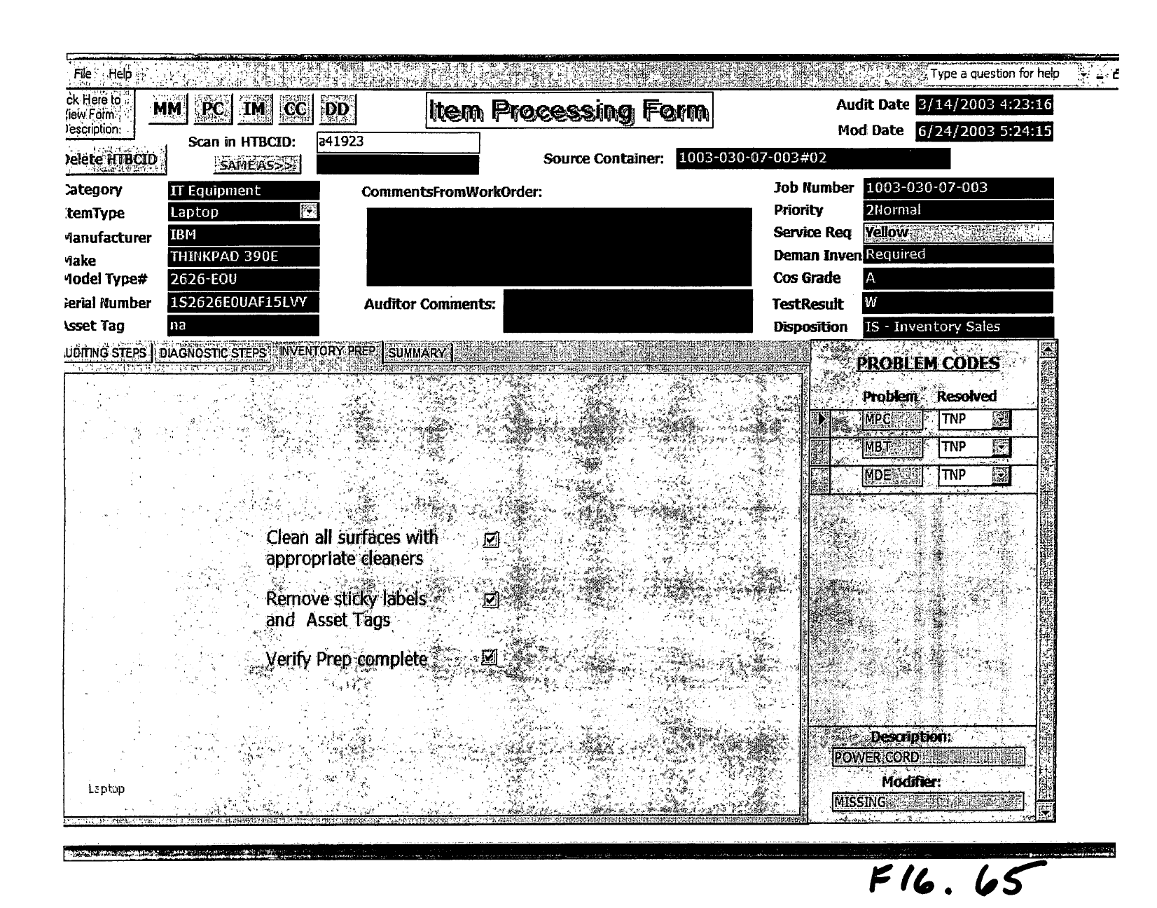

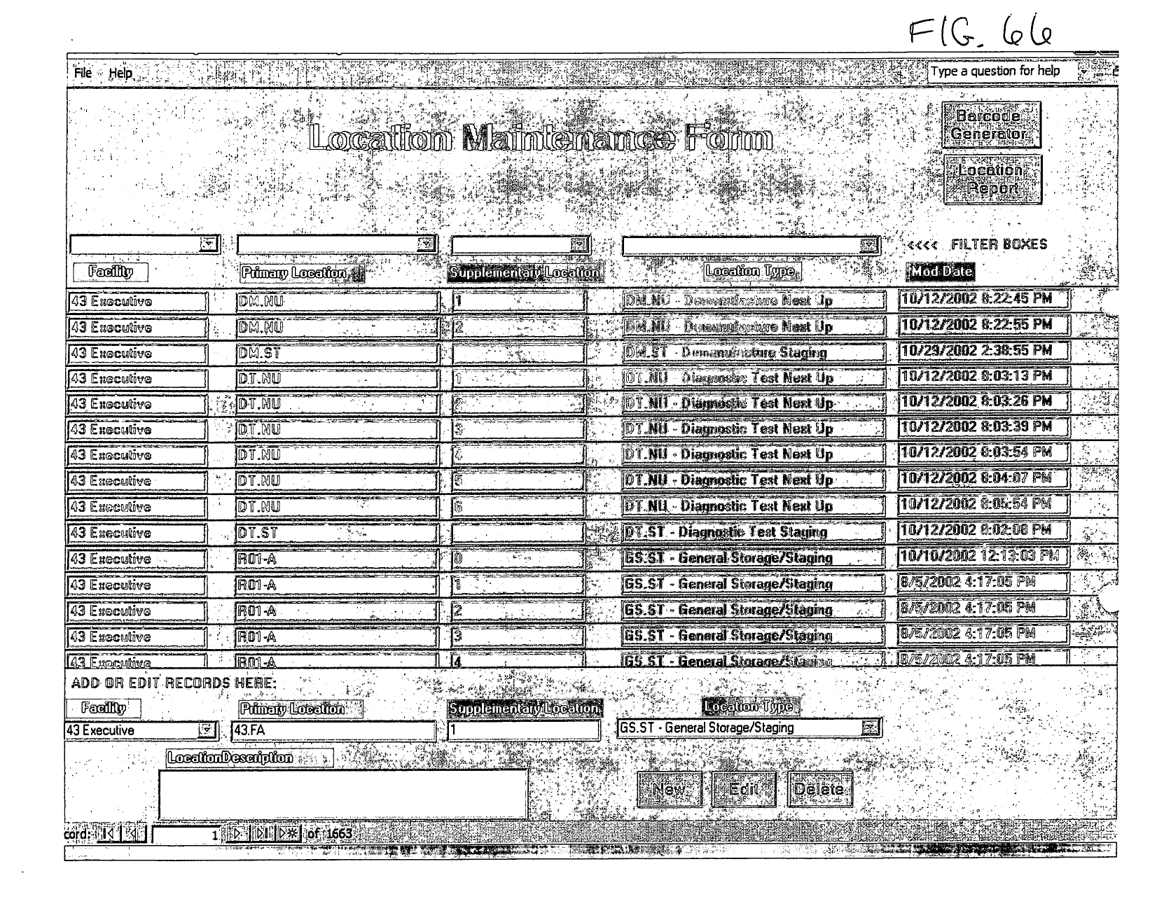

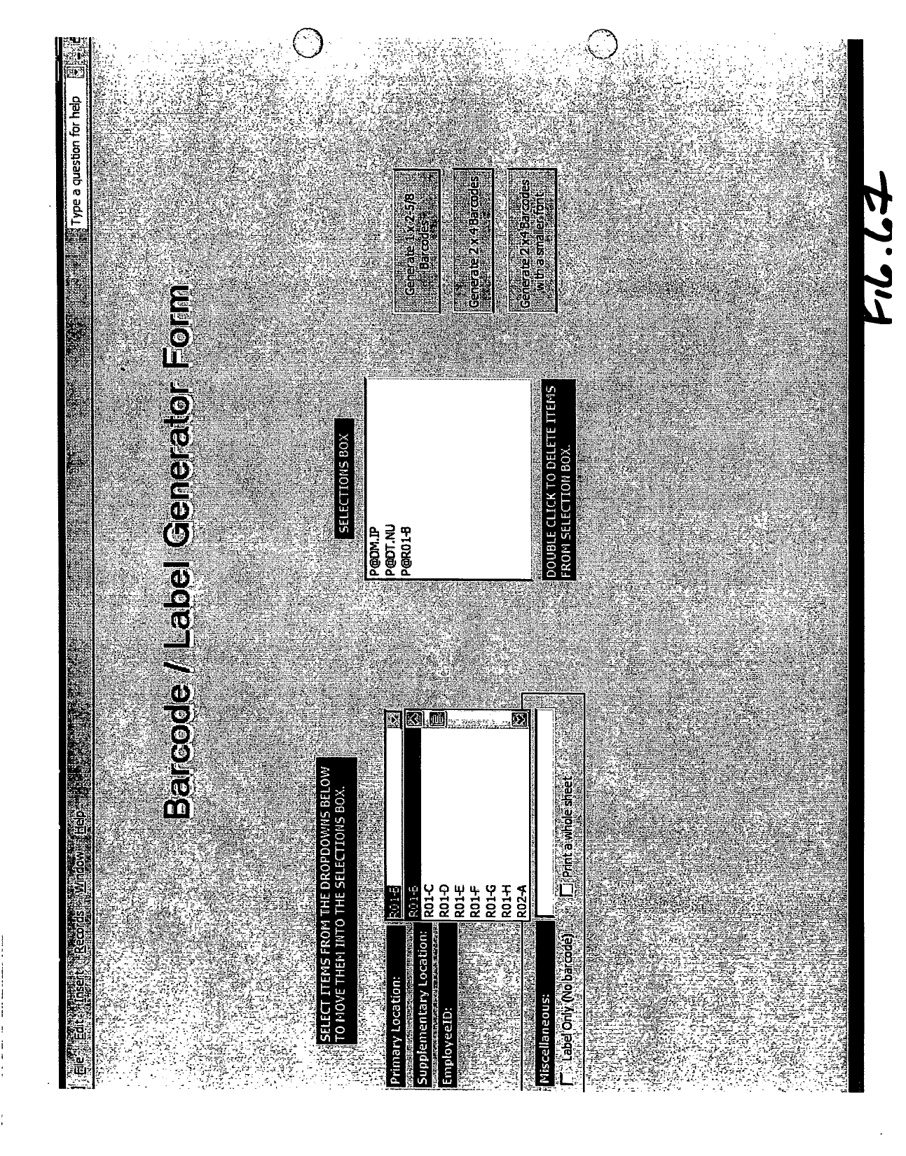

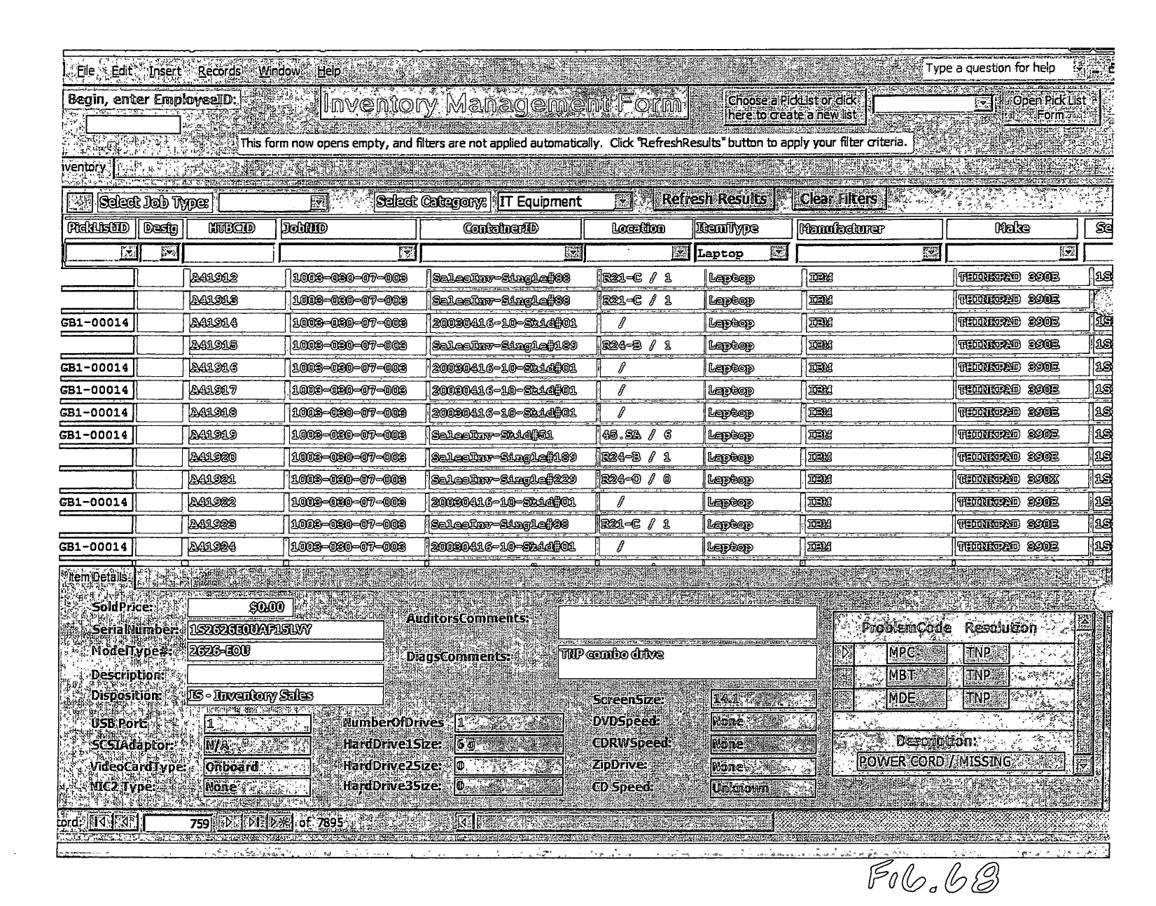

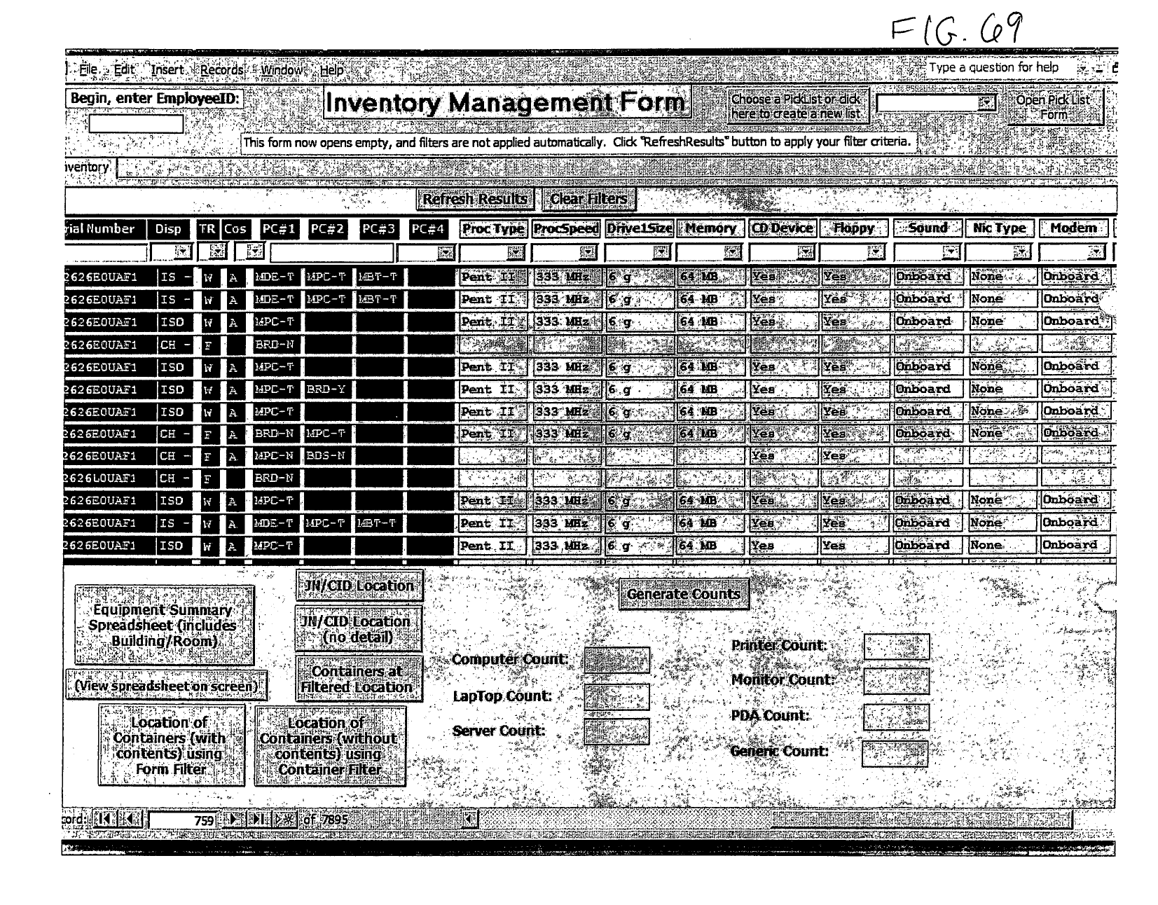

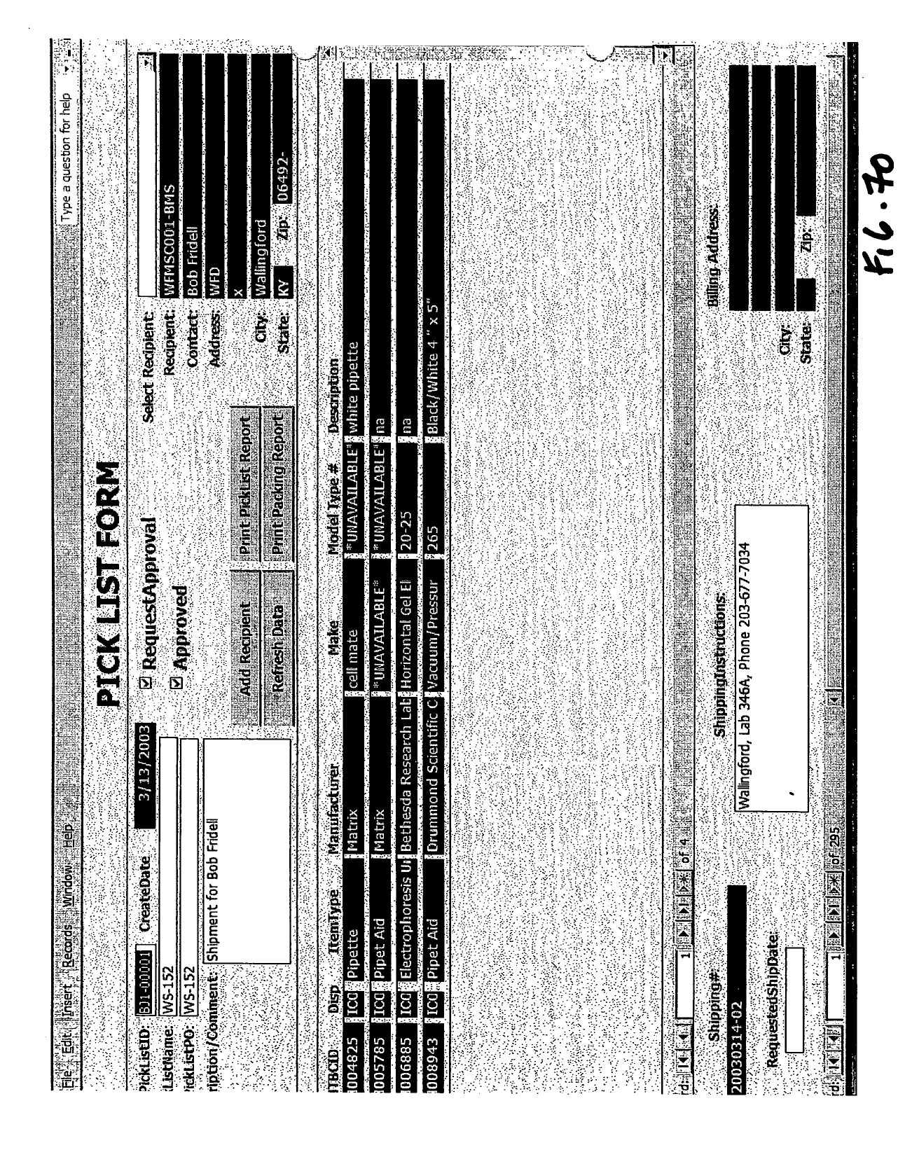

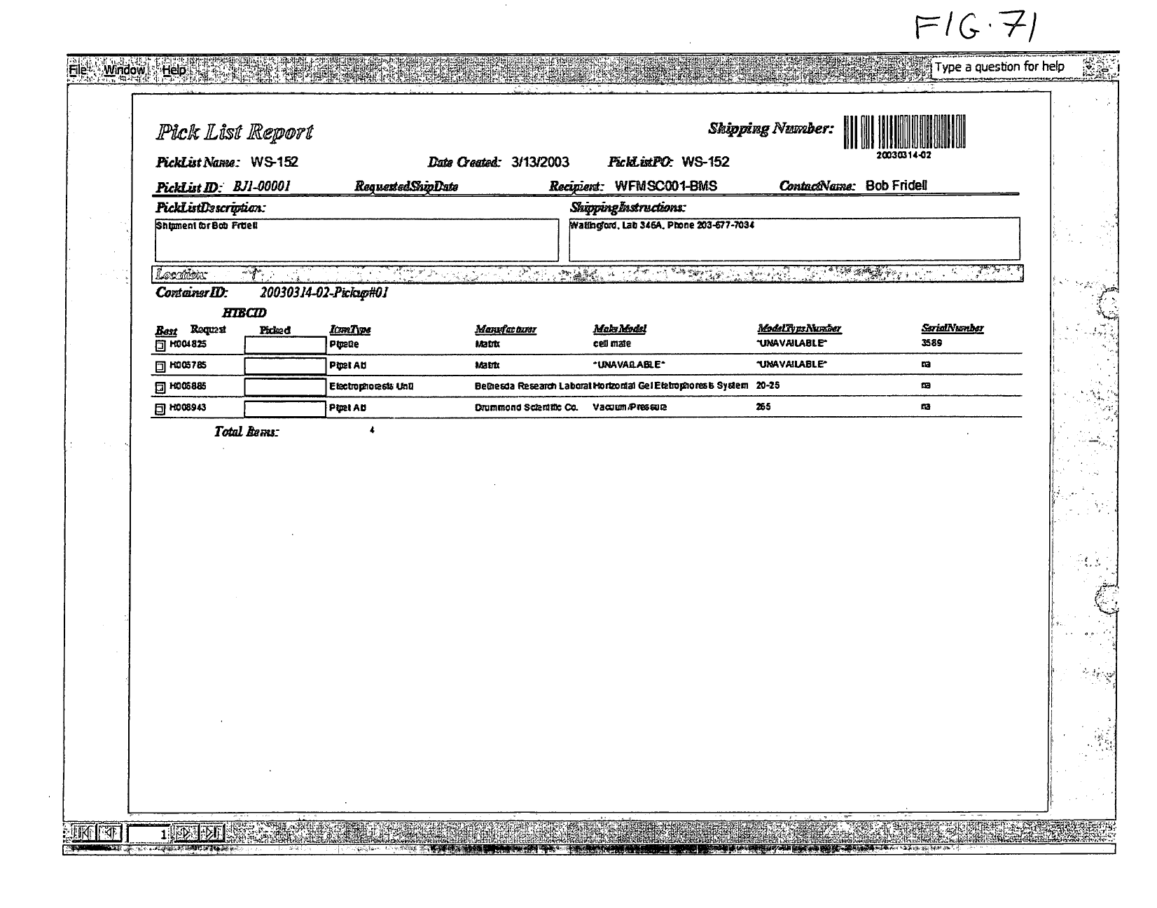

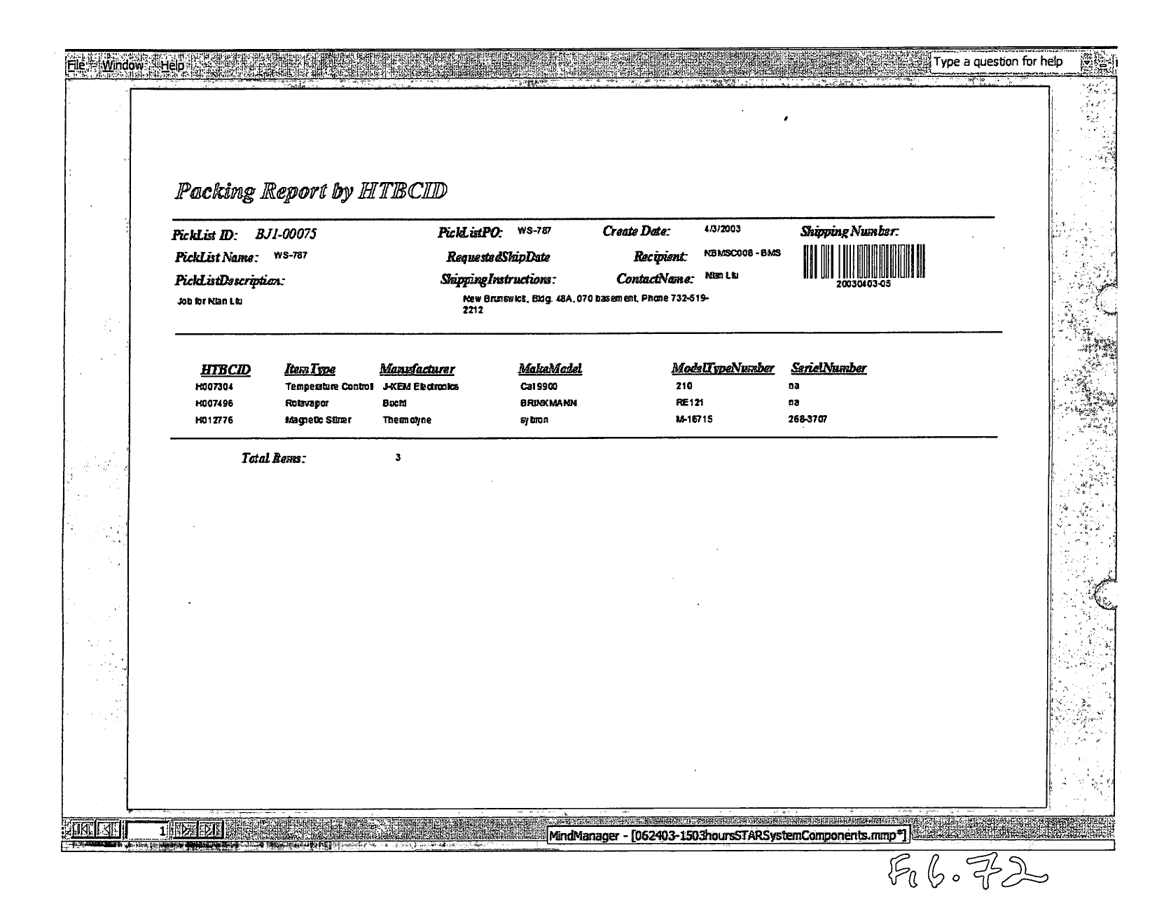

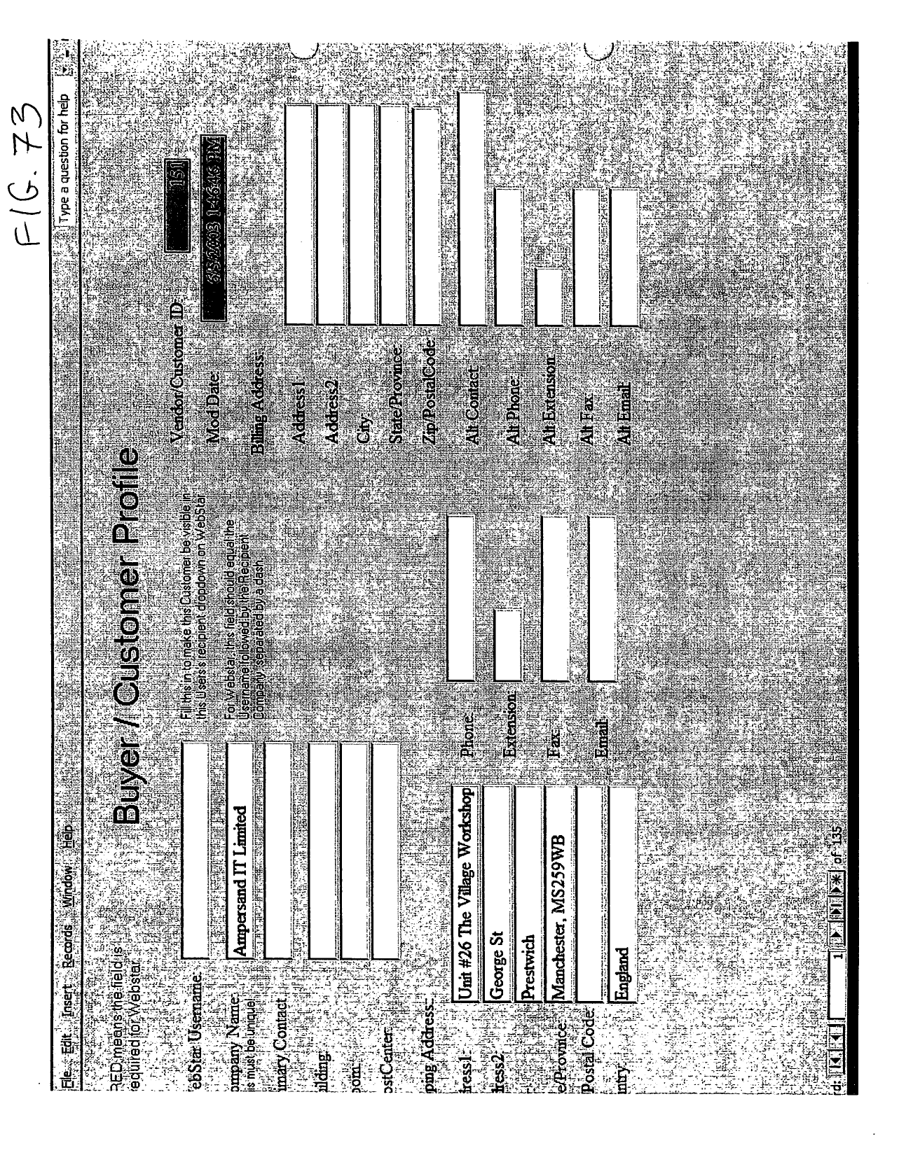

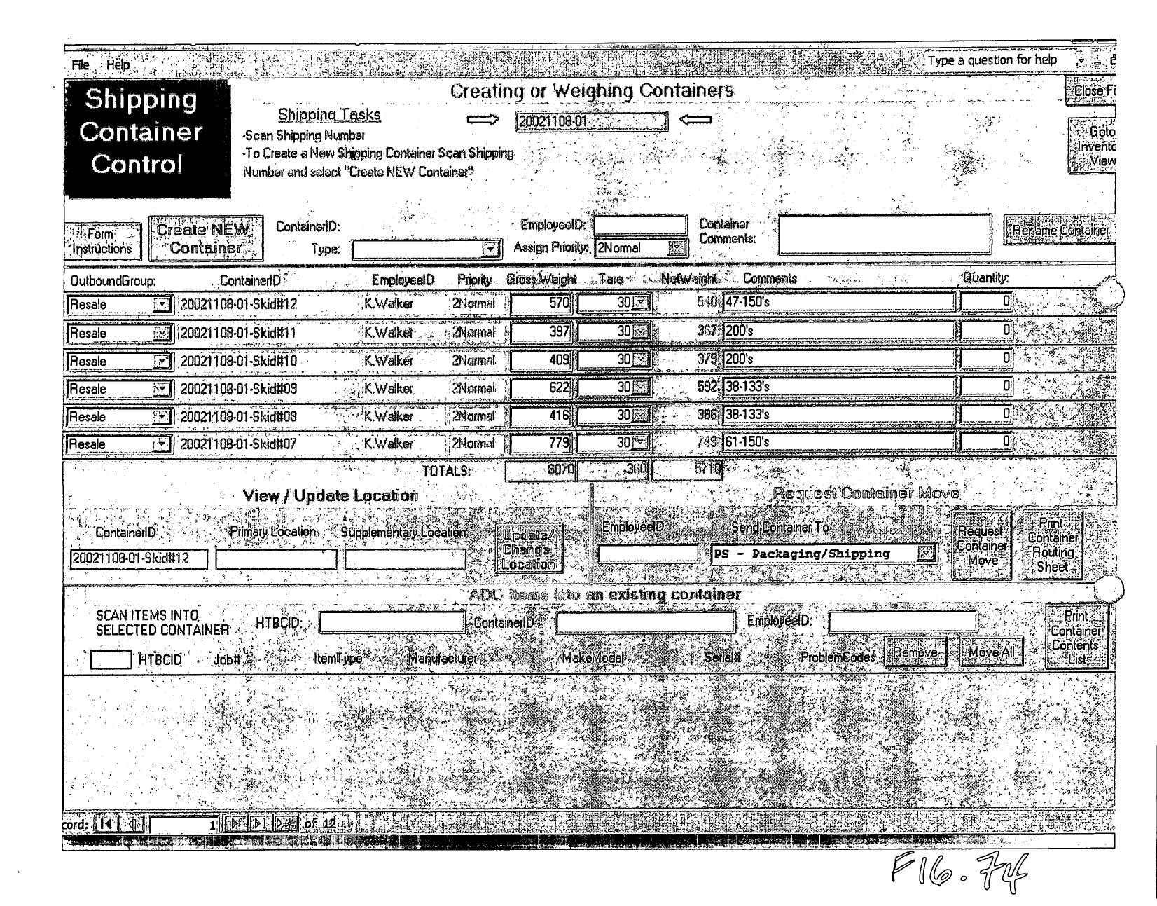

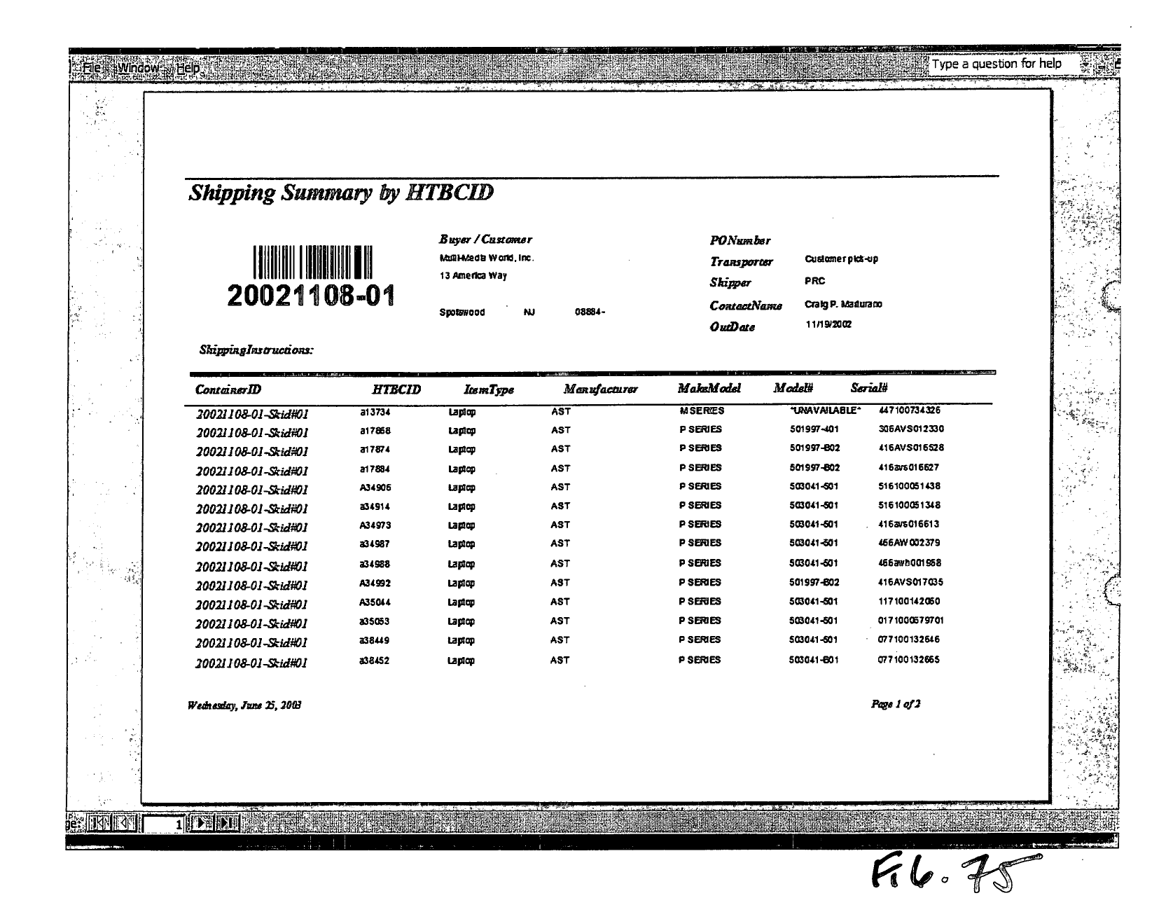

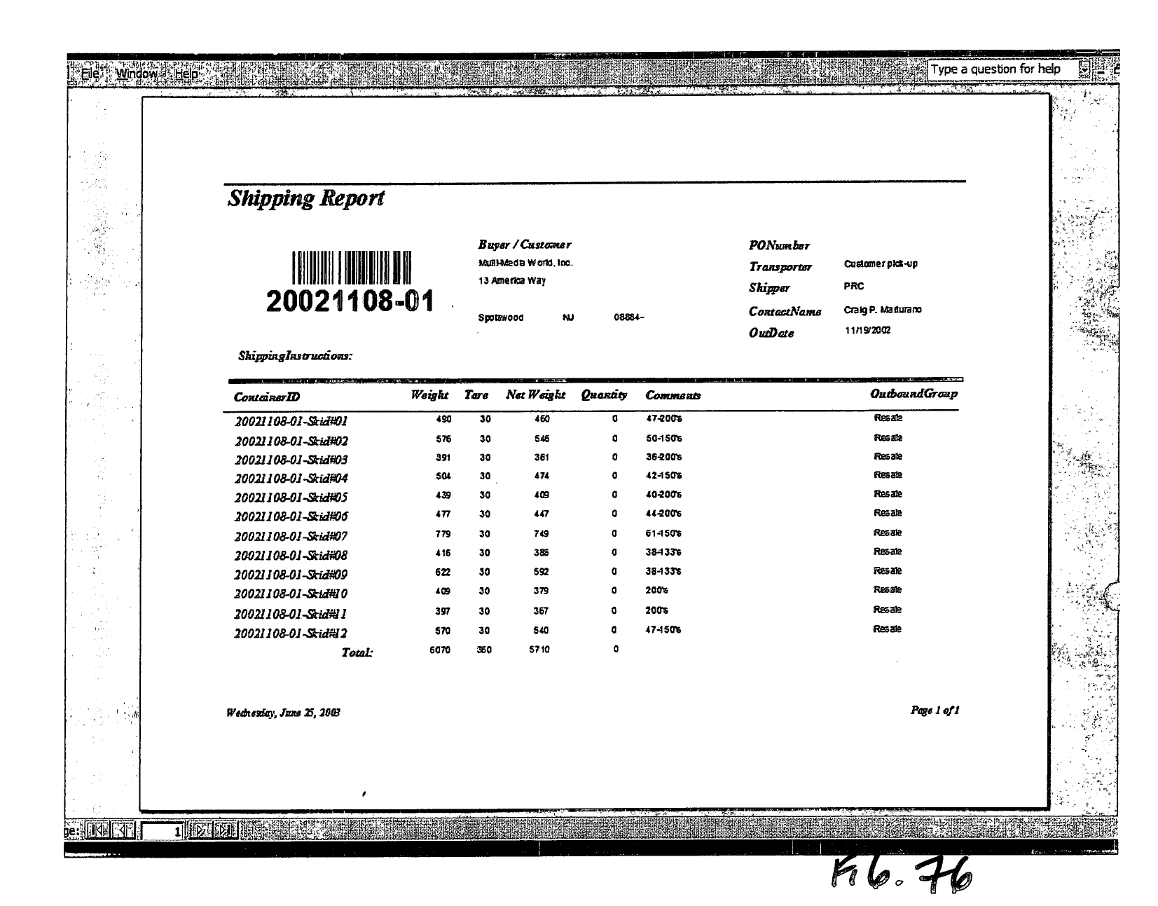

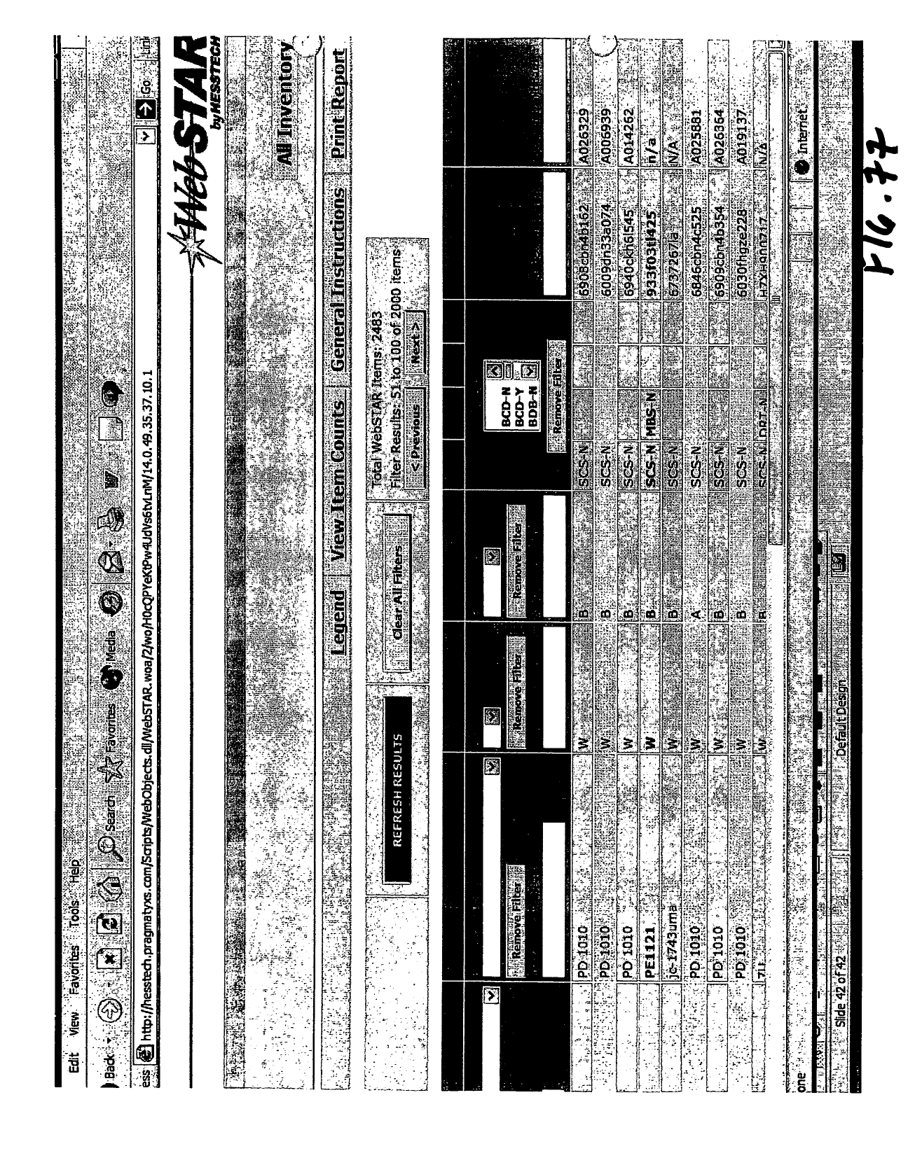

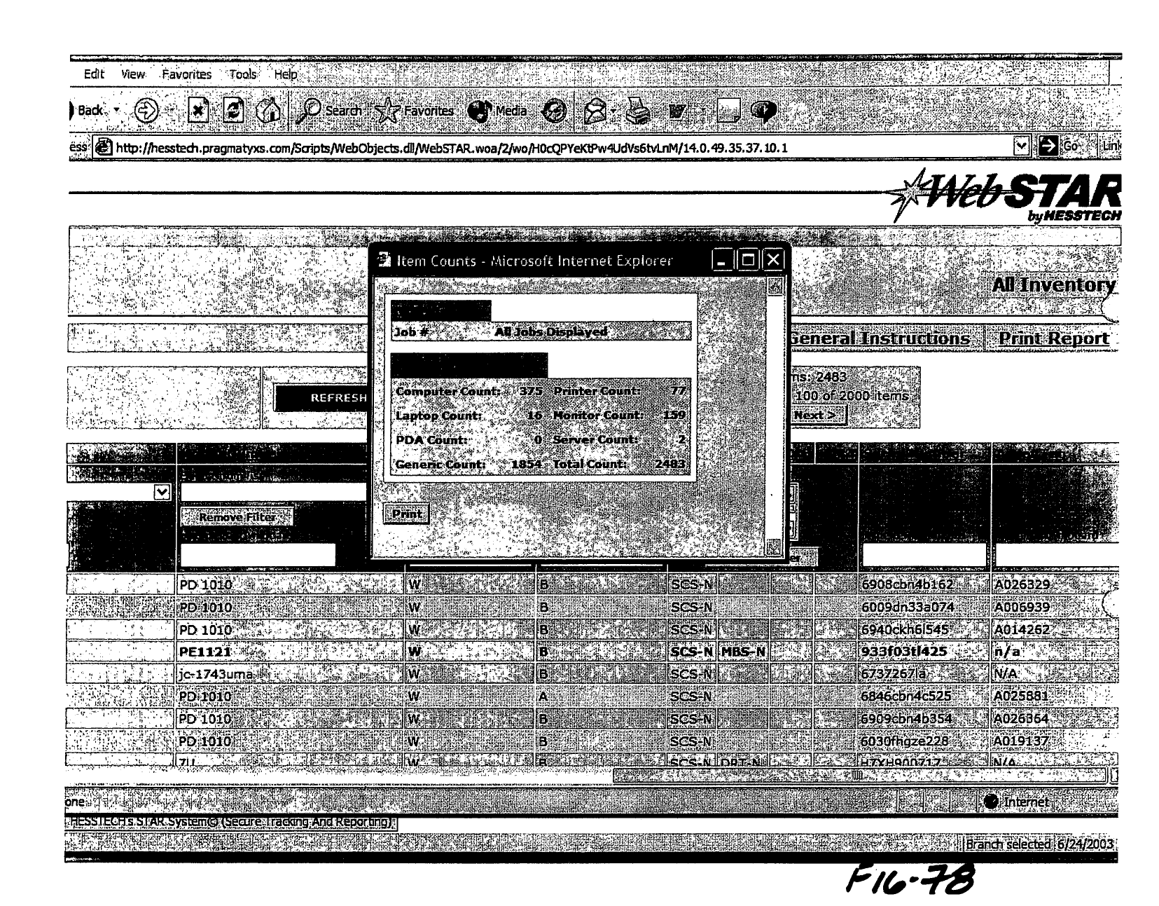

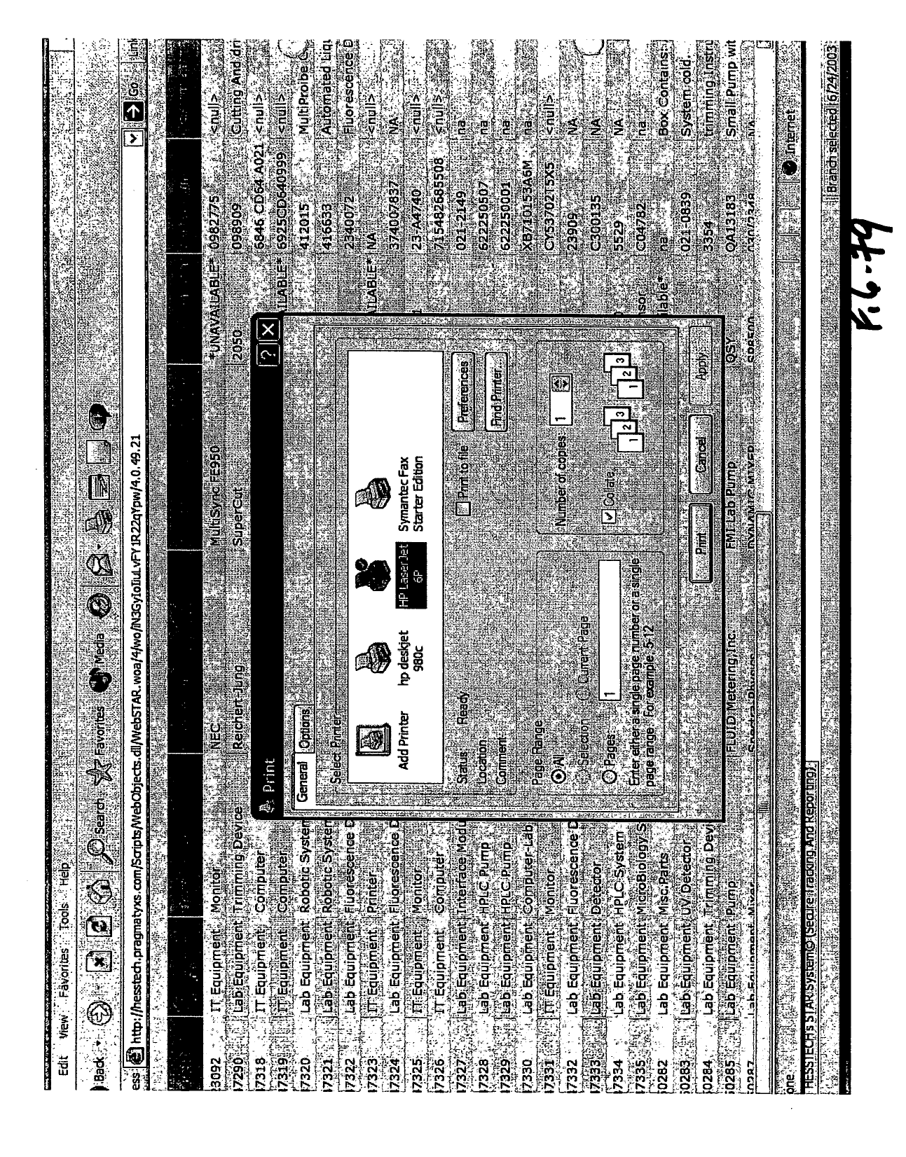

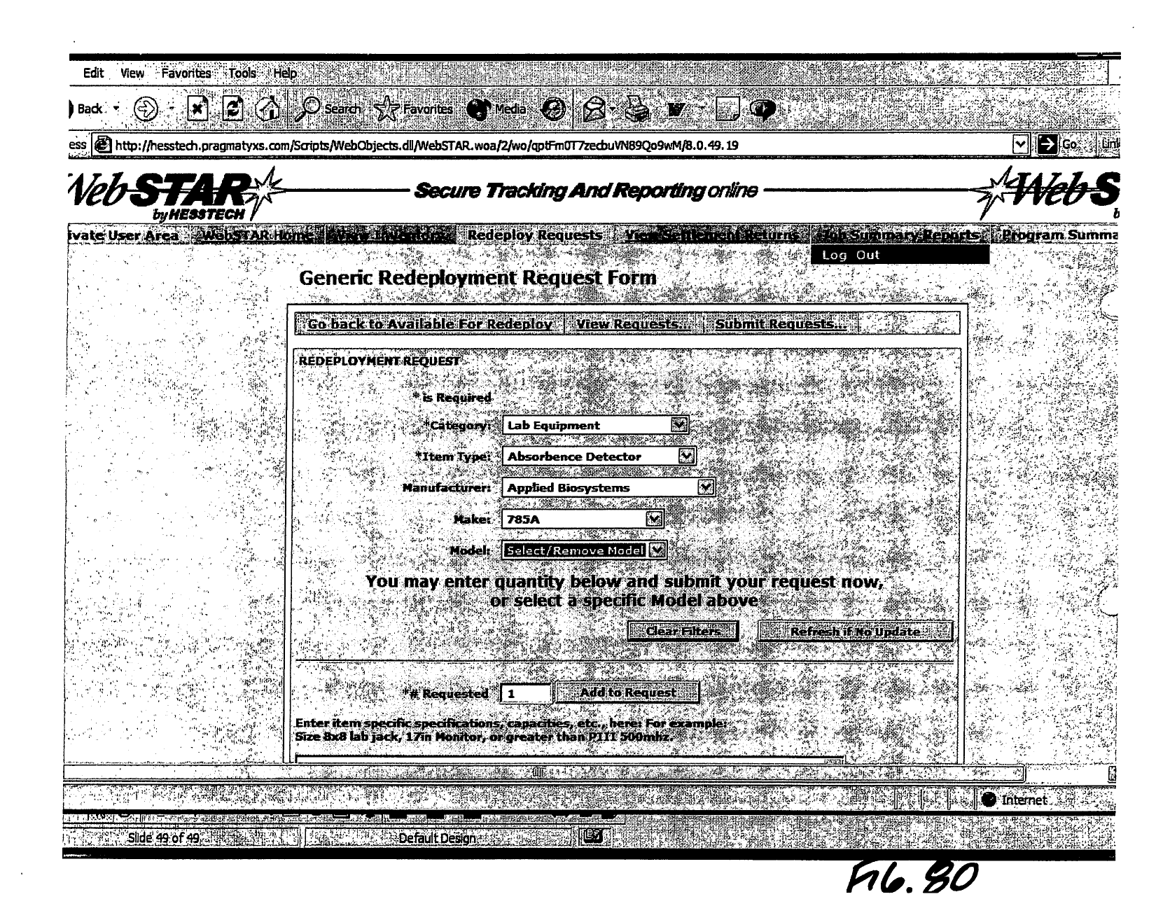

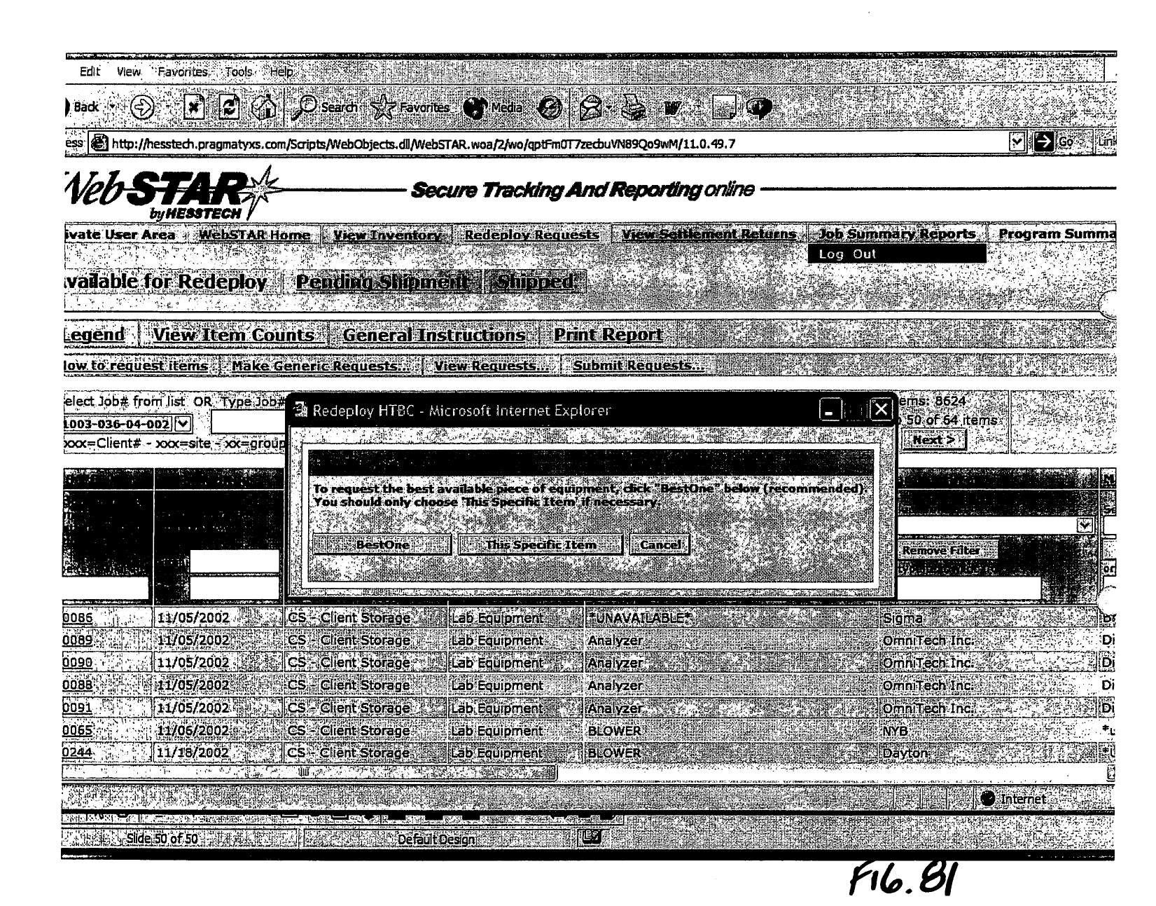

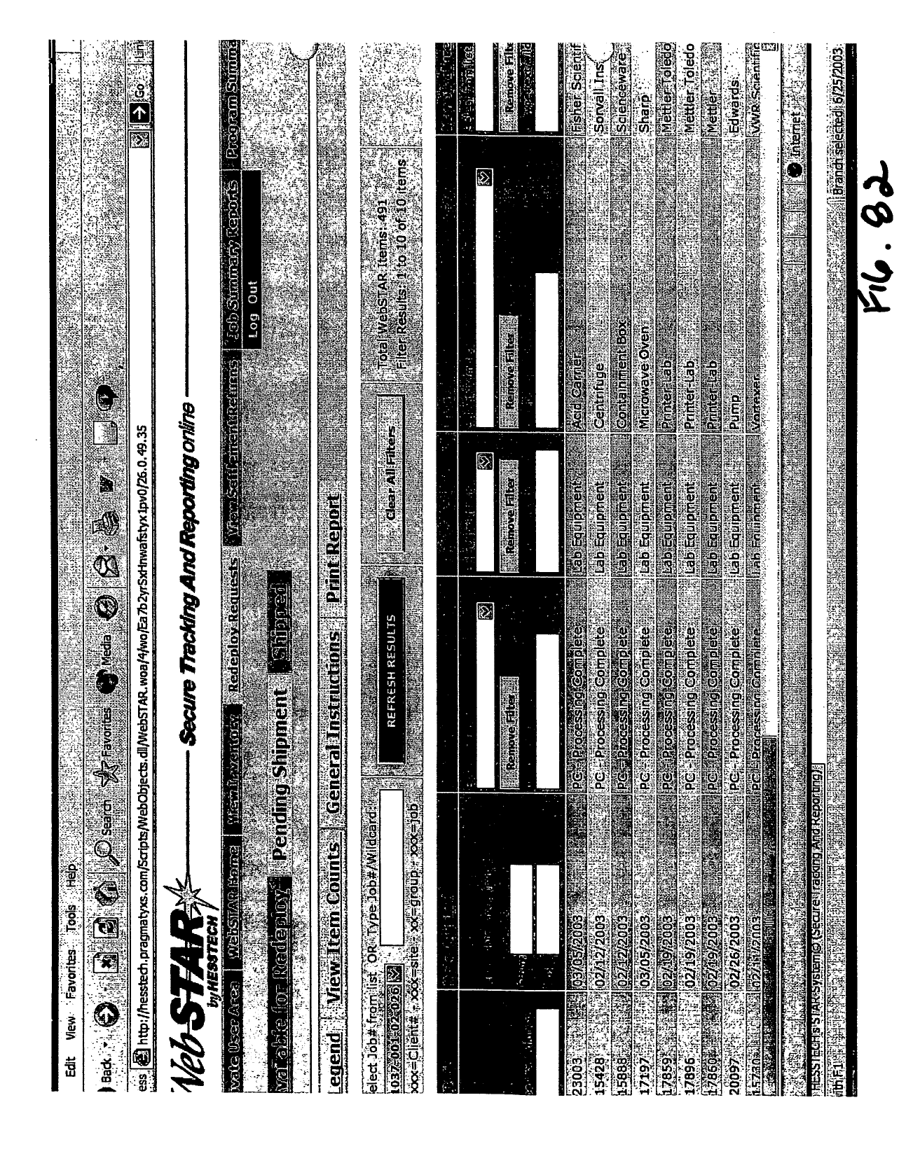

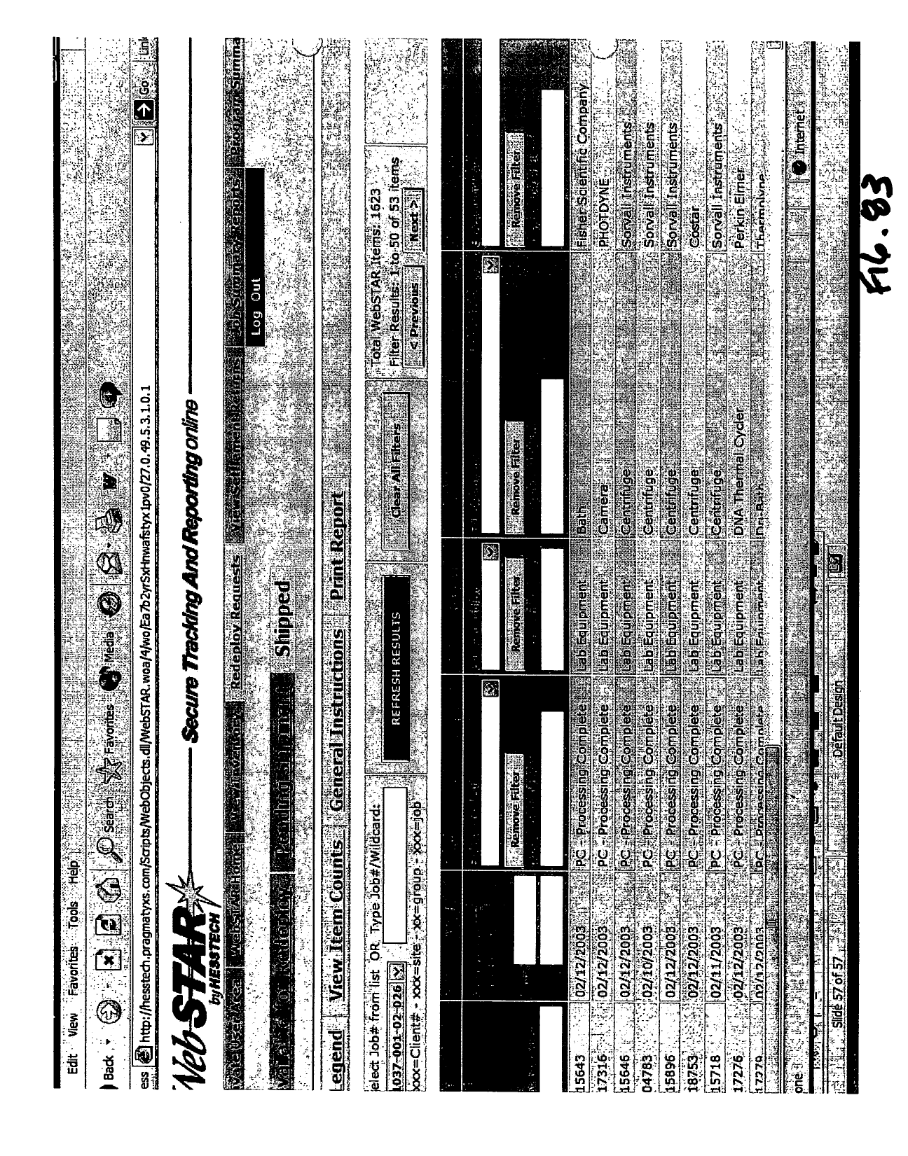

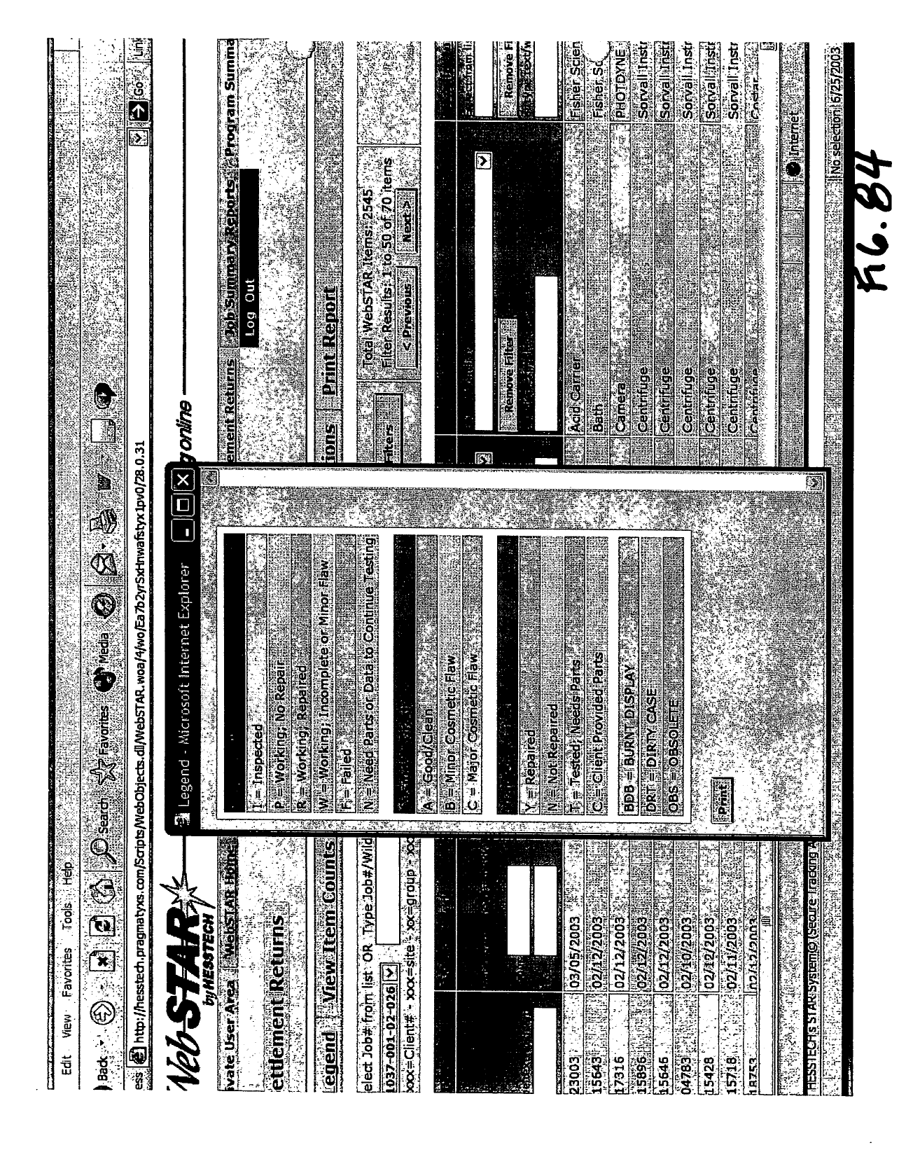

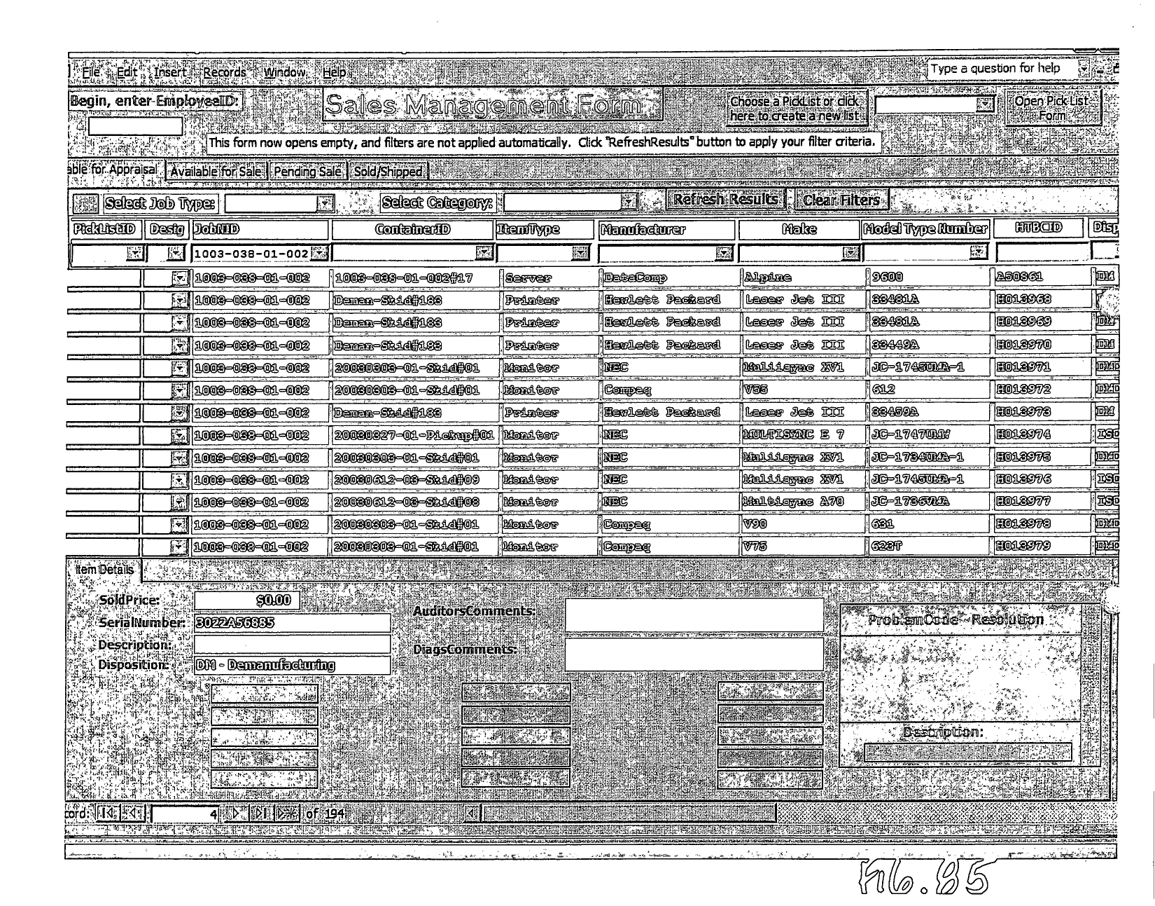

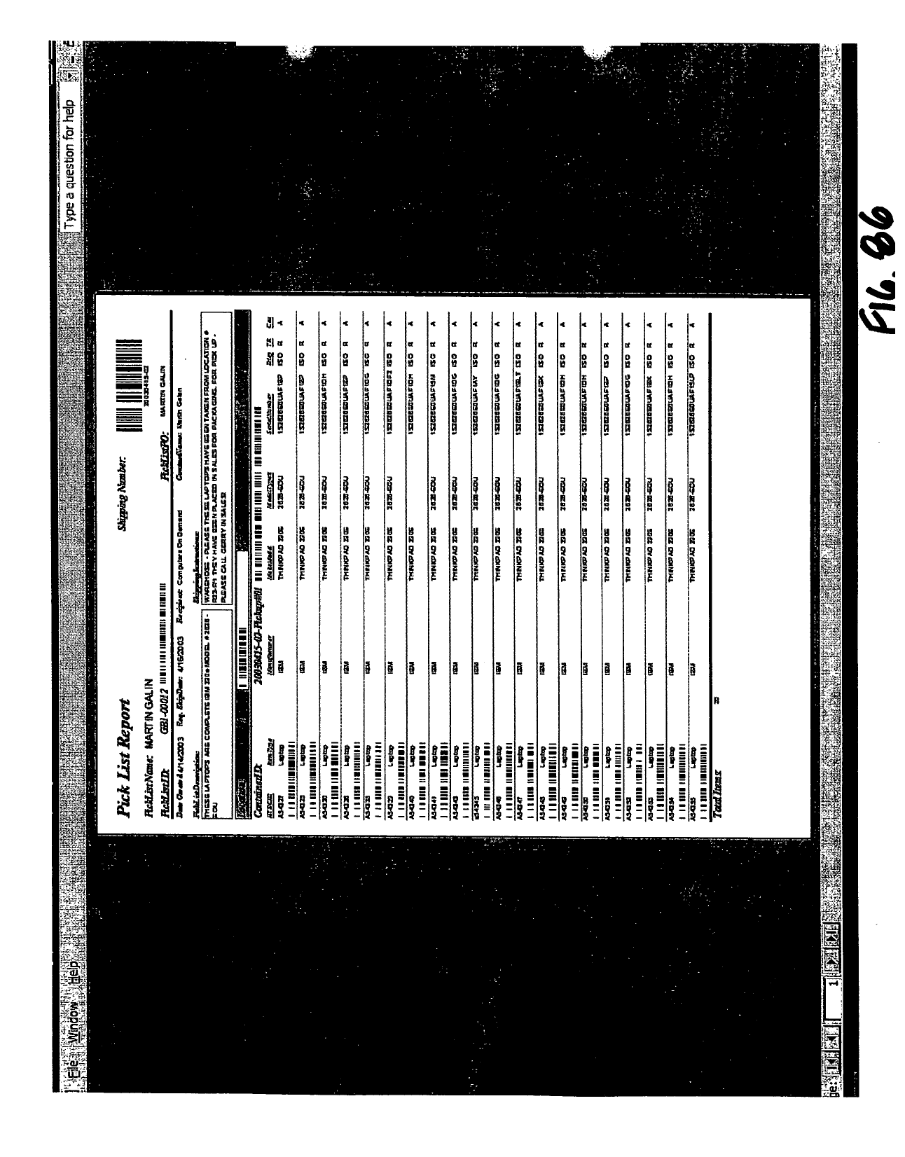

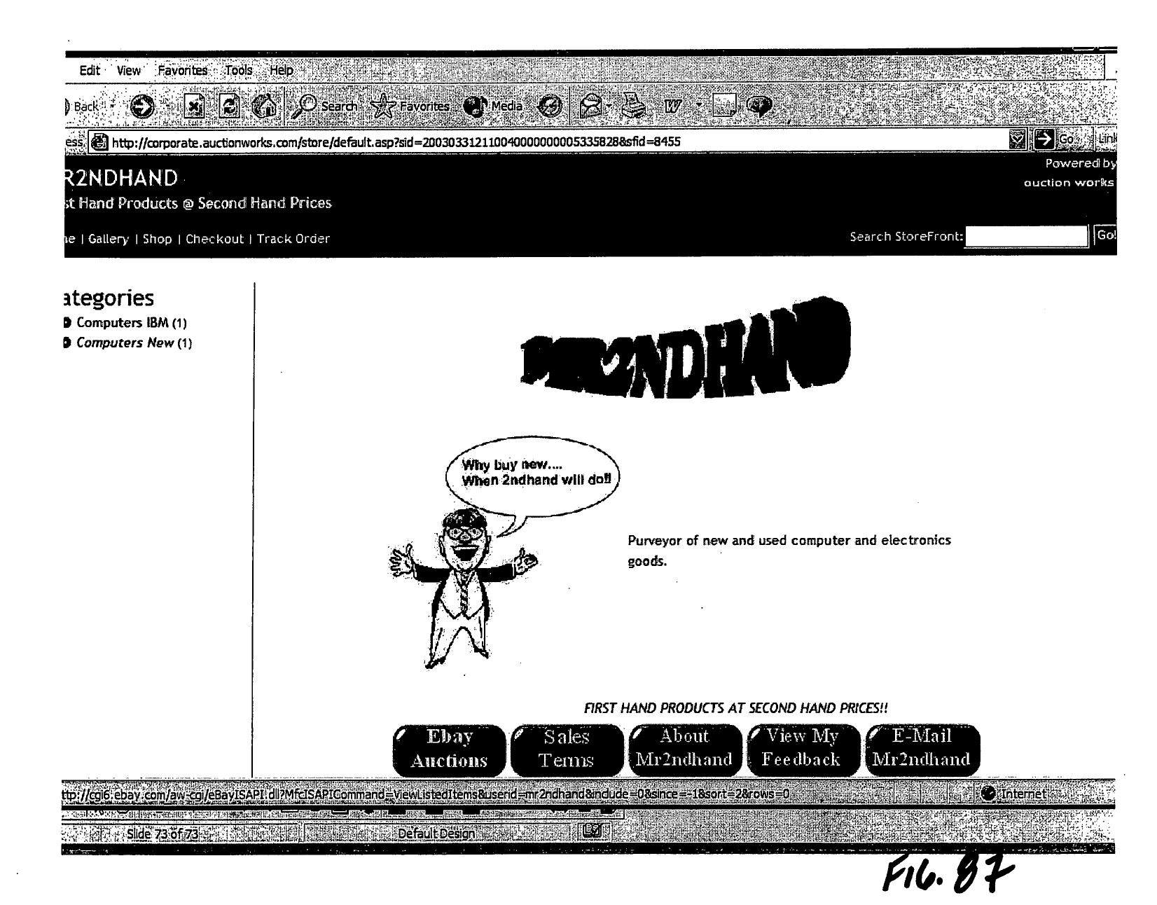

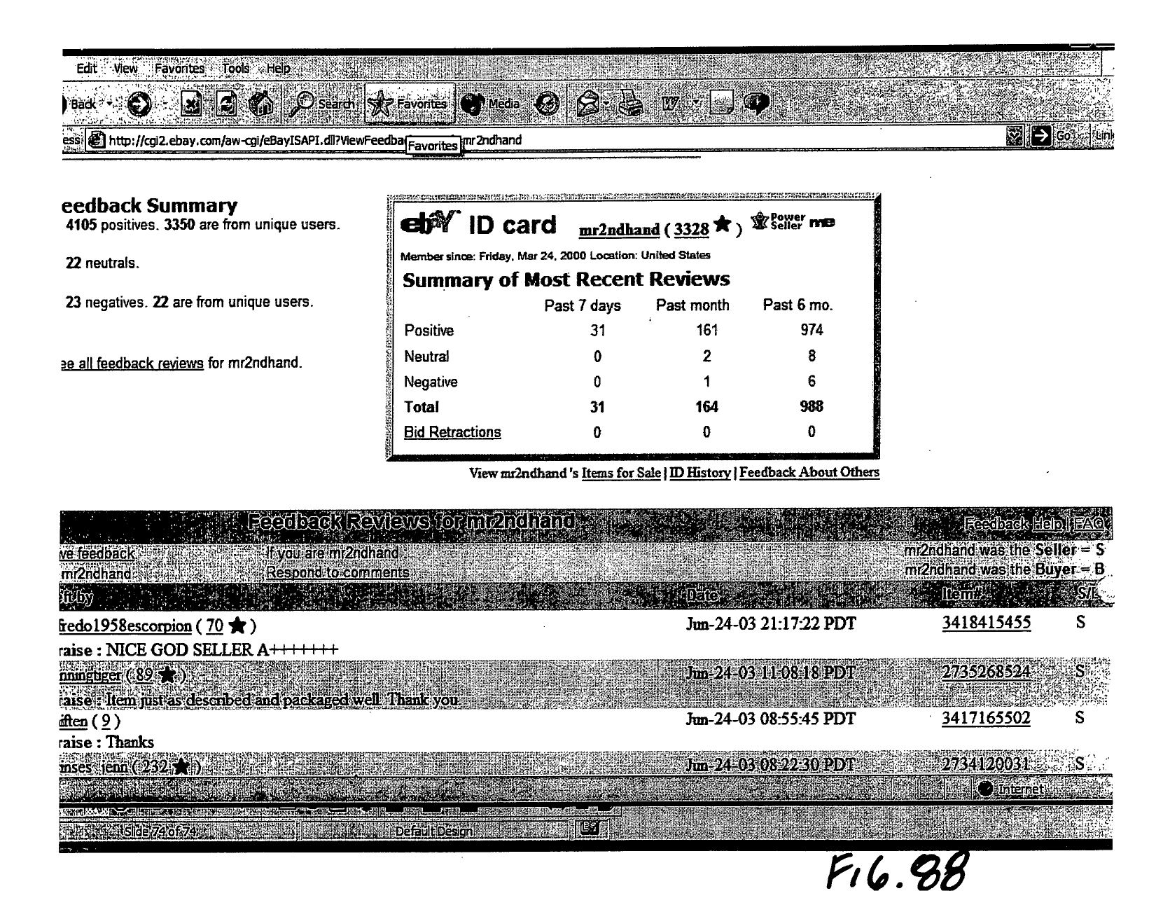

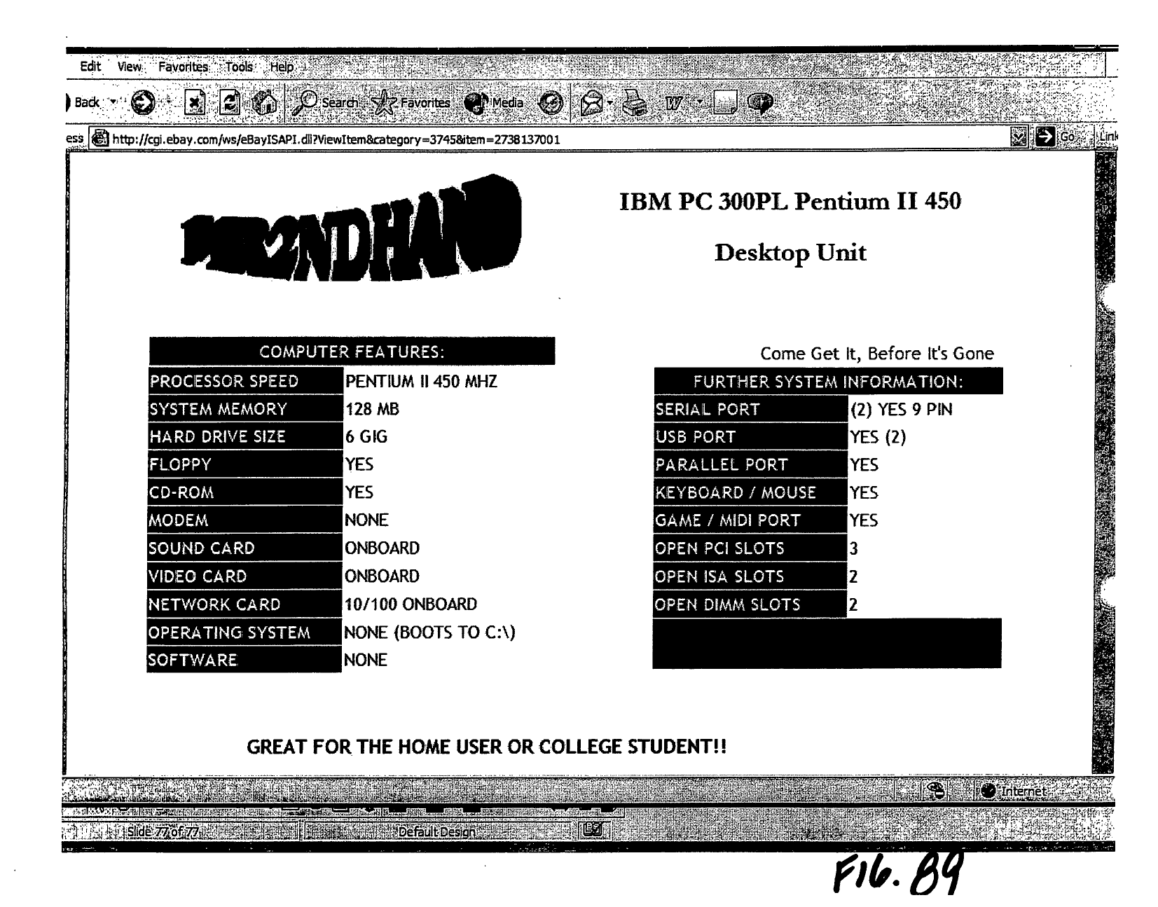

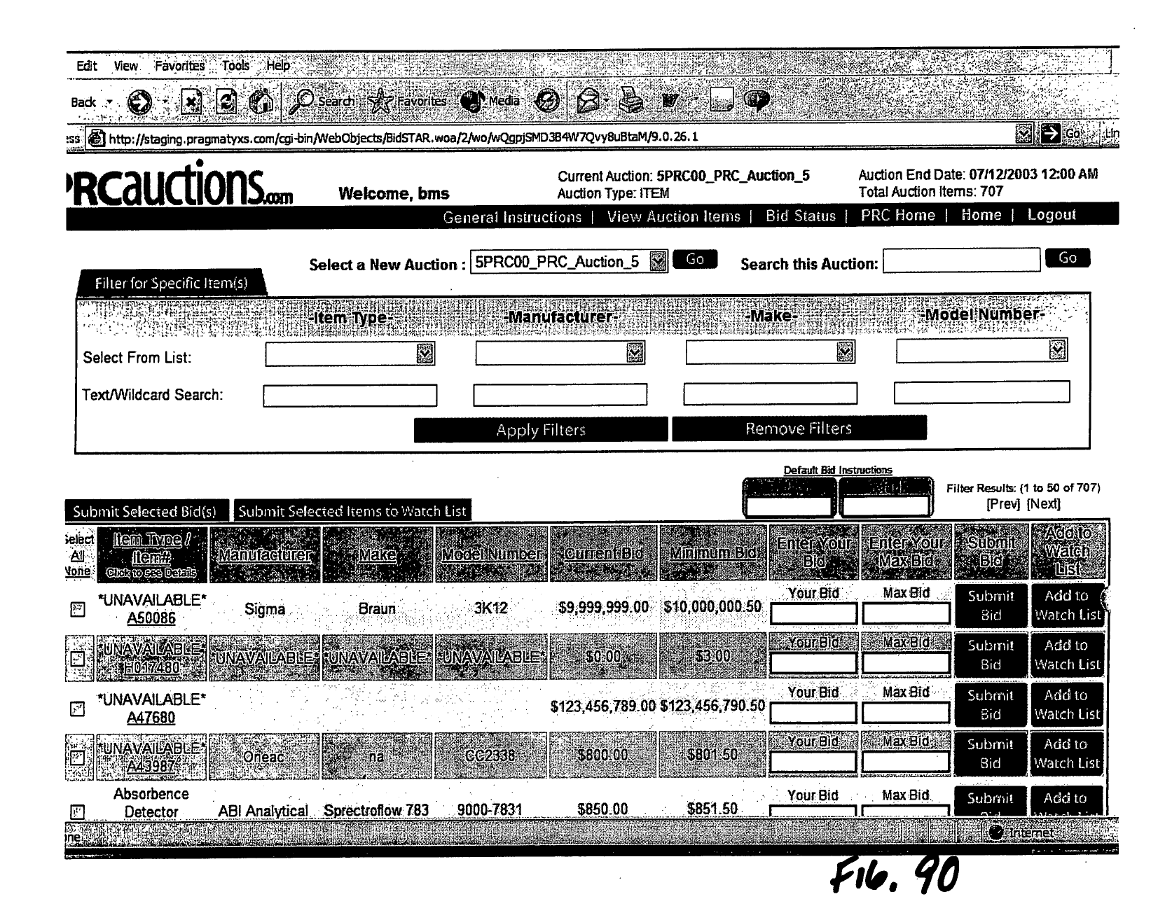

FIGS. 57-62 illustrate the processing of items using item related information in the present invention. FIG. 63 illustrates a logisitics and warehouse hierarchy for use in the present invention. The screen shots of FIGS. 64-86 illustrate the tracking of inventory and jobs, including searching, discrete inventory items, containers, and buyers and sellers of items in inventory. FIGS. 64-86 further illustrate the use of the reporting features available through the use of the present invention. FIGS. 87-90 illustrate an exemplary auction interface for use in the present invention.

The disclosure herein is directed to the variations and modifications of the elements and methods of the invention disclosed that will be apparent to those skilled in the art in light of the disclosure herein. Thus, it is intended that the present invention covers the modifications and variations of this invention, provided those modifications and variations come within the scope of the appended claims and the equivalents thereof.

1. A method of tracking and reselling inventoried items, comprising: assigning an audit code to an incoming inventoried item, wherein the audit code comprises a manual audit code and an automated audit code; auditing the incoming inventoried item to assess the incoming inventory item as suitable for one or more selected from the group consisting of destruction, demanufacturing, resale, recondition, storage, and redeployment;
sending the incoming inventoried item to one of a redeployment, a demanufacturing, a reconditioning, a resale, a storage, and a destruction in accordance with said auditing; manually updating the manual audit code in accordance with said auditing and said sending;
providing, after said sending and said manually updating, redeployment or resale of at least a portion of the incoming inventoried item audited as suitable for at least one of demanufacturing, resale, recondition, and redeployment; and finally updating the manual audit code based upon said providing.

2. The method of claim 1, wherein said sending comprises:
making the incoming inventoried item available for auction in accordance with an outcome of said auditing that the inventoried item is resellable.

3. The method of claim 1, wherein said providing comprises:
auctioning the incoming inventoried item audited as resellable by at least one of a line item auction and a lot auction; and
disposing of the resellable incoming inventoried item, upon completion of said auctioning, in accordance with an outcome of said auctioning.

4. The method of claim 3, wherein said finally updating comprises: tracking said disposing, wherein said tracking updates said auditing.

5. A method of reselling inventoried items, comprising:
auditing the incoming inventoried item to assess the incoming inventory item as suitable for resale;
making the incoming inventoried items available for auction in accordance with said auditing; auctioning the incoming inventoried item by at least one of a line item auction and a lot auction;
disposing of the incoming inventoried item, upon completion of said auctioning, in accordance with an outcome of said auctioning; and
tracking said disposing, wherein said tracking updates a code associated with said auditing.

6. The method of 5 wherein said auditing comprises:
assigning an audit code to the incoming inventoried item, wherein the audit code comprises a manual audit code and an automated audit code.

7. The method of claim 6, wherein said tracking further comprises; updating two databases, wherein a first of the two databases is local and is updated at the outcome of said auctioning, and wherein a second database is remote and is updated in accordance with a receipt of update from the first database.

8. The method of claim 7, wherein the first database is secure from the second database.

9. The method of claim 8, wherein the security comprises a user login, and wherein a third database comprises an association of a plurality of client logins with a plurality of security clearances.

10. The method of claim 7, wherein said updating of the second database comprises a one way SQL server replicating.

11. The method of claim 10, wherein said replicating occurs transactionally.

12. The method of claim 5, wherein said auctioning comprises providing multiple auction views.

13. The method of claim 12, wherein each of the multiple views is one selected from the group consisting of an auction search page, a bid page, an inventoried item detail page, and a summary page.

14. The method of claim 13, wherein the auction search page provides for: searching of available ones of the inventoried item by at least one selected from the group consisting of an item number, an item type, a manufacturer, a make, and a model.

15. The method of claim 5, wherein said auctioning comprises one of a closed auctioning and an open auctioning.

16. A system for tracking and disposition of inventoried items, comprising: an audit code assigner that assigns an audit code to an incoming inventoried item, wherein the audit code comprises a manual audit code and an automated audit code;
an auditor that audits the incoming inventoried item to assess the incoming inventory item as suitable for one or more selected from the group consisting of destruction, demanufacturing, resale, reconditioning, storage, and redeployment;
at least one of a redeployer, a demanufacturor, a reconditioner, a reseller, a scorer, and a destructor associated with said auditor, wherein at least one of said at least one redeployer demanufacturor, reconditioner, reseller,
storer, and destructor performs a disposition of said inventoried item in accordance with the audit by said auditor; and
at least one updator that manually updates the manual audit code at each of said audit code assignor, said auditor, and said at least one redeployer, demanufacturor, reconditioner, reseller, storer, and destructor.

17. A method of tracking and reselling inventoried items, said method comprising: assigning an audit code to an incoming inventoried item, wherein said audit code comprises a manual audit code and an automated audit code;
auditing the incoming inventoried item to assess the incoming inventory item as suitable for one or more of the group consisting of the destruction, demanufacturing, resale, reconditioning, storage, and redeployment;
sending the incoming inventoried item to one of the group consisting of redeployment, demanufacturing, reconditioning, resale, storage, and destruction in accordance with said auditing;
manually updating the manual audit code in accordance with said auditing and said sending;
providing disposition of at least a portion of the incoming inventoried item audited as suitable for at least one of demanufacturing, resale, reconditioning, and redeployment; and,
updating the manual audit code based upon the information provided to the system.

18. The method of claim 17, wherein said disposition includes one of at least redeployment or resale.

19. A method of reselling inventoried leas, said method comprising:
auditing the incoming inventoried item to assess the incoming inventory item as suitable for resale;
making the incoming inventoried item available for auction in accordance with said auditing;
auctioning the incoming inventoried item by at least one of a line item auction and a lot auction;
disposing of the incoming inventoried item in accordance with an outcome of said auctioning; and,
tracking said disposing,
wherein the tracking updates a code associated with the auditing.

20. A system for tracking and disposition of inventoried items, said system comprising:
an audit code assigner suitable for assigning a manual audit code and an automated audit code of the inventoried item;
an auditor that audits the incoming inventoried item to assess the incoming inventory item as suitable for one or more of destruction, demanufacturing, resale, reconditioning storage, and redeployment;
at least one of a redeployer, a demanufacturor, a reseller a storer and a destructor associated with said auditor; and,
at least one updator suitable for manually updating the manual audit code at each of the audit code assignor, the auditor, and the at least one redeployer, demanufacturor, reconditioner, reseller, storer, and destructor.
